(19) United States
(12) Patent Application Publication
(10) Pub. No.: US 2008/0167982 A1
(43) Pub. Date: Jul. 10, 2008

(54) MULTI-DIRECTIONAL, MULTI-DIMENSIONAL REVERSE MATRIX AUCTION

(76) Inventors: Hugh F. LEO, Saratoga, CA (US); Richard L. Nikoley, San Jose, CA (US)

Correspondence Address: GLENN PATENT GROUP, 3475 EDISON WAY, SUITE L, MENLO PARK, CA, 94025, US

(21) Appl. No.: 11/936,237

(22) Filed: Nov. 7, 2007

Related U.S. Application Data
(60) Provisional application No. 60/865,151, filed on Nov. 9, 2006.

(51) Int. Cl. G06Q 40/00; G06Q 30/00

(52) U.S. Cl. 705/37

(57) ABSTRACT

Methods and apparatus for providing a reverse auction are presented. A network based multi-directional and/or multi-dimensional reverse auction is described in which lender bid for loan terms and priority. A borrower provides loan terms, such as desired loan amount and optionally provides minimal loan requirements. Multiple bidders (1) select position, such as first, second, or third position; (2) designate loan terms, such as interest rate and amortization period; and (3) designate compatibility requirements of other lenders in terms of position and loan terms. A loan coordinator combines fractional interests of multiple bidders to yield (1) the borrower's requirement; (2) minimizing borrower's terms; (3) fulfilling a lender's term and position requirements; and (4) fulfilling lender compatibility requirements. Optionally, a loan servicing coordinator manages the loans. Optional fees for services rendered are provided.

### CROSS REFERENCE TO RELATED APPLICATIONS

This application claims benefit of U.S. provisional patent application No. 60/865,151 filed Nov. 9, 2006.

### BACKGROUND OF THE INVENTION

1. Field of the Invention

This invention relates generally to reverse auctions. More particularly, a method and apparatus are presented for a reverse matrix auction in which multiple lenders bid for loan terms and priority position.

2. Discussion of the Prior Art

### Reverse Auctions

Reverse auctions are a specialized auction format that allows individuals to procure goods and/or services at a lowest possible price. Reverse auctions feature decreasing incremental bidding. The reverse auction format lets potential suppliers submit bids and the supplier with the lowest price wins. Typically, a prospective buyer lists an item that they wish to buy and sellers bid to provide the best price.

Several reports of related art are outlined herein.

E. Shavit, Y. Cheifetz and N. Goren in U.S. patent application publication no. US 2007/0061248, Mar. 15, 2007 describe a system for matching lending orders and borrowing orders and/or selling loans. The system includes a borrowing order receiver configured to receive borrower requested loan terms; a lending order receiver configured to receive lender requested loan terms; and a matching system for matching lender and borrower.

Prosper, Inc. (San Francisco, Calif.), at www.prosper.com/welcom/how_it_works.aspx, describes people-to-people lending. The site describes a system taking people who need money, having them request the money, and having other people bid for the privilege of lending them money. The lending system of Prosper, Inc. uses a traditional reverse auction system using one-directional and one-dimensional bidding.

S. Lessin in WIPO international publication no. WO 02/075490 A2 describes a method of providing personal funding opportunities to sellers via an online personal funding marketplace. Each seller request is associated with reasons for the funding and the request is broken into share amounts with a purchase price and economic return. The shares are offered to registered sellers having mentoring capabilities.

W. Hillestad, C. Hills, and R. Ritzema in WIPO international publication no. WO 02/31727 A1 describe a computerized system for facilitating transactions between a buyer of credit, a member, and a lender. Members receive credit reports and may use the reports to extend anonymous credit requests to lenders. Lenders filter the requests and upon offer of credit to the member are charged a transaction fee, which may be shared with other lenders extending credit to the member.

D. Fralic in U.S. patent application publication no. US 2004/0039678 A1 describes a reverse auction/lease and review/evaluation method used over the internet that permits quantitative analysis of competing leasing offers according to financial fundamentals. The method includes quantitative and qualitative variables as defined by the lessee and a scoring systems permitting the lessee to measure competitive bids of prospective lessors.

W. Grey, S. Feldman, D. Shi, F. Wu, B. Eck, and B. Dietrich in U.S. patent application publication no. 2003/0041012 A1 describe a system, method, and apparatus for establishing customized financing terms for an item by identifying a financing function for the item and applying the function to the bid to generate a transformed bid reflecting customized financing terms for the item.

S. Tenenbaum in U.S. patent application publication no. US 2001/0027436 A1 describes a method of conducting loan transactions via a web-based community of reversed credit auctions where borrowers present their credit needs and collaterals and lenders analyze the requests on a caveat emptor basis and compete through interest rates for the loans.

### Problem

The prior art does not teach or suggest means for a lender to provide fractional loan amounts according to terms and priorities defined by the lender. In addition, the prior art does not teach or suggest a system where a borrower is provided an opportunity, in real time, to adjust their loan request based upon lender bids and/or marketplace conditions. It would be highly advantageous to have such a system providing lenders risk-appropriate returns that are competitive with alternative opportunities for investing their capital and are precisely commensurate with their objectives, as defined by the lenders themselves. The system enables a highly liquid, competitive marketplace for borrowers to obtain loans they can feasibly repay while deriving benefits from using the borrowed funds, as defined by the borrowers themselves, that are greater than the carrying costs of the loan.

### SUMMARY OF THE INVENTION

Methods and apparatus for providing a reverse auction are presented. A web based multi-directional and/or multi-dimensional reverse auction is described in which the lender bids for loan terms and priority. Lenders, also referred to herein as sellers bid for fractionalized interests in loans that are combined into a composite loan to fulfill a borrower's requirements while minimizing borrower costs.

### DESCRIPTION OF THE FIGURES

FIG. 1 illustrates pre-loan network reverse matrix auction interaction between borrower, lender, and a loan coordinator entity; and

FIG. 2 illustrates post-loan network based interaction between borrower, lender, and a reverse matrix auction loan servicing entity.

### DETAILED DESCRIPTION OF THE INVENTION

The invention comprises a reverse matrix auction. The reverse matrix auction is preferably a multi-directional, multi-dimensional reverse auction performed over a network, such as the world wide web or internet through an intermediate controlling entity. Herein, a borrower is also referred to as a buyer. The buyer seeks a loan with the most beneficial terms. A lender, also known as a seller or provider, provides loan capital to the borrower. Preferably the buyer and lender are individuals; however the buyer and/or lender are optionally legal entities, such as corporations. In the reverse matrix auction, a lender bids for a fractionalized interest in the loan specifying loan terms and priority position. Lender specified loan terms include, but are not limited to, the elements of interest rate, quantity, payment for a time period, and/or amortization period also referred to as term. Priority includes, but is not limited to, priority position and ratio of a given lender loan amount to a total loan amount. In addition, each lender optionally specifies compatibility requirements for other lenders in terms of separately designated loan terms and priority position. Each of these elements is further described, infra. Two or more fractionalized interests in loans are combined, by a loan term and position coordinator or entity, into a composite loan to fulfill (1) a borrower's loan term requirements, such as amount, term, and payment requirements, (2) the lender specified loan terms and position, and (3) lender specified compatibility requirements for additional co-lenders of the loan. A loan servicing coordinator subsequently services the loan. The loan servicing coordinator and the loan term and position coordinator are optionally subunits of a loan coordinator. Optional fees for services rendered are provided.

The reverse matrix auction has benefits including: allowing investors to hedge risk while magnifying returns; enabling an investor to take risks commensurate with the investor's risk tolerance; and providing optimal loan terms to the borrower.

Loan types are without limitation. Preferred loan types are signature loans, but loan types additionally include mortgages, business loans, car loans, consolidation loans, and both secured and unsecured loans. Additionally, a seller's interest in an existing loan may be auctioned by the seller to one or multiple bidders. Still further, the auction marketplace can auction other financial instruments or fractions of other financial instruments that originated from other sources.

### Loan Term and Positioning

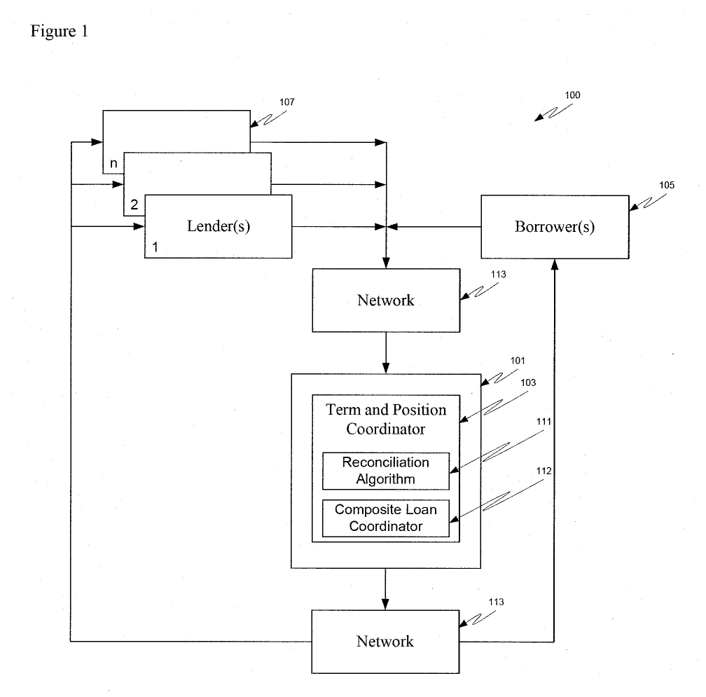

Referring now to FIG. 1, a multi-dimensional and multi-direction reverse matrix auction system 100 is composed of a lender(s) 107, a borrower 105, and a loan coordinator 101 that communicate and coordinate over a network 113, such as the world-wide-web, through peer-to-peer (P2P) lending, and/or through a private network. Herein P2P lending refers to borrowers making a loan request known to lenders who then bid amongst themselves to fund the loan request where the loan request is made known through a third party site. In a multi-dimensional, and preferably multi-directional, reverse auction system 100, a loan term and position coordinator 103 of a loan coordinator 101 receives a loan request from at least one borrower 105. The loan coordinator further receives lender terms and positions from a plurality of lenders 107, herein identified as lenders 1 to n where n is a positive integer.

Using a reconciliation algorithm 111, the loan term and position coordinator 103 selects a bid from one lender 107, referred to herein as the subject-bid, then identifies all other lender bids where the loan term and position characteristics and requirements are compatible with the subject-bid and with one another and where the loan term and position characteristics and requirements of the subject-bid are compatible with the other-lender bids. The loan term and position coordinator 103 then repeats the foregoing process selecting the next lender bid. This iterative process is performed each time the loan term and position coordinator 103 receives an additional lender bid or a modification of a prior bid, identifying the bids then compatible with each bid designated in sequence as the subject-bid for the purposes of this evaluation.

The composite loan coordinator 112 of a loan coordinator 101 receives a composite loan possibility, composed of compatible bids, for each lender bid identified as a subject-bid. The composite loan coordinator 112 evaluates each potential composite loan by totaling the amounts bid and totaling the monthly payments required to service those amounts. The composite loan coordinator calculates the weighted average interest rate and weighted average amortization term of the bids in each potential composite loan. From among all potential composite loans, the composite loan coordinator 112 designates those composite loans that equal or better the borrower's reserve requirements and designates from the resulting group of qualifying composite loans the winning composite loan. The winning composite loan is selected as the composite loan with the lowest weighted average interest rate or optionally based upon another loan term criterion.

Additional borrower and lender reverse matrix auction details are provided herein. The borrower provides at least a requested loan amount and optionally provides any or all of: a borrower's reserve, a maximum payment, a minimum term, a maximum interest rate, contact information, collateral, and reason(s) for the loan. Typically, a borrower provides a requested loan amount and reserve requirements. For example, the borrower provides a reserve auction requirement including all of: a minimum loan amount, a maximum interest rate, a minimum amortization term, and a maximum payment. If the reserve is not met, then the loan is not funded.

Each lender separately bids fractionalized loan amounts in a reverse auction format and with the bid provides specified loan terms, a specified loan position, and optionally provides required compatibility requirements for co-lenders. The lender bid loan terms optionally include terms for the fractional loan amount of rate, term, minimal payment, and/or collateral requirement(s). In addition, each lender optionally submits with the bid corresponding compatibility requirements for additional lenders who would hold fractionalized interest in the loan, such as requirements of positions of one or more of the fractionalized lenders and/or maximum or minimum funding for one or more positions senior to, subordinate to, and/or equal to that given lender's designated position. Still further, each lender optionally submits with the bid corresponding minimum or maximum term requirements for one or more positions. For example, an n^{th} lender may require by designation for additional lenders, who would hold fractionalized interests in the loan in a position senior to, subordinate to, or equal to the n^{th} lender, a maximum, minimum, or a set number any of: loaned amount, interest rate, payment, and term for each separately designated co-lender or in combination with all such co-lenders. Loan positions are optionally further defined in terms of losses. In one instance, the most junior loan absorbs 100% any loss on a dollar for dollar basis and then the next most junior position absorbs the loss until the totality of the loss is absorbed. In another instance, loss rates are included as terms in the bidding process. For example, a bidder may require that a senior position absorbs a percentage of any loss, such as 20% of loss on all or a fraction of the total loss. Similarly, a bidder may require a junior position to absorb a set fraction of any loss, such as 80% of a set fraction or on all of the total loss.

The loan coordinator 101 reconciles the lender(s) 107 to produce a combination of winning lenders yielding the best possible combination of loan terms fulfilling or bettering the borrower(s) 105 requirements while still maintaining co-lender individual and compatibility requirements. The loan terms to the borrower are blended loan terms of the individual winning bidders, where the blended terms are no more than the borrower's stated loan term requirements in terms of loan parameters, such as interest rate, amortization period, and/or monthly payment.

Herein, the bidding process is defined in terms of the borrower's needs where the borrower's needs are displayed to a plurality of lenders and the lenders bid using terms and positions for a fractionalized portion of the borrower needs.

In another embodiment, lenders are able to register bids for fractionalized loan amounts without knowing individual borrower requirements. For example, a lender places a standby bid and when the loan coordinator 101 later recognizes a borrower with a loan requirement met in part by the standby bid, the loan coordinator makes the bid active in an auction as described herein and notifies the lender that the standby bid is now active.

In all embodiments, the loan coordinator 101 selects the optimal winning bid.

Optionally, a borrower can see in real-time individual bids and/or a winning bid combination. The ability of the borrower to see bids in real-time allows the borrower to adjust the borrower's loan and reserve requirements, as is addressed in the multi-directional section herein.

The loan term and position coordinator optionally provides to the lenders any of a given borrower's:
identification, such as name and address;
loan requirements, such as total loan amount;
credit information;
available security;
minimal borrower acceptable loan terms; and reason(s) for the loan.

In different examples, all, a portion, or none, of the borrower's information is provided to the lenders. Similarly, in still different examples, prior to loan closure, all, a portion, or none, of the lender's information is provided to the borrower.

Preferably, once lender's terms and borrower requirements are provided in an auction, both lender and borrower are bound to their bids for the life of the auction. Alternately, lenders and/or borrowers may improve upon their bids. For example a lender may reduce the bid interest rate, may increase the amount bid, may increase the amortization term allowed, may reduce priority position required, may reduce the monthly payment required, may increase the maximum allowable amount of other funding in all positions, and/or may reduce the minimum allowable amortization period of other funding in all positions. For example a borrower may reduce the loan amount requested, increase the interest rate allowable, decrease the minimum acceptable amortization term, and/or increase the monthly payment allowable. In separate embodiments, legal terms of a designated auction type apply, according to any of the auction types further described, infra. Additional details on loan directionality and dimensionality are provided, infra.

### Auction Directionality and Dimensionality

Auction types are definable in terms of directionality and dimensionality.

One type of reverse auctions is a bidirectional and single dimensional auction. An example of a bi-directional auction is an auction defined in terms of price and quantity. An example of a single dimensional auction is an auction characterizable by a vertical axis for price and a horizontal axis for quantity.

Another type of reverse auction is a multi-directional and multi-dimensional auction. Herein, a multi-directional and multi-dimensional reverse auction is termed a reverse matrix auction. Reverse auction, multi-directional auction, and multi-dimensional auction characteristics are combined to form a multi-dimensional multi-directional reverse auction. The reverse auction, multi-dimensional reverse auction, and multi-directional reverse auction terms are further clarified, infra.

### Reverse Auction

In a reverse auction, buyers also known herein as lenders compete and bid down a price or term. For example, lenders compete and bid down a price, a quantity, or loan terms.

### Multi-Dimensional Reverse Matrix Auction

In a traditional auction, bidding is one-dimensional where competition is among buyers to bid the best price for whatever the seller is selling. In stark contrast, in a multi-dimensional reverse auction, instead of simply bidding for price and quantity, the seller, known as the lender, bids in multi-dimensions where the dimension include two or more of: loan terms, priority, and optionally inter-lender compatibility requirements. The bid conditions of terms, priority, and compatibility yield multi-dimensional terms in a bid. Further dimensions are added to the bid terms when the terms are further defined using parameters, such as loan amount or loan quantity, price or interest rate, term or amortization period, priority, and/or ratio of priority positions. The borrower accepts only the most favorable composite bid, which is composed of bids from multiple lenders. Further, the lenders bid is included in the winning composite bid only if it contributes to a combination of bids that in the aggregate produce the most favorable composite bid for the buyer also known as the borrower. To be included, the lender's bid must be compatible with other bidders in combining to meet the borrower's reserve requirements. Compatibility is determined by a plurality of conditions, such as position bid, the maximum a bidder allows for other funding that is senior, subordinate, and/or in an equal position, and/or the minimum term the bidder allows for amortization of other funding as a function of position. Still further, the winning combination of bids must fulfill the borrower's reserve. For example, the winning composite bid, if any, has (1) weighted average terms and conditions that meet or better the borrower's reserve in terms of loan amount, weighted average interest rate, weighted average loan terms, total periodic payment, such as monthly payment, and (2) is more favorable to the borrower than all other composite bid combinations.

### Multi-Directional Reverse Matrix Auction

In a single directional reverse auction, bidders simply bid against one another to secure whatever a seller is offering. A multi-direction reverse auction differs from a single directional reverse auction in at least two regards. First, both the borrower and lender bid. For example, lenders bid to obtain all or a portion of a loan the borrower is seeking to fund. As the bidding proceeds in real-time, the borrower may also bid by changing the borrower's reserve. For example, the borrower may adjust reserve loan terms in real-time to attract more bidders or in order to close the auction immediately by relaxing the conditions of the reserve enough to qualify existing lenders for the loan. Second, lenders become winning lenders only if their bids are compatible with enough other bidders in a manner that the composite of their bids meets or betters the borrower's reserve terms and betters any other combination of competing bids that fulfill the borrower's reserve terms. As the bidding proceeds in real-time, a lender may bid to become compatible with a greater number of other bidders overall in order to close the auction immediately by making the borrower's reserve conditions of the composite loan. For example, the lender may bid to increase the amount that they will lend, to reduce the interest that they demand, to increase a maximum amortization period, to reduce their priority position, to increase the amount allowed for a senior, subordinate, or same financing position, and/or by increasing an amortization period that they are willing to accept for compatible lenders.

In a multi-directional multi-dimensional reverse auction, parameters described, supra, for a reverse auction, a multi-dimensional reverse auction, and a multi-directional reverse auction are combined to form a reverse matrix auction.

To enhance clarity, three detailed examples of a multi-dimensional reverse auction are provided.

### EXAMPLE I

Referring to Tables 1 to 3, an example of multiple lenders bidding using multivariate terms and defining loan position for a potential loan is described herein. In Table 1, a borrower 105 submits a loan request over a network 113 to a loan coordinator 101. In this case, the borrower specifies specific loan reserve terms to: a loan amount of $10,000, a maximum payment of $471.00, a minimum term of 24 months, and a maximum interest rate of 12.0%. In other cases, more or fewer loan terms are set by the buyer. All or a portion of the borrower's loan terms are presented by the loan coordinator 101 to potential lenders 107 via the network 113. A multitude of lender bids are returned to the loan coordinator. Table 2 represents five of the returned bids; bids could number in the ten, hundreds, or thousands. Table 2 represents a portion of the lender bid terms and priority, which data are representable in a sub-matrix. The sub-matrix is itself a portion of a larger set of lender submitted data, which are also representable in matrix form. Table 2 includes a vector of lender identifications. For each lender identification, a number of associated loan terms and position are represented in corresponding vectors of the matrix. For example, lender number one submitted a bid of first priority position and terms of a bid amount of $7,500 dollars at 10% interest for 24 months. Each lender submits their own priority and terms as shown by example in Table 2. A single bidder may bid more than once and may bid in multiple positions simultaneously. However, the bidder is not allowed in the system to change their bid to make it inferior, as discussed supra. Using the borrower's loan requirements represented in Table 1 and the lender's loan terms and position requirements of Table 2, a reconciliation algorithm 111 of a term and position coordinator 103 determines that the terms and position of lenders 1, 2, and 4 combine fractionalized loan amounts of $7,500, $1,000, and $1,500 totaling to the borrower's loan request of $10,000. The reconciliation algorithm further determines that the lenders 1, 2, and 4 weighted average rates and terms fulfill the borrower's reserve terms even though lender number four has an individual interest rate term of 13.0% exceeding that of the borrower's reserve maximum interest rate term of 12.0%, which is typically a weighted average rate. Still further, the reconciliation program determines that the combination of lenders 1, 2, and 4 produces the best weighted average terms for the borrower, namely 10.55% interest, a 24 month term and a $464 monthly payment.

Optionally, the reconciliation program uses still further lender requirements in selecting a winning combination of lenders. Referring now to Table 3, a data set of additional lender terms, which are representable in matrix format is presented. For instance, Table 3 shows that lender one requires that a maximum position of funding in dollars from a subordinate position is $2500. As lender number one selected a priority position of one, as shown in Table 2, then the system determines that in Table 3, lender number one should not have funding from a position senior to lender number one. Further, lender number one dictates that the subordinate position(s) should have terms of at least 18 months. Similarly, Table 3 shows that lender number one is not allowing any other bid to combine with lender number one's bid in the same first priority position. Similar requirements are presented for each lender. The reconciliation program determines that lender numbers 1, 2, and 4 have compatible terms as expressed by conditions of Table 3.

All or portions of the elements of Tables 2 and 3 and additional bid elements are combinable into a larger matrix. Typically, in practice the reconciliation algorithm considers all terms represented in the sub-matrices of Tables 2 and 3 in finding the optimal terms for the borrower. More or less information may be provided in Tables 2 and 3 and all or parts of Tables 2 and 3 are optionally combined. The combined results are also representable in matrix format.

TABLE 1
Borrower Reserve Criteria

| Borrower Reserve | Borrower Reserve |
|---|---|
| Terms | Criteria |
| Loan Amount | $10,000 |
| Maximum Payment | $471.00 |
| Minimum Term | 24 |
| Maximum Rate | 12.0% |

TABLE 2
Multi-Directional, Multi-Dimensional Reverse Auction

| Lender ID | Priority | Amount | Rate | Term |
|---|---|---|---|---|
| 1 | 1 | 7500 | 10 | 24 |
| 2 | 2 | 1000 | 11 | 24 |
| 3 | 1 | 5500 | 12 | 36 |
| 4 | 3 | 1500 | 13 | 24 |
| 5 | 1 | 5000 | 14 | 12 |

TABLE 3
Ratio of Priority Positions

| | Maximum Position of Other | | | Minimum Term by Position | | |
|---|---|---|---|---|---|---|
| | Funding (dollars) | | | (months) | | |
| Lender ID | Senior | Subordinate | Same | Senior | Subordinate | Same |
| 1 | 0 | 2500 | 0 | N/A | 18 | N/A |
| 2 | 7500 | 2000 | 0 | 24 | 18 | 18 |
| 3 | 0 | 5500 | 5000 | N/A | 24 | 30 |
| 4 | 8500 | 0 | 2000 | 24 | N/A | 24 |
| 5 | 0 | 5000 | 3000 | N/A | 36 | 36 |

### EXAMPLE II

Referring now to Tables 4 to 34, a detailed example of a multi-directional reverse auction system is provided where multiple lenders bid using multivariate bidding terms and defined loan position requirements. In this example, thirty bidders are bidding on loan terms and position for a given loan. Table 4 provides an auction summary and Tables 5 to 34 provide auction details for bidders 101 to 130, respectively, with one table for each bidder. Reverse matrix auction information in the tables is further described, infra.

Table 4 provides a summary of the exemplary reverse matrix auction. In columns A and B of Table 4, reserve criteria of a borrower are presented in terms of loan amount, maximum payment, minimum term, and maximum rate. Columns C through L of Table provide bid parameters for a plurality of bidders 107. For example, lender or bidder number 107 has bidder terms defined in columns C through F of a first priority position, a loan amount of four thousand dollars, an interest rate of eight and one-half percent, and a thirty month term. Lender number 107 further defines compatibility requirements in columns G through L. Particularly, lender number 107 defines maximum funding of other positions in columns G through I in terms of position senior, subordinate, or the same as lender number 107's position. Lender number 107 defines the minimum term by position for other lenders in columns J through L. In column J, a minimum term of a senior position is listed as not applicable as in column C lender number 107 requires a first priority position. Columns K and L for lender number 107 show that lender number 107 requires a minimum terms by position for subordinate or same positions of thirty-six and thirty months, respectively.

Table 5 provides combinatorial bid information where combinations of bids must include bidder number 101. Similarly, Table 6 provides combinatorial bid information where bidder number 102 must be included. Extrapolating, Tables 5-34 provide combinatorial bid information where each table represents bid information that must include sequentially bidders numbers 101-130, respectively. For clarity, bid information for bidder number 101 is described, infra.

Referring now to Table 5, bid information compatibility with lender number 101 is provided. More particularly, Table 5 shows if bids are compatible with lender number 101 and if bids are compatible among lenders whose bids potentially would be combined with lender number 101 in a composite loan. Columns B through K of Table 5 provide bidder compatibility factors that are drawn from Columns C through L of Table 4. The reconciliation algorithm 111 for lender number 101 yields results in columns L through P of Table 5. In Columns L and P a “1” designates included and a “0” designates not included. For instance, column L of Table 5 shows that lender number 124 is a compatible bidder as to Term requirements. Likewise, column P of Table 5 shows that lender number 124 is a compatible bidder as to other funding requirements. Both are designated with a “1”. Consequently, the bid of lender number 124 is selected in Column Q. Column Q of Table 5 further shows that the bid of lender number 124 is a $1500 component of a potential composite loan including bids from lenders 102, 112, and 114 in conjunction with bid 101 totaling $7,500 at the point illustrated in the auction process. The term and position coordinator 103 uses the results of the reconciliation algorithm 111 to determine the combination of bids resulting in a total lending amount of $7,500, column Q, with individual and combined rates provided in columns R through U. Hence, Table 5 shows the best combination of bids where the combination must include lender number 101. A result provided within Table 5 is that no combination of bids is yet available that fulfills the requirements of both lender number 101 and the borrower's reserve requirements, which includes the requirement of a $10,000 loan. This tells lender number 101 that he must currently wait for more compatible lenders or relax his constraints to result in a composite loan winning bid combination including lender number 101.

Referring now to Table 7, bid information compatibility with lender number 103 is provided. The columns are identical to that of Table 5, but the fields are populated based upon the requirements of lender number 103. Column Q of Table 7 shows that the term and position coordinator 103 has combined bids from lenders number 102, 104, 112, 114, and 124 with the bid from lender number 103 to produce a bid combination that fulfills the borrowers requirements and is a potential winning composite loan. The actual winning composite loan may or may not be composed of this bid combination. In a manner consistent with that described for lender numbers 101 and 103 in Tables 5 and 7, Tables 6 and 8 to 34 provide best bid combinations for lenders 102 and 104 to 130, respectively. The loan coordinator 101 selects the winning composite loan by determining which potential composite loan is composed of the optimal combination of bids. Preferably, the bids composing the winning composite loan will minimize the weighted average interest rate to the borrower. Notably, it is possible that no overall winning combination of bids exists as no combination of bids fulfilled the borrower's reserve criteria.

TABLE 4
Zazingo Table 4A
Multi-Directional, Multi-Dimensional
Reverse Matrix Auction

| | | Lenders' Terms | | | | |
|---|---|---|---|---|---|---|
| Borrower | | Bidding Amounts & Terms >>>>>>>> | | | | |
| Reserve Criteria | | Bid | Priority | Amount | Rate | Term |
| Amount | $10,000 | 101 | 1 | $2,000 | 7.00% | 36 |
| Max Pmt. | $471.00 | 102 | 2 | $1,000 | 7.25% | 36 |
| Min. Term | 24 | 103 | 1 | $1,500 | 7.50% | 30 |
| Max Rate | 12.0% | 104 | 1 | $2,000 | 7.75% | 30 |
| Payment Calculator | | 105 | 1 | $2,500 | 8.00% | 24 |
| 12.0% | | 106 | 1 | $3,000 | 8.25% | 24 |
| 24 | | 107 | 1 | $4,000 | 8.50% | 30 |
| $470.73 | | 108 | 3 | $4,000 | 8.75% | 24 |
| | | 109 | 1 | $4,500 | 9.00% | 18 |
| | | 110 | 1 | $5,000 | 9.25% | 24 |
| | | 111 | 3 | $500 | 9.50% | 12 |
| | | 112 | 2 | $1,000 | 9.75% | 36 |
| | | 113 | 2 | $1,500 | 10.00% | 24 |
| | | 114 | 3 | $2,000 | 12.25% | 36 |
| | | 115 | 3 | $2,500 | 12.50% | 24 |
| | | 116 | 3 | $3,000 | 12.75% | 24 |
| | | 117 | 3 | $3,500 | 13.00% | 24 |
| | | 118 | 3 | $5,000 | 13.25% | 24 |
| | | 119 | 3 | $4,500 | 13.50% | 24 |
| | | 120 | 3 | $5,000 | 13.75% | 24 |
| | | 121 | 3 | $1,000 | 14.00% | 24 |
| | | 122 | 3 | $1,500 | 14.25% | 12 |
| | | 123 | 2 | $2,500 | 14.50% | 24 |
| | | 124 | 3 | $3,500 | 14.75% | 36 |
| | | 125 | 3 | $4,000 | 15.00% | 24 |
| | | 126 | 3 | $2,500 | 15.25% | 24 |
| | | 127 | 3 | $3,000 | 15.50% | 36 |
| | | 128 | 3 | $1,500 | 15.75% | 24 |
| | | 129 | 3 | $1,000 | 16.00% | 36 |
| | | 130 | 3 | $500 | 16.25% | 24 |
| | A | B | C | D | E | F |

Zazingo Table 4B
Multi-Directional, Multi-Dimensional
Reverse Matrix Auction

Compatability Factors>>>>>>>>>>>>>>>>>>>>>>>>>>>>>>>

| | Maximum Position | | | | | |
|---|---|---|---|---|---|---|
| | Other Funding | | | Minimum Term By Position | | |
| Bid | Senior | Subordinate | Same | Senior | Subordinate | Same |
| 101 | 0% | 55% | 35% | N/A | 36 | 36 |
| 102 | 90% | 90% | 35% | 24 | 18 | 18 |
| 103 | 0% | 70% | 20% | N/A | 24 | 30 |
| 104 | 0% | 65% | 45% | N/A | 36 | 30 |
| 105 | 0% | 60% | 20% | N/A | 42 | 24 |
| 106 | 0% | 55% | 55% | N/A | 48 | 24 |
| 107 | 0% | 50% | 40% | N/A | 36 | 30 |
| 108 | 50% | 45% | 65% | 24 | 60 | 24 |
| 109 | 0% | 40% | 70% | N/A | 66 | 24 |
| 110 | 0% | 35% | 75% | N/A | 72 | 24 |
| 111 | 99% | 0% | 30% | 24 | 12 | 12 |
| 112 | 90% | 75% | 35% | 24 | 18 | 36 |
| 113 | 90% | 70% | 40% | 24 | 24 | 24 |
| 114 | 80% | 65% | 45% | 24 | 36 | 36 |
| 115 | 25% | 0% | 25% | 24 | N/A | 24 |
| 116 | 20% | 0% | 35% | 24 | N/A | 24 |
| 117 | 15% | 0% | 45% | 24 | N/A | 24 |
| 118 | 15% | 0% | 50% | 24 | N/A | 24 |
| 119 | 10% | 0% | 60% | 24 | N/A | 24 |
| 120 | 10% | 0% | 65% | 24 | N/A | 24 |
| 121 | 50% | 0% | 20% | 24 | N/A | 24 |
| 122 | 55% | 0% | 55% | 24 | N/A | 36 |
| 123 | 60% | 30% | 20% | 24 | 24 | 24 |
| 124 | 90% | 0% | 20% | 24 | N/A | 36 |
| 125 | 70% | 0% | 40% | 24 | N/A | 24 |
| 126 | 75% | 0% | 35% | 24 | N/A | 24 |
| 127 | 80% | 0% | 30% | 24 | N/A | 36 |
| 128 | 85% | 0% | 25% | 24 | N/A | 24 |
| 129 | 90% | 0% | 20% | 24 | N/A | 36 |
| 130 | 95% | 0% | 15% | 24 | N/A | 24 |
| B | G | H | I | J | K | L |

Zazingo Table 4C
Multi-Directional, Multi-Dimensional
Reverse Matrix Auction

| | Composite Loan Terms | | | | | | |
|---|---|---|---|---|---|---|---|
| | To Borrower | | | | | | |
| | [Winning/Lead Bidders(s) In Red] | | | | Lender Yields | | |
| | Amount | Interest | | Monthly | | Second | Third |
| Bid | Funded | Rate | Loan Months | Payment | First Position | Position | Position |
| 101 | $7,500 | 10.35% | 36.0 | $243 | 7.0% | 8.5% | 13.3% |
| 102 | $7,000 | 12.57% | 36.0 | $235 | 0.0% | 8.5% | 14.2% |
| 103 | $10,000 | 10.51% | 33.9 | $345 | 7.6% | 8.5% | 13.6% |
| 104 | $10,000 | 9.73% | 33.0 | $349 | 8.2% | 8.5% | 13.1% |
| 105 | $4,500 | 8.11% | 24.0 | $204 | 8.1% | 0.0% | 0.0% |
| 106 | $6,000 | 8.75% | 24.0 | $273 | 8.8% | 0.0% | 0.0% |
| 107 | $10,000 | 9.10% | 32.4 | $352 | 8.3% | 8.5% | 12.3% |
| 108 | $7,500 | 8.43% | 28.4 | $300 | 7.5% | 8.5% | 8.8% |
| 109 | $4,500 | 9.00% | 18.0 | $268 | 9.0% | 0.0% | 0.0% |
| 110 | $8,000 | 8.88% | 24.0 | $365 | 8.9% | 0.0% | 0.0% |
| 111 | $500 | 9.50% | 12.0 | $44 | 0.0% | 0.0% | 9.5% |
| 112 | $6,000 | 8.67% | 28.0 | $245 | 0.0% | 8.5% | 8.8% |
| 113 | $8,000 | 8.56% | 26.7 | $337 | 7.5% | 8.9% | 8.8% |
| 114 | $7,500 | 12.42% | 36.0 | $251 | 0.0% | 8.5% | 13.8% |
| 115 | $7,500 | 9.55% | 26.8 | $318 | 7.5% | 7.3% | 10.6% |
| 116 | $7,500 | 10.15% | 25.6 | $333 | 0.0% | 7.3% | 10.6% |
| 117 | $8,500 | 10.32% | 25.4 | $380 | 0.0% | 7.3% | 10.7% |
| 118 | $10,000 | 10.85% | 25.2 | $452 | 0.0% | 7.3% | 11.3% |
| 119 | $9,500 | 10.84% | 25.3 | $428 | 0.0% | 7.3% | 11.3% |
| 120 | $10,000 | 11.10% | 25.2 | $453 | 0.0% | 7.3% | 11.5% |
| 121 | $6,500 | 9.19% | 29.1 | $257 | 7.5% | 8.5% | 10.5% |
| 122 | $1,500 | 14.25% | 12.0 | $135 | 0.0% | 0.0% | 14.3% |
| 123 | $6,000 | 10.79% | 27.8 | $253 | 7.5% | 11.9% | 0.0% |
| 124 | $7,500 | 12.42% | 36.0 | $251 | 0.0% | 8.5% | 13.8% |
| 125 | $9,000 | 11.36% | 25.3 | $407 | 0.0% | 7.3% | 11.9% |
| 126 | $8,000 | 10.72% | 27.0 | $344 | 0.0% | 8.5% | 11.5% |
| 127 | $7,000 | 12.57% | 36.0 | $235 | 0.0% | 8.5% | 14.2% |
| 128 | $7,500 | 9.83% | 28.4 | $305 | 7.5% | 8.5% | 11.4% |
| 129 | $7,000 | 10.21% | 36.0 | $227 | 7.0% | 8.5% | 13.5% |
| 130 | $5,500 | 9.00% | 30.0 | $211 | 7.5% | 8.5% | 10.6% |
| B | M | N | O | P | Q | R | S |

TABLE 5
Zazingo Table 5A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 101 | 1 | | | 36 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 100% | 90% | 35% |
| 103 | 1 | $1,500 | 7.50% | 30 | 100% | 70% | 20% |
| 104 | 1 | $2,000 | 7.75% | 30 | 100% | 65% | 45% |
| 105 | 1 | $2,500 | 8.00% | 24 | 100% | 60% | 20% |
| 106 | 1 | $3,000 | 8.25% | 24 | 100% | 55% | 55% |
| 107 | 1 | $4,000 | 8.50% | 30 | 100% | 50% | 40% |
| 108 | 3 | $4,000 | 8.75% | 24 | 100% | 45% | 65% |
| 109 | 1 | $4,500 | 9.00% | 18 | 100% | 40% | 70% |
| 110 | 1 | $5,000 | 9.25% | 24 | 100% | 35% | 75% |
| 111 | 3 | $500 | 9.50% | 12 | 100% | 0% | 30% |
| 112 | 2 | $1,000 | 9.75% | 36 | 100% | 75% | 35% |
| 113 | 2 | $1,500 | 10.00% | 24 | 100% | 70% | 40% |
| 114 | 3 | $2,000 | 12.25% | 36 | 100% | 65% | 45% |
| 115 | 3 | $2,500 | 12.50% | 24 | 100% | 0% | 25% |
| 116 | 3 | $3,000 | 12.75% | 24 | 100% | 0% | 35% |
| 117 | 3 | $3,500 | 13.00% | 24 | 100% | 0% | 45% |
| 118 | 3 | $5,000 | 13.25% | 24 | 100% | 0% | 50% |
| 119 | 3 | $4,500 | 13.50% | 24 | 100% | 0% | 60% |
| 120 | 3 | $5,000 | 13.75% | 24 | 100% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 5B
Multi-Directional, Multi-Dimensional
Reverse Matrix Auction

| | | Compatability Factors | | | Qualifying |
|---|---|---|---|---|---|
| | | Continued | | | Bids |
| 101 | 1 | N/A | 36 | 36 | |
| | | Minimum Term By Position | | | Inclusion |
| Bid | Priority | Senior | Subordinate | Same | By Term |
| 101 | 1 | N/A | 36 | 36 | 1 |
| 102 | 2 | 24 | 18 | 18 | 1 |
| 103 | 1 | N/A | 24 | 30 | 0 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 0 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 1 |
| 113 | 2 | 24 | 24 | 24 | 0 |
| 114 | 3 | 24 | 36 | 36 | 1 |
| 115 | 3 | 24 | N/A | 24 | 0 |
| 116 | 3 | 24 | N/A | 24 | 0 |
| 117 | 3 | 24 | N/A | 24 | 0 |
| 118 | 3 | 24 | N/A | 24 | 0 |
| 119 | 3 | 24 | N/A | 24 | 0 |
| 120 | 3 | 24 | N/A | 24 | 0 |
| 121 | 3 | 24 | N/A | 24 | 0 |
| 122 | 3 | 24 | N/A | 36 | 0 |
| 123 | 2 | 24 | 24 | 24 | 0 |
| 124 | 3 | 24 | N/A | 36 | 1 |
| 125 | 3 | 24 | N/A | 24 | 0 |
| 126 | 3 | 24 | N/A | 24 | 0 |
| 127 | 3 | 24 | N/A | 36 | 1 |
| 128 | 3 | 24 | N/A | 24 | 0 |
| 129 | 3 | 24 | N/A | 36 | 1 |
| 130 | 3 | 24 | N/A | 24 | 0 |
| A | B | I | J | K | L |

Zazingo Table 5C
Multi-Directional, Multi-Dimensional
Reverse Matrix Auction

Qualifying Bids>>>>>>>>>>>>>>>>>>>>>>>>>>

| 101 | 1 | $0 | $5,500 | $3,500 | |
|---|---|---|---|---|---|
| | | Maximum Position Other Funding | | | Inclusion By |
| Bid | Priority | Senior | Subordinate | Same | Other Funding |
| | | $0 | $5,500 | $0 | |
| 101 | 1 | $0 | $0 | $0 | 1 |
| 102 | 2 | $0 | $1,000 | $0 | 1 |
| 103 | 1 | $0 | $0 | $0 | 1 |
| 104 | 1 | $0 | $0 | $0 | 1 |
| 105 | 1 | $0 | $0 | $0 | 1 |
| 106 | 1 | $0 | $0 | $0 | 1 |
| 107 | 1 | $0 | $0 | $0 | 0 |
| 108 | 3 | $0 | $0 | $0 | 1 |
| 109 | 1 | $0 | $0 | $0 | 0 |
| 110 | 1 | $0 | $0 | $0 | 0 |
| 111 | 3 | $0 | $0 | $0 | 0 |
| 112 | 2 | $0 | $1,000 | $0 | 1 |
| 113 | 2 | $0 | $0 | $0 | 1 |
| 114 | 3 | $0 | $2,000 | $0 | 1 |
| 115 | 3 | $0 | $0 | $0 | 0 |
| 116 | 3 | $0 | $0 | $0 | 1 |
| 117 | 3 | $0 | $0 | $0 | 1 |
| 118 | 3 | $0 | $0 | $0 | 1 |
| 119 | 3 | $0 | $0 | $0 | 1 |
| 120 | 3 | $0 | $0 | $0 | 1 |
| 121 | 3 | $0 | $0 | $0 | 0 |
| 122 | 3 | $0 | $0 | $0 | 1 |
| 123 | 2 | $0 | $0 | $0 | 0 |
| 124 | 3 | $0 | $1,500 | $0 | 1 |
| 125 | 3 | $0 | $0 | $0 | 1 |
| 126 | 3 | $0 | $0 | $0 | 1 |
| 127 | 3 | $0 | $0 | $0 | 0 |
| 128 | 3 | $0 | $0 | $0 | 0 |
| 129 | 3 | $0 | $0 | $0 | 0 |
| 130 | 3 | $0 | $0 | $0 | 0 |
| A | B | M | N | O | P |

Zazingo BORROWER RESERVE NOT SATISFIED Table 5D
Multi-Directional, Multi-Dimensional
Reverse Matrix Auction

| | | | Borrower | | Lender | | |
|---|---|---|---|---|---|---|---|
| | | | Loan Terms | | Yields On Investment | | |
| 101 | 1 | Selected Bids | | Overall | 1st | 2nd | 3rd |
| | | | Rates >> | 10.35% | 7.00% | 8.50% | 13.32% |
| | | Total | Months >> | 36.0 | 36.0 | 36.0 | 36.0 |
| Bid | Priority | $7,500 | Mo. Pmt >> | $243.38 | $2,000 | $2,000 | $3,500 |
| 101 | 1 | $2,000 | | $61.75 | $2,000 | $0 | $0 |
| 102 | 2 | $1,000 | | $30.99 | $0 | $1,000 | $0 |
| 103 | 1 | $0 | | $0.00 | $0 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $0 | | $0.00 | $0 | $0 | $0 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $1,000 | | $32.15 | $0 | $1,000 | $0 |
| 113 | 2 | $0 | | $0.00 | $0 | $0 | $0 |
| 114 | 3 | $2,000 | | $66.67 | $0 | $0 | $2,000 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $1,500 | | $51.81 | $0 | $0 | $1,500 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 6
Zazingo Table 6A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 102 | 2 | | | 36 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 6B
Multi-Directional, Multi-Dimensional
Reverse Matrix Auction

| | | Compatability Factors | | | Qualifying |
|---|---|---|---|---|---|
| | | Continued | | | Bids |
| 102 | 2 | 24 | 18 | 18 | |
| | | Minimum Term By Position | | | Inclusion |
| Bid | Priority | Senior | Subordinate | Same | By Term |
| 101 | 1 | N/A | 36 | 36 | 1 |
| 102 | 2 | 24 | 18 | 18 | 1 |
| 103 | 1 | N/A | 24 | 30 | 0 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 0 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 1 |
| 113 | 2 | 24 | 24 | 24 | 0 |
| 114 | 3 | 24 | 36 | 36 | 1 |
| 115 | 3 | 24 | N/A | 24 | 0 |
| 116 | 3 | 24 | N/A | 24 | 0 |
| 117 | 3 | 24 | N/A | 24 | 0 |
| 118 | 3 | 24 | N/A | 24 | 0 |
| 119 | 3 | 24 | N/A | 24 | 0 |
| 120 | 3 | 24 | N/A | 24 | 0 |
| 121 | 3 | 24 | N/A | 24 | 0 |
| 122 | 3 | 24 | N/A | 36 | 0 |
| 123 | 2 | 24 | 24 | 24 | 0 |
| 124 | 3 | 24 | N/A | 36 | 1 |
| 125 | 3 | 24 | N/A | 24 | 0 |
| 126 | 3 | 24 | N/A | 24 | 0 |
| 127 | 3 | 24 | N/A | 36 | 1 |
| 128 | 3 | 24 | N/A | 24 | 0 |
| 129 | 3 | 24 | N/A | 36 | 1 |
| 130 | 3 | 24 | N/A | 24 | 0 |
| A | B | I | J | K | L |

Zazingo Table 6C
Multi-Directional, Multi-Dimensional
Reverse Matrix Auction

Qualifying Bids>>>>>>>>>>>>>>>>>>>>>>>>>>

| 102 | 2 | $9,000 | $9,000 | $3,500 | |
|---|---|---|---|---|---|
| | | Maximum Position Other Funding | | | Inclusion By |
| Bid | Priority | Senior | Subordinate | Same | Other Funding |
| | | $2,000 | $9,000 | $1,000 | |
| 101 | 1 | $2,000 | $0 | $0 | 0 |
| 102 | 2 | $0 | $0 | $0 | 1 |
| 103 | 1 | $0 | $0 | $0 | 1 |
| 104 | 1 | $0 | $0 | $0 | 0 |
| 105 | 1 | $0 | $0 | $0 | 0 |
| 106 | 1 | $0 | $0 | $0 | 0 |
| 107 | 1 | $0 | $0 | $0 | 0 |
| 108 | 3 | $0 | $0 | $0 | 1 |
| 109 | 1 | $0 | $0 | $0 | 0 |
| 110 | 1 | $0 | $0 | $0 | 0 |
| 111 | 3 | $0 | $0 | $0 | 0 |
| 112 | 2 | $0 | $0 | $1,000 | 1 |
| 113 | 2 | $0 | $0 | $0 | 1 |
| 114 | 3 | $0 | $2,000 | $0 | 1 |
| 115 | 3 | $0 | $0 | $0 | 0 |
| 116 | 3 | $0 | $0 | $0 | 0 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 0 |
| 122 | 3 | $0 | $0 | $0 | 1 |
| 123 | 2 | $0 | $0 | $0 | 0 |
| 124 | 3 | $0 | $3,500 | $0 | 0 |
| 125 | 3 | $0 | $0 | $0 | 0 |
| 126 | 3 | $0 | $0 | $0 | 0 |
| 127 | 3 | $0 | $3,000 | $0 | 1 |
| 128 | 3 | $0 | $0 | $0 | 0 |
| 129 | 3 | $0 | $500 | $0 | 0 |
| 130 | 3 | $0 | $0 | $0 | 0 |
| A | B | M | N | O | P |

Zazingo BORROWER RESERVE NOT SATISFIED Table 6D
Multi-Directional, Multi-Dimensional
Reverse Matrix Auction

| | | | Borrower | | Lender | | |
|---|---|---|---|---|---|---|---|
| | | | Loan Terms | | Yields On Investment | | |
| 102 | 2 | Selected Bids | | Overall | 1st | 2nd | 3rd |
| | | | Rates >> | 12.57% | 0.00% | 8.50% | 14.20% |
| | | Total | Months >> | 36.0 | 0.0 | 36.0 | 36.0 |
| Bid | Priority | $7,000 | Mo. Pmt >> | $234.54 | $0 | $2,000 | $5,000 |
| 101 | 1 | $0 | | $0.00 | $0 | $0 | $0 |
| 102 | 2 | $1,000 | | $30.99 | $0 | $1,000 | $0 |
| 103 | 1 | $0 | | $0.00 | $0 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $0 | | $0.00 | $0 | $0 | $0 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $1,000 | | $32.15 | $0 | $1,000 | $0 |
| 113 | 2 | $0 | | $0.00 | $0 | $0 | $0 |
| 114 | 3 | $2,000 | | $66.67 | $0 | $0 | $2,000 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $3,000 | | $104.73 | $0 | $0 | $3,000 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 7
Zazingo Table 7A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 103 | 1 | | | 30 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 7B
Multi-Directional, Multi-Dimensional
Reverse Matrix Auction

| | | Compatability Factors | | | Qualifying |
|---|---|---|---|---|---|
| | | Continued | | | Bids |
| 103 | 1 | N/A | 24 | 30 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 1 |
| 103 | 1 | N/A | 24 | 30 | 1 |
| 104 | 1 | N/A | 36 | 30 | 1 |
| 105 | 1 | N/A | 42 | 24 | 0 |
| 106 | 1 | N/A | 48 | 24 | 0 |
| 107 | 1 | N/A | 36 | 30 | 1 |
| 108 | 3 | 24 | 60 | 24 | 0 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 1 |
| 113 | 2 | 24 | 24 | 24 | 0 |
| 114 | 3 | 24 | 36 | 36 | 1 |
| 115 | 3 | 24 | N/A | 24 | 0 |
| 116 | 3 | 24 | N/A | 24 | 0 |
| 117 | 3 | 24 | N/A | 24 | 0 |
| 118 | 3 | 24 | N/A | 24 | 0 |
| 119 | 3 | 24 | N/A | 24 | 0 |
| 120 | 3 | 24 | N/A | 24 | 0 |
| 121 | 3 | 24 | N/A | 24 | 0 |
| 122 | 3 | 24 | N/A | 36 | 0 |
| 123 | 2 | 24 | 24 | 24 | 0 |
| 124 | 3 | 24 | N/A | 36 | 1 |
| 125 | 3 | 24 | N/A | 24 | 0 |
| 126 | 3 | 24 | N/A | 24 | 0 |
| 127 | 3 | 24 | N/A | 36 | 1 |
| 128 | 3 | 24 | N/A | 24 | 0 |
| 129 | 3 | 24 | N/A | 36 | 1 |
| 130 | 3 | 24 | N/A | 24 | 0 |
| A | B | I | J | K | L |

Zazingo Table 7C
Multi-Directional, Multi-Dimensional
Reverse Matrix Auction

Qualifying Bids>>>>>>>>>>>>>>>>>>>>>>>>>>

| 103 | 1 | $0 | $7,000 | $2,000 | |
|---|---|---|---|---|---|
| | | Maximum Position Other Funding | | | Inclusion By |
| Bid | Priority | Senior | Subordinate | Same | Other Funding |
| | | $0 | $7,000 | $2,000 | |
| 101 | 1 | $0 | $0 | $0 | 0 |
| 102 | 2 | $0 | $1,000 | $0 | 1 |
| 103 | 1 | $0 | $0 | $0 | 1 |
| 104 | 1 | $0 | $0 | $2,000 | 1 |
| 105 | 1 | $0 | $0 | $0 | 0 |
| 106 | 1 | $0 | $0 | $0 | 0 |
| 107 | 1 | $0 | $0 | $0 | 0 |
| 108 | 3 | $0 | $0 | $0 | 0 |
| 109 | 1 | $0 | $0 | $0 | 0 |
| 110 | 1 | $0 | $0 | $0 | 0 |
| 111 | 3 | $0 | $0 | $0 | 0 |
| 112 | 2 | $0 | $1,000 | $0 | 1 |
| 113 | 2 | $0 | $0 | $0 | 1 |
| 114 | 3 | $0 | $2,000 | $0 | 1 |
| 115 | 3 | $0 | $0 | $0 | 0 |
| 116 | 3 | $0 | $0 | $0 | 0 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 0 |
| 122 | 3 | $0 | $0 | $0 | 1 |
| 123 | 2 | $0 | $0 | $0 | 0 |
| 124 | 3 | $0 | $3,000 | $0 | 1 |
| 125 | 3 | $0 | $0 | $0 | 0 |
| 126 | 3 | $0 | $0 | $0 | 0 |
| 127 | 3 | $0 | $0 | $0 | 0 |
| 128 | 3 | $0 | $0 | $0 | 0 |
| 129 | 3 | $0 | $0 | $0 | 0 |
| 130 | 3 | $0 | $0 | $0 | 0 |
| A | B | M | N | O | P |

Zazingo Table 7D
Multi-Directional, Multi-Dimensional
Reverse Matrix Auction

| | | | Borrower | | Lender | | |
|---|---|---|---|---|---|---|---|
| | | | Loan Terms | | Yields On Investment | | |
| 103 | 1 | Selected Bids | | Overall | 1st | 2nd | 3rd |
| | | | Rates >> | 10.51% | 7.64% | 8.50% | 13.64% |
| | | Total | Months >> | 33.9 | 30.0 | 36.0 | 36.0 |
| Bid | Priority | $10,000 | Mo. Pmt >> | $344.70 | $3,500 | $2,000 | $4,500 |
| 101 | 1 | $0 | | $0.00 | $0 | $0 | $0 |
| 102 | 2 | $1,000 | | $30.99 | $0 | $1,000 | $0 |
| 103 | 1 | $1,500 | | $54.99 | $1,500 | $0 | $0 |
| 104 | 1 | $2,000 | | $73.55 | $2,000 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $0 | | $0.00 | $0 | $0 | $0 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $1,000 | | $32.15 | $0 | $1,000 | $0 |
| 113 | 2 | $0 | | $0.00 | $0 | $0 | $0 |
| 114 | 3 | $2,000 | | $66.67 | $0 | $0 | $2,000 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $2,500 | | $86.36 | $0 | $0 | $2,500 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 8
Zazingo Table 8A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 104 | 1 | | | 30 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 8B
Multi-Directional, Multi-Dimensional
Reverse Matrix Auction

| | | Compatability Factors | | | Qualifying |
|---|---|---|---|---|---|
| | | Continued | | | Bids |
| 104 | 1 | N/A | 36 | 30 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 1 |
| 103 | 1 | N/A | 24 | 30 | 1 |
| 104 | 1 | N/A | 36 | 30 | 1 |
| 105 | 1 | N/A | 42 | 24 | 0 |
| 106 | 1 | N/A | 48 | 24 | 0 |
| 107 | 1 | N/A | 36 | 30 | 1 |
| 108 | 3 | 24 | 60 | 24 | 0 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 1 |
| 113 | 2 | 24 | 24 | 24 | 0 |
| 114 | 3 | 24 | 36 | 36 | 1 |
| 115 | 3 | 24 | N/A | 24 | 0 |
| 116 | 3 | 24 | N/A | 24 | 0 |
| 117 | 3 | 24 | N/A | 24 | 0 |
| 118 | 3 | 24 | N/A | 24 | 0 |
| 119 | 3 | 24 | N/A | 24 | 0 |
| 120 | 3 | 24 | N/A | 24 | 0 |
| 121 | 3 | 24 | N/A | 24 | 0 |
| 122 | 3 | 24 | N/A | 36 | 0 |
| 123 | 2 | 24 | 24 | 24 | 0 |
| 124 | 3 | 24 | N/A | 36 | 1 |
| 125 | 3 | 24 | N/A | 24 | 0 |
| 126 | 3 | 24 | N/A | 24 | 0 |
| 127 | 3 | 24 | N/A | 36 | 1 |
| 128 | 3 | 24 | N/A | 24 | 0 |
| 129 | 3 | 24 | N/A | 36 | 1 |
| 130 | 3 | 24 | N/A | 24 | 0 |
| A | B | I | J | K | L |

Zazingo Table 8C
Multi-Directional, Multi-Dimensional
Reverse Matrix Auction

| | | Qualifying Bids>>>>>>>>>>>>>>>>>>>>>>>>>> | | | |
|---|---|---|---|---|---|
| 104 | 1 | $0 | $6,500 | $4,500 | |
| | | Maximum Position Other Funding | | | Inclusion By |
| Bid | Priority | Senior | Subordinate | Same | Other Funding |
| | | $0 | $6,500 | $4,500 | |
| 101 | 1 | $0 | $0 | $0 | 0 |
| 102 | 2 | $0 | $1,000 | $0 | 1 |
| 103 | 1 | $0 | $0 | $1,500 | 0 |
| 104 | 1 | $0 | $0 | $0 | 1 |
| 105 | 1 | $0 | $0 | $0 | 0 |
| 106 | 1 | $0 | $0 | $0 | 1 |
| 107 | 1 | $0 | $0 | $3,000 | 1 |
| 108 | 3 | $0 | $0 | $0 | 0 |
| 109 | 1 | $0 | $0 | $0 | 0 |
| 110 | 1 | $0 | $0 | $0 | 0 |
| 111 | 3 | $0 | $0 | $0 | 1 |
| 112 | 2 | $0 | $1,000 | $0 | 1 |
| 113 | 2 | $0 | $0 | $0 | 1 |
| 114 | 3 | $0 | $2,000 | $0 | 1 |
| 115 | 3 | $0 | $0 | $0 | 0 |
| 116 | 3 | $0 | $0 | $0 | 0 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 0 |
| 122 | 3 | $0 | $0 | $0 | 0 |
| 123 | 2 | $0 | $0 | $0 | 1 |
| 124 | 3 | $0 | $2,500 | $0 | 1 |
| 125 | 3 | $0 | $0 | $0 | 1 |
| 126 | 3 | $0 | $0 | $0 | 1 |
| 127 | 3 | $0 | $0 | $0 | 1 |
| 128 | 3 | $0 | $0 | $0 | 0 |
| 129 | 3 | $0 | $0 | $0 | 0 |
| 130 | 3 | $0 | $0 | $0 | 0 |
| A | B | M | N | O | P |

Zazingo Table 8D
Multi-Directional, Multi-Dimensional
Reverse Matrix Auction

| | | | Borrower | | Lender | | |
|---|---|---|---|---|---|---|---|
| | | | Loan Terms | | Yields On Investment | | |
| 104 | 1 | Selected Bids | | Overall | 1st | 2nd | 3rd |
| | | | Rates >> | 9.73% | 8.20% | 8.50% | 13.08% |
| | | Total | Months >> | 33.0 | 30.0 | 36.0 | 36.0 |
| Bid | Priority | $10,000 | Mo. Pmt >> | $349.25 | $5,000 | $2,000 | $3,000 |
| 101 | 1 | $0 | | $0.00 | $0 | $0 | $0 |
| 102 | 2 | $1,000 | | $30.99 | $0 | $1,000 | $0 |
| 103 | 1 | $0 | | $0.00 | $0 | $0 | $0 |
| 104 | 1 | $2000 | | $73.55 | $2,000 | $0 | $0 |
| 105 | 1 | $0 | | $0.00 | $0 | $0 | $0 |
| 106 | 1 | $0 | | $0.00 | $0 | $0 | $0 |
| 107 | 1 | $3,000 | | $111.35 | $3,000 | $0 | $0 |
| 108 | 3 | $0 | | $0.00 | $0 | $0 | $0 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $1,000 | | $32.15 | $0 | $1,000 | $0 |
| 113 | 2 | $0 | | $0.00 | $0 | $0 | $0 |
| 114 | 3 | $2,000 | | $66.67 | $0 | $0 | $2,000 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $1,000 | | $34.54 | $0 | $0 | $1,000 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 9
Zazingo Table 9A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 105 | 1 | | | 24 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 9B
Multi-Directional, Multi-Dimensional
Reverse Matrix Auction

| | | Compatability Factors | | | Qualifying |
|---|---|---|---|---|---|
| | | Continued | | | Bids |
| 105 | 1 | N/A | 42 | 24 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 0 |
| 103 | 1 | N/A | 24 | 30 | 0 |
| 104 | 1 | N/A | 36 | 30 | 0 |
| 105 | 1 | N/A | 42 | 24 | 1 |
| 106 | 1 | N/A | 48 | 24 | 1 |
| 107 | 1 | N/A | 36 | 30 | 0 |
| 108 | 3 | 24 | 60 | 24 | 0 |
| 109 | 1 | N/A | 66 | 24 | 0 |
| 110 | 1 | N/A | 72 | 24 | 1 |
| 111 | 3 | 24 | 12 | 12 | 0 |
| 112 | 2 | 24 | 18 | 36 | 0 |
| 113 | 2 | 24 | 24 | 24 | 0 |
| 114 | 3 | 24 | 36 | 36 | 0 |
| 115 | 3 | 24 | N/A | 24 | 0 |
| 116 | 3 | 24 | N/A | 24 | 0 |
| 117 | 3 | 24 | N/A | 24 | 0 |
| 118 | 3 | 24 | N/A | 24 | 0 |
| 119 | 3 | 24 | N/A | 24 | 0 |
| 120 | 3 | 24 | N/A | 24 | 0 |
| 121 | 3 | 24 | N/A | 24 | 0 |
| 122 | 3 | 24 | N/A | 36 | 0 |
| 123 | 2 | 24 | 24 | 24 | 0 |
| 124 | 3 | 24 | N/A | 36 | 0 |
| 125 | 3 | 24 | N/A | 24 | 0 |
| 126 | 3 | 24 | N/A | 24 | 0 |
| 127 | 3 | 24 | N/A | 36 | 0 |
| 128 | 3 | 24 | N/A | 24 | 0 |
| 129 | 3 | 24 | N/A | 36 | 0 |
| 130 | 3 | 24 | N/A | 24 | 0 |
| A | B | I | J | K | L |

Zazingo Table 9C
Multi-Directional, Multi-Dimensional
Reverse Matrix Auction

| | | Qualifying Bids>>>>>>>>>>>>>>>>>>>>>>>>>> | | | |
|---|---|---|---|---|---|
| 105 | 1 | $0 | $6,000 | $2,000 | |
| | | Maximum Position Other Funding | | | Inclusion By |
| Bid | Priority | Senior | Subordinate | Same | Other Funding |
| | | $0 | $0 | $2,000 | |
| 101 | 1 | $0 | $0 | $0 | 0 |
| 102 | 2 | $0 | $0 | $0 | 1 |
| 103 | 1 | $0 | $0 | $0 | 0 |
| 104 | 1 | $0 | $0 | $0 | 1 |
| 105 | 1 | $0 | $0 | $0 | 1 |
| 106 | 1 | $0 | $0 | $2,000 | 1 |
| 107 | 1 | $0 | $0 | $0 | 0 |
| 108 | 3 | $0 | $0 | $0 | 1 |
| 109 | 1 | $0 | $0 | $0 | 1 |
| 110 | 1 | $0 | $0 | $0 | 1 |
| 111 | 3 | $0 | $0 | $0 | 1 |
| 112 | 2 | $0 | $0 | $0 | 1 |
| 113 | 2 | $0 | $0 | $0 | 1 |
| 114 | 3 | $0 | $0 | $0 | 1 |
| 115 | 3 | $0 | $0 | $0 | 0 |
| 116 | 3 | $0 | $0 | $0 | 0 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 1 |
| 122 | 3 | $0 | $0 | $0 | 1 |
| 123 | 2 | $0 | $0 | $0 | 1 |
| 124 | 3 | $0 | $0 | $0 | 1 |
| 125 | 3 | $0 | $0 | $0 | 1 |
| 126 | 3 | $0 | $0 | $0 | 1 |
| 127 | 3 | $0 | $0 | $0 | 1 |
| 128 | 3 | $0 | $0 | $0 | 1 |
| 129 | 3 | $0 | $0 | $0 | 1 |
| 130 | 3 | $0 | $0 | $0 | 1 |
| A | B | M | N | O | P |

Zazingo BORROWER RESERVE NOT SATISFIED Table 9D
Multi-Directional, Multi-Dimensional
Reverse Matrix Auction

| | | | Borrower | | Lender | | |
|---|---|---|---|---|---|---|---|
| | | Selected | Loan Terms | | Yields On Investment | | |
| 105 | 1 | Bids | | Overall | 1st | 2nd | 3rd |
| | | | Rates >> | 8.11% | 8.11% | 0.00% | 0.00% |
| | | Total | Months >> | 24.0 | 24.0 | 0.0 | 0.0 |
| Bid | Priority | $4,500 | Mo. Pmt >> | $203.75 | $4,500 | $0 | $0 |
| 101 | 1 | $0 | | $0.00 | $0 | $0 | $0 |
| 102 | 2 | $0 | | $0.00 | $0 | $0 | $0 |
| 103 | 1 | $0 | | $0.00 | $0 | $0 | $0 |
| 104 | 1 | $0 | | $0.00 | $0 | $0 | $0 |
| 105 | 1 | $2,500 | | $113.07 | $2,500 | $0 | $0 |
| 106 | 1 | $2,000 | | $90.68 | $2,000 | $0 | $0 |
| 107 | 1 | $0 | | $0.00 | $0 | $0 | $0 |
| 108 | 3 | $0 | | $0.00 | $0 | $0 | $0 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $0 | | $0.00 | $0 | $0 | $0 |
| 113 | 2 | $0 | | $0.00 | $0 | $0 | $0 |
| 114 | 3 | $0 | | $0.00 | $0 | $0 | $0 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 10
Zazingo Table 10A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 106 | 1 | | | 24 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 10B
Multi-Directional, Multi-Dimensional
Reverse Matrix Auction

| | | Compatability Factors | | | Qualifying |
|---|---|---|---|---|---|
| | | Continued | | | Bids |
| 106 | 1 | N/A | 48 | 24 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 0 |
| 103 | 1 | N/A | 24 | 30 | 0 |
| 104 | 1 | N/A | 36 | 30 | 0 |
| 105 | 1 | N/A | 42 | 24 | 1 |
| 106 | 1 | N/A | 48 | 24 | 1 |
| 107 | 1 | N/A | 36 | 30 | 0 |
| 108 | 3 | 24 | 60 | 24 | 0 |
| 109 | 1 | N/A | 66 | 24 | 0 |
| 110 | 1 | N/A | 72 | 24 | 1 |
| 111 | 3 | 24 | 12 | 12 | 0 |
| 112 | 2 | 24 | 18 | 36 | 0 |
| 113 | 2 | 24 | 24 | 24 | 0 |
| 114 | 3 | 24 | 36 | 36 | 0 |
| 115 | 3 | 24 | N/A | 24 | 0 |
| 116 | 3 | 24 | N/A | 24 | 0 |
| 117 | 3 | 24 | N/A | 24 | 0 |
| 118 | 3 | 24 | N/A | 24 | 0 |
| 119 | 3 | 24 | N/A | 24 | 0 |
| 120 | 3 | 24 | N/A | 24 | 0 |
| 121 | 3 | 24 | N/A | 24 | 0 |
| 122 | 3 | 24 | N/A | 36 | 0 |
| 123 | 2 | 24 | 24 | 24 | 0 |
| 124 | 3 | 24 | N/A | 36 | 0 |
| 125 | 3 | 24 | N/A | 24 | 0 |
| 126 | 3 | 24 | N/A | 24 | 0 |
| 127 | 3 | 24 | N/A | 36 | 0 |
| 128 | 3 | 24 | N/A | 24 | 0 |
| 129 | 3 | 24 | N/A | 36 | 0 |
| 130 | 3 | 24 | N/A | 24 | 0 |
| A | B | I | J | K | L |

Zazingo Table 10C
Multi-Directional, Multi-Dimensional
Reverse Matrix Auction

| | | Qualifying Bids>>>>>>>>>>>>>>>>>>>>>>>>>> | | | |
|---|---|---|---|---|---|
| 106 | 1 | $0 | $5,500 | $5,500 | |
| | | Maximum Position Other Funding | | | Inclusion By |
| Bid | Priority | Senior | Subordinate | Same | Other Funding |
| | | $0 | $0 | $5,500 | |
| 101 | 1 | $0 | $0 | $0 | 0 |
| 102 | 2 | $0 | $0 | $0 | 1 |
| 103 | 1 | $0 | $0 | $0 | 0 |
| 104 | 1 | $0 | $0 | $0 | 0 |
| 105 | 1 | $0 | $0 | $2,500 | 0 |
| 107 | 1 | $0 | $0 | $0 | 0 |
| 108 | 3 | $0 | $0 | $0 | 0 |
| 109 | 1 | $0 | $0 | $0 | 1 |
| 110 | 1 | $0 | $0 | $3,000 | 1 |
| 111 | 3 | $0 | $0 | $0 | 1 |
| 112 | 2 | $0 | $0 | $0 | 1 |
| 113 | 2 | $0 | $0 | $0 | 1 |
| 114 | 3 | $0 | $0 | $0 | 1 |
| 115 | 3 | $0 | $0 | $0 | 0 |
| 116 | 3 | $0 | $0 | $0 | 0 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 0 |
| 122 | 3 | $0 | $0 | $0 | 0 |
| 123 | 2 | $0 | $0 | $0 | 1 |
| 124 | 3 | $0 | $0 | $0 | 1 |
| 125 | 3 | $0 | $0 | $0 | 1 |
| 126 | 3 | $0 | $0 | $0 | 1 |
| 127 | 3 | $0 | $0 | $0 | 1 |
| 128 | 3 | $0 | $0 | $0 | 1 |
| 129 | 3 | $0 | $0 | $0 | 1 |
| 130 | 3 | $0 | $0 | $0 | 1 |
| A | B | M | N | O | P |

Zazingo BORROWER RESERVE NOT SATISFIED Table 10D
Multi-Directional, Multi-Dimensional
Reverse Matrix Auction

| | | | Borrower | | Lender | | |
|---|---|---|---|---|---|---|---|
| | | Selected | Loan Terms | | Yields On Investment | | |
| 106 | 1 | Bids | | Overall | 1st | 2nd | 3rd |
| | | | Rates >> | 8.75% | 8.75% | 0.00% | 0.00% |
| | | Total | Months >> | 24.0 | 24.0 | 0.0 | 0.0 |
| Bid | Priority | $6,000 | Mo. Pmt >> | $273.42 | $6,000 | $0 | $0 |
| 101 | 1 | $0 | | $0.00 | $0 | $0 | $0 |
| 102 | 2 | $0 | | $0.00 | $0 | $0 | $0 |
| 103 | 1 | $0 | | $0.00 | $0 | $0 | $0 |
| 104 | 1 | $0 | | $0.00 | $0 | $0 | $0 |
| 105 | 1 | $0 | | $0.00 | $0 | $0 | $0 |
| 106 | 1 | $3,000 | | $136.02 | $3,000 | $0 | $0 |
| 107 | 1 | $0 | | $0.00 | $0 | $0 | $0 |
| 108 | 3 | $0 | | $0.00 | $0 | $0 | $0 |
| 109 | 1 | $0 | | $0.00 | $0 | $0 | $0 |
| 110 | 1 | $3,000 | | $137.40 | $3,000 | $0 | $0 |
| 111 | 3 | $0 | | $0.00 | $0 | $0 | $0 |
| 112 | 2 | $0 | | $0.00 | $0 | $0 | $0 |
| 113 | 2 | $0 | | $0.00 | $0 | $0 | $0 |
| 114 | 3 | $0 | | $0.00 | $0 | $0 | $0 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 11
Zazingo Table 11A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 107 | 1 | | | 30 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 11B
Multi-Directional, Multi-Dimensional
Reverse Matrix Auction

| | | Compatability Factors | | | Qualifying |
|---|---|---|---|---|---|
| | | Continued | | | Bids |
| 107 | 1 | N/A | 36 | 30 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 1 |
| 103 | 1 | N/A | 24 | 30 | 1 |
| 104 | 1 | N/A | 36 | 30 | 1 |
| 105 | 1 | N/A | 42 | 24 | 0 |
| 106 | 1 | N/A | 48 | 24 | 0 |
| 107 | 1 | N/A | 36 | 30 | 1 |
| 108 | 3 | 24 | 60 | 24 | 0 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 1 |
| 113 | 2 | 24 | 24 | 24 | 0 |
| 114 | 3 | 24 | 36 | 36 | 1 |
| 115 | 3 | 24 | N/A | 24 | 0 |
| 116 | 3 | 24 | N/A | 24 | 0 |
| 117 | 3 | 24 | N/A | 24 | 0 |
| 118 | 3 | 24 | N/A | 24 | 0 |
| 119 | 3 | 24 | N/A | 24 | 0 |
| 120 | 3 | 24 | N/A | 24 | 0 |
| 121 | 3 | 24 | N/A | 24 | 0 |
| 122 | 3 | 24 | N/A | 36 | 0 |
| 123 | 2 | 24 | 24 | 24 | 0 |
| 124 | 3 | 24 | N/A | 36 | 1 |
| 125 | 3 | 24 | N/A | 24 | 0 |
| 126 | 3 | 24 | N/A | 24 | 0 |
| 127 | 3 | 24 | N/A | 36 | 1 |
| 128 | 3 | 24 | N/A | 24 | 0 |
| 129 | 3 | 24 | N/A | 36 | 1 |
| 130 | 3 | 24 | N/A | 24 | 0 |
| A | B | I | J | K | L |

Zazingo Table 11C
Multi-Directional, Multi-Dimensional
Reverse Matrix Auction

| | | Qualifying Bids>>>>>>>>>>>>>>>>>>>>>>>>>> | | | |
|---|---|---|---|---|---|
| 107 | 1 | $0 | $5,000 | $4,000 | |
| | | Maximum Position Other Funding | | | Inclusion By |
| Bid | Priority | Senior | Subordinate | Same | Other Funding |
| | | $0 | $5,000 | $3,500 | |
| 101 | 1 | $0 | $0 | $0 | 0 |
| 102 | 2 | $0 | $1,000 | $0 | 1 |
| 103 | 1 | $0 | $0 | $1,500 | 0 |
| 104 | 1 | $0 | $0 | $2,000 | 1 |
| 105 | 1 | $0 | $0 | $0 | 0 |
| 106 | 1 | $0 | $0 | $0 | 0 |
| 107 | 1 | $0 | $0 | $0 | 1 |
| 108 | 3 | $0 | $0 | $0 | 0 |
| 109 | 1 | $0 | $0 | $0 | 1 |
| 110 | 1 | $0 | $0 | $0 | 0 |
| 111 | 3 | $0 | $0 | $0 | 1 |
| 112 | 2 | $0 | $1,000 | $0 | 1 |
| 113 | 2 | $0 | $0 | $0 | 1 |
| 114 | 3 | $0 | $2,000 | $0 | 1 |
| 115 | 3 | $0 | $0 | $0 | 0 |
| 116 | 3 | $0 | $0 | $0 | 0 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 0 |
| 122 | 3 | $0 | $0 | $0 | 0 |
| 123 | 2 | $0 | $0 | $0 | 1 |
| 124 | 3 | $0 | $1,000 | $0 | 1 |
| 125 | 3 | $0 | $0 | $0 | 0 |
| 126 | 3 | $0 | $0 | $0 | 0 |
| 127 | 3 | $0 | $0 | $0 | 1 |
| 128 | 3 | $0 | $0 | $0 | 1 |
| 129 | 3 | $0 | $0 | $0 | 1 |
| 130 | 3 | $0 | $0 | $0 | 0 |
| A | B | M | N | O | P |

Zazingo 11D
Multi-Directional, Multi-Dimensional
Reverse Matrix Auction

| | | | Borrower | | Lender | | |
|---|---|---|---|---|---|---|---|
| | | Selected | Loan Terms | | Yields On Investment | | |
| 107 | 1 | Bids | | Overall | 1st | 2nd | 3rd |
| | | | Rates >> | 9.10% | 8.25% | 8.50% | 12.25% |
| | | Total | Months >> | 32.4 | 30.0 | 36.0 | 36.0 |
| Bid | Priority | $10,000 | Mo. Pmt >> | $351.83 | $6,000 | $2,000 | $2,000 |
| 101 | 1 | $0 | | $0.00 | $0 | $0 | $0 |
| 102 | 2 | $1,000 | | $30.99 | $0 | $1,000 | $0 |
| 103 | 1 | $0 | | $0.00 | $0 | $0 | $0 |
| 104 | 1 | $2,000 | | $73.55 | $2,000 | $0 | $0 |
| 105 | 1 | $0 | | $0.00 | $0 | $0 | $0 |
| 106 | 1 | $0 | | $0.00 | $0 | $0 | $0 |
| 107 | 1 | $4,000 | | $148.47 | $4,000 | $0 | $0 |
| 108 | 3 | $0 | | $0.00 | $0 | $0 | $0 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $1,000 | | $32.15 | $0 | $1,000 | $0 |
| 113 | 2 | $0 | | $0.00 | $0 | $0 | $0 |
| 114 | 3 | $2,000 | | $66.67 | $0 | $0 | $2,000 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 12
Zazingo Table 12A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 108 | 3 | | | 24 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 12B
Multi-Directional, Multi-Dimensional
Reverse Matrix Auction

| | | Compatability Factors | | | Qualifying |
|---|---|---|---|---|---|
| | | Continued | | | Bids |
| 108 | 3 | 24 | 60 | 24 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 1 |
| 103 | 1 | N/A | 24 | 30 | 1 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 1 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 1 |
| 113 | 2 | 24 | 24 | 24 | 0 |
| 114 | 3 | 24 | 36 | 36 | 0 |
| 115 | 3 | 24 | N/A | 24 | 1 |
| 116 | 3 | 24 | N/A | 24 | 1 |
| 117 | 3 | 24 | N/A | 24 | 1 |
| 118 | 3 | 24 | N/A | 24 | 1 |
| 119 | 3 | 24 | N/A | 24 | 1 |
| 120 | 3 | 24 | N/A | 24 | 1 |
| 121 | 3 | 24 | N/A | 24 | 1 |
| 122 | 3 | 24 | N/A | 36 | 0 |
| 123 | 2 | 24 | 24 | 24 | 0 |
| 124 | 3 | 24 | N/A | 36 | 0 |
| 125 | 3 | 24 | N/A | 24 | 1 |
| 126 | 3 | 24 | N/A | 24 | 1 |
| 127 | 3 | 24 | N/A | 36 | 0 |
| 128 | 3 | 24 | N/A | 24 | 1 |
| 129 | 3 | 24 | N/A | 36 | 0 |
| 130 | 3 | 24 | N/A | 24 | 1 |
| A | B | I | J | K | L |

Zazingo Table 12C
Multi-Directional, Multi-Dimensional
Reverse Matrix Auction

| | | Qualifying Bids>>>>>>>>>>>>>>>>>>>>>>>>>> | | | |
|---|---|---|---|---|---|
| 108 | 3 | $5,000 | $4,500 | $6,500 | |
| | | Maximum Position Other Funding | | | Inclusion By |
| Bid | Priority | Senior | Subordinate | Same | Other Funding |
| | | $3,500 | $0 | $6,500 | |
| 101 | 1 | $0 | $0 | $0 | 0 |
| 102 | 2 | $1,000 | $0 | $0 | 1 |
| 103 | 1 | $1,500 | $0 | $0 | 1 |
| 104 | 1 | $0 | $0 | $0 | 1 |
| 105 | 1 | $0 | $0 | $0 | 1 |
| 106 | 1 | $0 | $0 | $0 | 0 |
| 107 | 1 | $0 | $0 | $0 | 0 |
| 109 | 1 | $0 | $0 | $0 | 0 |
| 110 | 1 | $0 | $0 | $0 | 0 |
| 111 | 3 | $0 | $0 | $0 | 0 |
| 112 | 2 | $1,000 | $0 | $0 | 1 |
| 113 | 2 | $0 | $0 | $0 | 1 |
| 114 | 3 | $0 | $0 | $0 | 1 |
| 115 | 3 | $0 | $0 | $2,500 | 0 |
| 116 | 3 | $0 | $0 | $3,000 | 0 |
| 117 | 3 | $0 | $0 | $1,000 | 0 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 0 |
| 122 | 3 | $0 | $0 | $0 | 1 |
| 123 | 2 | $0 | $0 | $0 | 0 |
| 124 | 3 | $0 | $0 | $0 | 0 |
| 125 | 3 | $0 | $0 | $0 | 1 |
| 126 | 3 | $0 | $0 | $0 | 0 |
| 127 | 3 | $0 | $0 | $0 | 0 |
| 128 | 3 | $0 | $0 | $0 | 0 |
| 129 | 3 | $0 | $0 | $0 | 0 |
| 130 | 3 | $0 | $0 | $0 | 0 |
| A | B | M | N | O | P |

Zazingo BORROWER RESERVE NOT SATISFIED Table 12D
Multi-Directional, Multi-Dimensional
Reverse Matrix Auction

| | | | Borrower | | Lender | | |
|---|---|---|---|---|---|---|---|
| | | Selected | Loan Terms | | Yields On Investment | | |
| 108 | 3 | Bids | | Overall | 1st | 2nd | 3rd |
| | | | Rates >> | 8.43% | 7.50% | 8.50% | 8.75% |
| | | Total | Months >> | 28.4 | 30.0 | 36.0 | 24.0 |
| Bid | Priority | $7,500 | Mo. Pmt >> | $300.41 | $1,500 | $2,000 | $4,000 |
| 101 | 1 | $0 | | $0.00 | $0 | $0 | $0 |
| 102 | 2 | $1,000 | | $30.99 | $0 | $1,000 | $0 |
| 103 | 1 | $1,500 | | $54.99 | $1,500 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $4,000 | | $182.28 | $0 | $0 | $4,000 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $1,000 | | $32.15 | $0 | $1,000 | $0 |
| 113 | 2 | $0 | | $0.00 | $0 | $0 | $0 |
| 114 | 3 | $0 | | $0.00 | $0 | $0 | $0 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 13
Zazingo Table 13A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 109 | 1 | | | 18 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 13B
Multi-Directional, Multi-Dimensional
Reverse Matrix Auction

| | | Compatability Factors | | | Qualifying |
|---|---|---|---|---|---|
| | | Continued | | | Bids |
| 109 | 1 | N/A | 66 | 24 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 0 |
| 103 | 1 | N/A | 24 | 30 | 0 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 0 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 0 |
| 113 | 2 | 24 | 24 | 24 | 0 |
| 114 | 3 | 24 | 36 | 36 | 0 |
| 115 | 3 | 24 | N/A | 24 | 0 |
| 116 | 3 | 24 | N/A | 24 | 0 |
| 117 | 3 | 24 | N/A | 24 | 0 |
| 118 | 3 | 24 | N/A | 24 | 0 |
| 119 | 3 | 24 | N/A | 24 | 0 |
| 120 | 3 | 24 | N/A | 24 | 0 |
| 121 | 3 | 24 | N/A | 24 | 0 |
| 122 | 3 | 24 | N/A | 36 | 0 |
| 123 | 2 | 24 | 24 | 24 | 0 |
| 124 | 3 | 24 | N/A | 36 | 0 |
| 125 | 3 | 24 | N/A | 24 | 0 |
| 126 | 3 | 24 | N/A | 24 | 0 |
| 127 | 3 | 24 | N/A | 36 | 0 |
| 128 | 3 | 24 | N/A | 24 | 0 |
| 129 | 3 | 24 | N/A | 36 | 0 |
| 130 | 3 | 24 | N/A | 24 | 0 |
| A | B | I | J | K | L |

Zazingo Table 13C
Multi-Directional, Multi-Dimensional
Reverse Matrix Auction

| | | Qualifying Bids>>>>>>>>>>>>>>>>>>>>>>>>>> | | | |
|---|---|---|---|---|---|
| 109 | 1 | $0 | $4,000 | $7,000 | |
| | | Maximum Position Other Funding | | | Inclusion By |
| Bid | Priority | Senior | Subordinate | Same | Other Funding |
| | | $0 | $0 | $0 | |
| 101 | 1 | $0 | $0 | $0 | 0 |
| 102 | 2 | $0 | $0 | $0 | 1 |
| 103 | 1 | $0 | $0 | $0 | 0 |
| 104 | 1 | $0 | $0 | $0 | 1 |
| 105 | 1 | $0 | $0 | $0 | 0 |
| 106 | 1 | $0 | $0 | $0 | 1 |
| 107 | 1 | $0 | $0 | $0 | 0 |
| 108 | 3 | $0 | $0 | $0 | 1 |
| 109 | 1 | $0 | $0 | $0 | 1 |
| 110 | 1 | $0 | $0 | $0 | 1 |
| 111 | 3 | $0 | $0 | $0 | 1 |
| 112 | 2 | $0 | $0 | $0 | 1 |
| 113 | 2 | $0 | $0 | $0 | 1 |
| 114 | 3 | $0 | $0 | $0 | 1 |
| 115 | 3 | $0 | $0 | $0 | 0 |
| 116 | 3 | $0 | $0 | $0 | 0 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 1 |
| 122 | 3 | $0 | $0 | $0 | 1 |
| 123 | 2 | $0 | $0 | $0 | 1 |
| 124 | 3 | $0 | $0 | $0 | 1 |
| 125 | 3 | $0 | $0 | $0 | 1 |
| 126 | 3 | $0 | $0 | $0 | 1 |
| 127 | 3 | $0 | $0 | $0 | 1 |
| 128 | 3 | $0 | $0 | $0 | 1 |
| 129 | 3 | $0 | $0 | $0 | 1 |
| 130 | 3 | $0 | $0 | $0 | 1 |
| A | B | M | O | P | |

Zazingo BORROWER RESERVE NOT SATISFIED Table 13D
Multi-Directional, Multi-Dimensional
Reverse Matrix Auction

| | | | Borrower | | Lender | | |
|---|---|---|---|---|---|---|---|
| | | Selected | Loan Terms | | Yields On Investment | | |
| 109 | 1 | Bids | | Overall | 1st | 2nd | 3rd |
| | | | Rates >> | 9.00% | 9.00% | 0.00% | 0.00% |
| | | Total | Months >> | 18.0 | 18.0 | 0.0 | 0.0 |
| Bid | Priority | $4,500 | Mo. Pmt >> | $268.19 | $4,500 | $0 | $0 |
| 101 | 1 | $0 | | $0.00 | $0 | $0 | $0 |
| 102 | 2 | $0 | | $0.00 | $0 | $0 | $0 |
| 103 | 1 | $0 | | $0.00 | $0 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $0 | | $0.00 | $0 | $0 | $0 |
| 109 | 1 | $4,500 | | $268.19 | $4,500 | $0 | $0 |
| 110 | 1 | $0 | | $0.00 | $0 | $0 | $0 |
| 111 | 3 | $0 | | $0.00 | $0 | $0 | $0 |
| 112 | 2 | $0 | | $0.00 | $0 | $0 | $0 |
| 113 | 2 | $0 | | $0.00 | $0 | $0 | $0 |
| 114 | 3 | $0 | | $0.00 | $0 | $0 | $0 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 14
Zazingo Table 14A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 110 | 1 | | | 24 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 14B
Multi-Directional, Multi-Dimensional
Reverse Matrix Auction

| | | Compatability Factors | | | Qualifying |
|---|---|---|---|---|---|
| | | Continued | | | Bids |
| 110 | 1 | N/A | 72 | 24 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 0 |
| 103 | 1 | N/A | 24 | 30 | 0 |
| 104 | 1 | N/A | 36 | 30 | 0 |
| 105 | 1 | N/A | 42 | 24 | 1 |
| 106 | 1 | N/A | 48 | 24 | 1 |
| 107 | 1 | N/A | 36 | 30 | 0 |
| 108 | 3 | 24 | 60 | 24 | 0 |
| 109 | 1 | N/A | 66 | 24 | 0 |
| 110 | 1 | N/A | 72 | 24 | 1 |
| 111 | 3 | 24 | 12 | 12 | 0 |
| 112 | 2 | 24 | 18 | 36 | 0 |
| 113 | 2 | 24 | 24 | 24 | 0 |
| 114 | 3 | 24 | 36 | 36 | 0 |
| 115 | 3 | 24 | N/A | 24 | 0 |
| 116 | 3 | 24 | N/A | 24 | 0 |
| 117 | 3 | 24 | N/A | 24 | 0 |
| 118 | 3 | 24 | N/A | 24 | 0 |
| 119 | 3 | 24 | N/A | 24 | 0 |
| 120 | 3 | 24 | N/A | 24 | 0 |
| 121 | 3 | 24 | N/A | 24 | 0 |
| 122 | 3 | 24 | N/A | 36 | 0 |
| 123 | 2 | 24 | 24 | 24 | 0 |
| 124 | 3 | 24 | N/A | 36 | 0 |
| 125 | 3 | 24 | N/A | 24 | 0 |
| 126 | 3 | 24 | N/A | 24 | 0 |
| 127 | 3 | 24 | N/A | 36 | 0 |
| 128 | 3 | 24 | N/A | 24 | 0 |
| 129 | 3 | 24 | N/A | 36 | 0 |
| 130 | 3 | 24 | N/A | 24 | 0 |
| A | B | I | J | K | L |

Zazingo Table 14C
Multi-Directional, Multi-Dimensional
Reverse Matrix Auction

| | | Qualifying Bids>>>>>>>>>>>>>>>>>>>>>>>>>> | | | |
|---|---|---|---|---|---|
| 110 | 1 | $0 | $3,500 | $7,500 | |
| | | Maximum Position Other Funding | | | Inclusion By |
| Bid | Priority | Senior | Subordinate | Same | Other Funding |
| | | $0 | $0 | $5,500 | |
| 101 | 1 | $0 | $0 | $0 | 0 |
| 102 | 2 | $0 | $0 | $0 | 1 |
| 103 | 1 | $0 | $0 | $0 | 0 |
| 104 | 1 | $0 | $0 | $0 | 0 |
| 105 | 1 | $0 | $0 | $2,500 | 0 |
| 106 | 1 | $0 | $0 | $3,000 | 1 |
| 107 | 1 | $0 | $0 | $0 | 0 |
| 108 | 3 | $0 | $0 | $0 | 0 |
| 109 | 1 | $0 | $0 | $0 | 0 |
| 110 | 1 | $0 | $0 | $0 | 1 |
| 111 | 3 | $0 | $0 | $0 | 1 |
| 112 | 2 | $0 | $0 | $0 | 1 |
| 113 | 2 | $0 | $0 | $0 | 1 |
| 114 | 3 | $0 | $0 | $0 | 1 |
| 115 | 3 | $0 | $0 | $0 | 0 |
| 116 | 3 | $0 | $0 | $0 | 0 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 0 |
| 122 | 3 | $0 | $0 | $0 | 0 |
| 123 | 2 | $0 | $0 | $0 | 0 |
| 124 | 3 | $0 | $0 | $0 | 1 |
| 125 | 3 | $0 | $0 | $0 | 0 |
| 126 | 3 | $0 | $0 | $0 | 0 |
| 127 | 3 | $0 | $0 | $0 | 1 |
| 128 | 3 | $0 | $0 | $0 | 1 |
| 129 | 3 | $0 | $0 | $0 | 1 |
| 130 | 3 | $0 | $0 | $0 | 1 |
| A | B | M | N | O | P |

Zazingo BORROWER RESERVE NOT SATISFIED Table 14D
Multi-Directional, Multi-Dimensional
Reverse Matrix Auction

| | | | Borrower | | Lender | | |
|---|---|---|---|---|---|---|---|
| | | Selected | Loan Terms | | Yields On Investment | | |
| 110 | 1 | Bids | | Overall | 1st | 2nd | 3rd |
| | | | Rates >> | 8.88% | 8.88% | 0.00% | 0.00% |
| | | Total | Months >> | 24.0 | 24.0 | 0.0 | 0.0 |
| Bid | Priority | $8,000 | Mo. Pmt >> | $365.02 | $8,000 | $0 | $0 |
| 101 | 1 | $0 | | $0.00 | $0 | $0 | $0 |
| 102 | 2 | $0 | | $0.00 | $0 | $0 | $0 |
| 103 | 1 | $0 | | $0.00 | $0 | $0 | $0 |
| 104 | 1 | $0 | | $0.00 | $0 | $0 | $0 |
| 105 | 1 | $0 | | $0.00 | $0 | $0 | $0 |
| 106 | 1 | $3,000 | | $136.02 | $3,000 | $0 | $0 |
| 107 | 1 | $0 | | $0.00 | $0 | $0 | $0 |
| 108 | 3 | $0 | | $0.00 | $0 | $0 | $0 |
| 109 | 1 | $0 | | $0.00 | $0 | $0 | $0 |
| 110 | 1 | $5,000 | | $229.00 | $5,000 | $0 | $0 |
| 111 | 3 | $0 | | $0.00 | $0 | $0 | $0 |
| 112 | 2 | $0 | | $0.00 | $0 | $0 | $0 |
| 113 | 2 | $0 | | $0.00 | $0 | $0 | $0 |
| 114 | 3 | $0 | | $0.00 | $0 | $0 | $0 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 15
Zazingo Table 15A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 111 | 3 | | | 12 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 15B
Multi-Directional, Multi-Dimensional
Reverse Matrix Auction

| | | Compatability Factors | | | Qualifying |
|---|---|---|---|---|---|
| | | Continued | | | Bids |
| 111 | 3 | 24 | 12 | 12 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 0 |
| 103 | 1 | N/A | 24 | 30 | 0 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 0 |
| 109 | 1 | N/A | 66 | 24 | 0 |
| 110 | 1 | N/A | 72 | 24 | 0 |
| 111 | 3 | 24 | 12 | 12 | 1 |
| 112 | 2 | 24 | 18 | 36 | 0 |
| 113 | 2 | 24 | 24 | 24 | 0 |
| 114 | 3 | 24 | 36 | 36 | 0 |
| 115 | 3 | 24 | N/A | 24 | 0 |
| 116 | 3 | 24 | N/A | 24 | 0 |
| 117 | 3 | 24 | N/A | 24 | 0 |
| 118 | 3 | 24 | N/A | 24 | 0 |
| 119 | 3 | 24 | N/A | 24 | 0 |
| 120 | 3 | 24 | N/A | 24 | 0 |
| 121 | 3 | 24 | N/A | 24 | 0 |
| 122 | 3 | 24 | N/A | 36 | 0 |
| 123 | 2 | 24 | 24 | 24 | 0 |
| 124 | 3 | 24 | N/A | 36 | 0 |
| 125 | 3 | 24 | N/A | 24 | 0 |
| 126 | 3 | 24 | N/A | 24 | 0 |
| 127 | 3 | 24 | N/A | 36 | 0 |
| 128 | 3 | 24 | N/A | 24 | 0 |
| 129 | 3 | 24 | N/A | 36 | 0 |
| 130 | 3 | 24 | N/A | 24 | 0 |
| A | B | I | J | K | L |

Zazingo Table 15C
Multi-Directional, Multi-Dimensional
Reverse Matrix Auction

| | | Qualifying Bids>>>>>>>>>>>>>>>>>>>>>>>>>> | | | |
|---|---|---|---|---|---|
| 111 | 3 | $9,900 | $0 | $3,000 | |
| | | Maximum Position Other Funding | | | Inclusion By |
| Bid | Priority | Senior | Subordinate | Same | Other Funding |
| | | $0 | $0 | $0 | |
| 101 | 1 | $0 | $0 | $0 | 1 |
| 102 | 2 | $0 | $0 | $0 | 1 |
| 103 | 1 | $0 | $0 | $0 | 1 |
| 104 | 1 | $0 | $0 | $0 | 1 |
| 105 | 1 | $0 | $0 | $0 | 1 |
| 106 | 1 | $0 | $0 | $0 | 1 |
| 107 | 1 | $0 | $0 | $0 | 1 |
| 108 | 3 | $0 | $0 | $0 | 1 |
| 109 | 1 | $0 | $0 | $0 | 1 |
| 110 | 1 | $0 | $0 | $0 | 1 |
| 111 | 3 | $0 | $0 | $0 | 1 |
| 112 | 2 | $0 | $0 | $0 | 1 |
| 113 | 2 | $0 | $0 | $0 | 1 |
| 114 | 3 | $0 | $0 | $0 | 1 |
| 115 | 3 | $0 | $0 | $0 | 1 |
| 116 | 3 | $0 | $0 | $0 | 1 |
| 117 | 3 | $0 | $0 | $0 | 1 |
| 118 | 3 | $0 | $0 | $0 | 1 |
| 119 | 3 | $0 | $0 | $0 | 1 |
| 120 | 3 | $0 | $0 | $0 | 1 |
| 121 | 3 | $0 | $0 | $0 | 1 |
| 122 | 3 | $0 | $0 | $0 | 1 |
| 123 | 2 | $0 | $0 | $0 | 1 |
| 124 | 3 | $0 | $0 | $0 | 1 |
| 125 | 3 | $0 | $0 | $0 | 1 |
| 126 | 3 | $0 | $0 | $0 | 1 |
| 127 | 3 | $0 | $0 | $0 | 1 |
| 128 | 3 | $0 | $0 | $0 | 1 |
| 129 | 3 | $0 | $0 | $0 | 1 |
| 130 | 3 | $0 | $0 | $0 | 1 |
| A | B | M | N | O | P |

Zazingo BORROWER RESERVE NOT SATISFIED Table 15D
Multi-Directional, Multi-Dimensional
Reverse Matrix Auction

| | | | Borrower | | Lender | | |
|---|---|---|---|---|---|---|---|
| | | Selected | Loan Terms | | Yields On Investment | | |
| 111 | 3 | Bids | | Overall | 1st | 2nd | 3rd |
| | | | Rates >> | 9.50% | 0.00% | 0.00% | 9.50% |
| | | Total | Months >> | 12.0 | 0.0 | 0.0 | 12.0 |
| Bid | Priority | $500 | Mo. Pmt >> | $43.84 | $0 | $0 | $500 |
| 101 | 1 | $0 | | $0.00 | $0 | $0 | $0 |
| 102 | 2 | $0 | | $0.00 | $0 | $0 | $0 |
| 103 | 1 | $0 | | $0.00 | $0 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $0 | | $0.00 | $0 | $0 | $0 |
| 109 | 1 | $0 | | $0.00 | $0 | $0 | $0 |
| 110 | 1 | $0 | | $0.00 | $0 | $0 | $0 |
| 111 | 3 | $500 | | $43.84 | $0 | $0 | $500 |
| 112 | 2 | $0 | | $0.00 | $0 | $0 | $0 |
| 113 | 2 | $0 | | $0.00 | $0 | $0 | $0 |
| 114 | 3 | $0 | | $0.00 | $0 | $0 | $0 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 16
Zazingo Table 16A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 112 | 2 | | | 36 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 16B
Multi-Directional, Multi-Dimensional
Reverse Matrix Auction

| | | Compatability Factors | | | Qualifying |
|---|---|---|---|---|---|
| | | Continued | | | Bids |
| 112 | 2 | 24 | 18 | 36 | |
| | | Minimum Term By Position | | | Inclusion |
| Bid | Priority | Senior | Subordinate | Same | By Term |
| 101 | 1 | N/A | 36 | 36 | 1 |
| 102 | 2 | 24 | 18 | 18 | 1 |
| 103 | 1 | N/A | 24 | 30 | 0 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 1 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 1 |
| 113 | 2 | 24 | 24 | 24 | 0 |
| 114 | 3 | 24 | 36 | 36 | 0 |
| 115 | 3 | 24 | N/A | 24 | 0 |
| 116 | 3 | 24 | N/A | 24 | 0 |
| 117 | 3 | 24 | N/A | 24 | 0 |
| 118 | 3 | 24 | N/A | 24 | 0 |
| 119 | 3 | 24 | N/A | 24 | 0 |
| 120 | 3 | 24 | N/A | 24 | 0 |
| 121 | 3 | 24 | N/A | 24 | 0 |
| 122 | 3 | 24 | N/A | 36 | 0 |
| 123 | 2 | 24 | 24 | 24 | 0 |
| 124 | 3 | 24 | N/A | 36 | 0 |
| 125 | 3 | 24 | N/A | 24 | 0 |
| 126 | 3 | 24 | N/A | 24 | 0 |
| 127 | 3 | 24 | N/A | 36 | 0 |
| 128 | 3 | 24 | N/A | 24 | 0 |
| 129 | 3 | 24 | N/A | 36 | 0 |
| 130 | 3 | 24 | N/A | 24 | 0 |
| A | B | I | J | K | L |

Zazingo Table 16C
Multi-Directional, Multi-Dimensional
Reverse Matrix Auction

Qualifying Bids >>>>>>>>>>>>>>>>>>>>>>>>>>>

| 112 | 2 | $9,000 | $7,500 | $3,500 | |
|---|---|---|---|---|---|
| | | Maximum Position Other Funding | | | Inclusion By |
| Bid | Priority | Senior | Subordinate | Same | Other Funding |
| | | $2,000 | $4,000 | $1,000 | |
| 101 | 1 | $2,000 | $0 | $0 | 0 |
| 102 | 2 | $0 | $0 | $1,000 | 1 |
| 103 | 1 | $0 | $0 | $0 | 1 |
| 104 | 1 | $0 | $0 | $0 | 1 |
| 105 | 1 | $0 | $0 | $0 | 1 |
| 106 | 1 | $0 | $0 | $0 | 0 |
| 107 | 1 | $0 | $0 | $0 | 0 |
| 108 | 3 | $0 | $4,000 | $0 | 1 |
| 109 | 1 | $0 | $0 | $0 | 0 |
| 110 | 1 | $0 | $0 | $0 | 0 |
| 111 | 3 | $0 | $0 | $0 | 0 |
| 112 | 2 | $0 | $0 | $0 | 1 |
| 113 | 2 | $0 | $0 | $0 | 1 |
| 114 | 3 | $0 | $0 | $0 | 1 |
| 115 | 3 | $0 | $0 | $0 | 0 |
| 116 | 3 | $0 | $0 | $0 | 0 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 0 |
| 122 | 3 | $0 | $0 | $0 | 1 |
| 123 | 2 | $0 | $0 | $0 | 0 |
| 124 | 3 | $0 | $0 | $0 | 0 |
| 125 | 3 | $0 | $0 | $0 | 1 |
| 126 | 3 | $0 | $0 | $0 | 0 |
| 127 | 3 | $0 | $0 | $0 | 0 |
| 128 | 3 | $0 | $0 | $0 | 0 |
| 129 | 3 | $0 | $0 | $0 | 0 |
| 130 | 3 | $0 | $0 | $0 | 0 |
| A | B | M | N | O | P |

Zazingo BORROWER RESERVE NOT SATISFIED Table 16D
Multi-Directional, Multi-Dimensional
Reverse Matrix Auction

| | | | Borrower | | Lender | | |
|---|---|---|---|---|---|---|---|
| | | Selected | Loan Terms | | Yields On Investment | | |
| 112 | 2 | Bids | | Overall | 1st | 2nd | 3rd |
| | | | Rates >> | 8.67% | 0.00% | 8.50% | 8.75% |
| | | Total | Months >> | 28.0 | 0.0 | 36.0 | 24.0 |
| Bid | Priority | $6,000 | Mo. Pmt >> | $245.42 | $0 | $2,000 | $4,000 |
| 101 | 1 | $0 | | $0.00 | $0 | $0 | $0 |
| 102 | 2 | $1,000 | | $30.99 | $0 | $1,000 | $0 |
| 103 | 1 | $0 | | $0.00 | $0 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $4,000 | | $182.28 | $0 | $0 | $4,000 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $1,000 | | $32.15 | $0 | $1,000 | $0 |
| 113 | 2 | $0 | | $0.00 | $0 | $0 | $0 |
| 114 | 3 | $0 | | $0.00 | $0 | $0 | $0 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 17
Zazingo Table 17A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 113 | 2 | | | 24 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 17B
Multi-Directional, Multi-Dimensional
Reverse Matrix Auction

| | | Compatability Factors | | | Qualifying |
|---|---|---|---|---|---|
| | | Continued | | | Bids |
| 113 | 2 | 24 | 24 | 24 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 1 |
| 103 | 1 | N/A | 24 | 30 | 1 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 1 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 0 |
| 113 | 2 | 24 | 24 | 24 | 1 |
| 114 | 3 | 24 | 36 | 36 | 0 |
| 115 | 3 | 24 | N/A | 24 | 1 |
| 116 | 3 | 24 | N/A | 24 | 1 |
| 117 | 3 | 24 | N/A | 24 | 1 |
| 118 | 3 | 24 | N/A | 24 | 1 |
| 119 | 3 | 24 | N/A | 24 | 1 |
| 120 | 3 | 24 | N/A | 24 | 1 |
| 121 | 3 | 24 | N/A | 24 | 1 |
| 122 | 3 | 24 | N/A | 36 | 0 |
| 123 | 2 | 24 | 24 | 24 | 1 |
| 124 | 3 | 24 | N/A | 36 | 0 |
| 125 | 3 | 24 | N/A | 24 | 1 |
| 126 | 3 | 24 | N/A | 24 | 1 |
| 127 | 3 | 24 | N/A | 36 | 0 |
| 128 | 3 | 24 | N/A | 24 | 1 |
| 129 | 3 | 24 | N/A | 36 | 0 |
| 130 | 3 | 24 | N/A | 24 | 1 |
| A | B | I | J | K | L |

Zazingo Table 17C
Multi-Directional, Multi-Dimensional
Reverse Matrix Auction

Qualifying Bids>>>>>>>>>>>>>>>>>>>>>>>>>>

| 113 | 2 | $9,000 | $7,000 | $4,000 | |
|---|---|---|---|---|---|
| | | Maximum Position Other Funding | | | Inclusion By |
| Bid | Priority | Senior | Subordinate | Same | Other Funding |
| | | $1,500 | $7,000 | $3,500 | |
| 101 | 1 | $0 | $0 | $0 | 0 |
| 102 | 2 | $0 | $0 | $1,000 | 1 |
| 103 | 1 | $1,500 | $0 | $0 | 1 |
| 104 | 1 | $0 | $0 | $0 | 1 |
| 105 | 1 | $0 | $0 | $0 | 0 |
| 106 | 1 | $0 | $0 | $0 | 0 |
| 107 | 1 | $0 | $0 | $0 | 0 |
| 108 | 3 | $0 | $4,000 | $0 | 1 |
| 109 | 1 | $0 | $0 | $0 | 0 |
| 110 | 1 | $0 | $0 | $0 | 0 |
| 111 | 3 | $0 | $0 | $0 | 0 |
| 112 | 2 | $0 | $0 | $0 | 1 |
| 113 | 2 | $0 | $0 | $0 | 1 |
| 114 | 3 | $0 | $0 | $0 | 1 |
| 115 | 3 | $0 | $2,500 | $0 | 0 |
| 116 | 3 | $0 | $500 | $0 | 0 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 0 |
| 122 | 3 | $0 | $0 | $0 | 1 |
| 123 | 2 | $0 | $0 | $2,500 | 0 |
| 124 | 3 | $0 | $0 | $0 | 0 |
| 125 | 3 | $0 | $0 | $0 | 1 |
| 126 | 3 | $0 | $0 | $0 | 0 |
| 127 | 3 | $0 | $0 | $0 | 0 |
| 128 | 3 | $0 | $0 | $0 | 0 |
| 129 | 3 | $0 | $0 | $0 | 0 |
| 130 | 3 | $0 | $0 | $0 | 0 |
| A | B | M | N | O | P |

Zazingo BORROWER RESERVE NOT SATISFIED Table 17D
Multi-Directional, Multi-Dimensional
Reverse Matrix Auction

| | | | Borrower | | Lender | | |
|---|---|---|---|---|---|---|---|
| | | | Loan Terms | | Yields On Investment | | |
| 113 | 2 | Selected Bids | | Overall | 1st | 2nd | 3rd |
| | | | Rates >> | 8.56% | 7.50% | 8.90% | 8.75% |
| | | Total | Months >> | 26.7 | 30.0 | 29.0 | 24.0 |
| Bid | Priority | $8,000 | Mo. Pmt >> | $337.48 | $1,500 | $2,500 | $4,000 |
| 101 | 1 | $0 | | $0.00 | $0 | $0 | $0 |
| 102 | 2 | $1,000 | | $30.99 | $0 | $1,000 | $0 |
| 103 | 1 | $1,500 | | $54.99 | $1,500 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $4,000 | | $182.28 | $0 | $0 | $4,000 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $0 | | $0.00 | $0 | $0 | $0 |
| 113 | 2 | $1,500 | | $69.22 | $0 | $1,500 | $0 |
| 114 | 3 | $0 | | $0.00 | $0 | $0 | $0 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 18
Zazingo Table 18A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 114 | 3 | | | 36 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 18B
Multi-Directional, Multi-Dimensional
Reverse Matrix Auction

| | | Compatability Factors | | | Qualifying |
|---|---|---|---|---|---|
| | | Continued | | | Bids |
| 114 | 3 | 24 | 36 | 36 | |
| | | Minimum Term By Position | | | Inclusion |
| Bid | Priority | Senior | Subordinate | Same | By Term |
| 101 | 1 | N/A | 36 | 36 | 1 |
| 102 | 2 | 24 | 18 | 18 | 1 |
| 103 | 1 | N/A | 24 | 30 | 0 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 0 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 1 |
| 113 | 2 | 24 | 24 | 24 | 0 |
| 114 | 3 | 24 | 36 | 36 | 1 |
| 115 | 3 | 24 | N/A | 24 | 0 |
| 116 | 3 | 24 | N/A | 24 | 0 |
| 117 | 3 | 24 | N/A | 24 | 0 |
| 118 | 3 | 24 | N/A | 24 | 0 |
| 119 | 3 | 24 | N/A | 24 | 0 |
| 120 | 3 | 24 | N/A | 24 | 0 |
| 121 | 3 | 24 | N/A | 24 | 0 |
| 122 | 3 | 24 | N/A | 36 | 0 |
| 123 | 2 | 24 | 24 | 24 | 0 |
| 124 | 3 | 24 | N/A | 36 | 1 |
| 125 | 3 | 24 | N/A | 24 | 0 |
| 126 | 3 | 24 | N/A | 24 | 0 |
| 127 | 3 | 24 | N/A | 36 | 1 |
| 128 | 3 | 24 | N/A | 24 | 0 |
| 129 | 3 | 24 | N/A | 36 | 1 |
| 130 | 3 | 24 | N/A | 24 | 0 |
| A | B | I | J | K | L |

Zazingo Table 18C
Multi-Directional, Multi-Dimensional
Reverse Matrix Auction

Qualifying Bids>>>>>>>>>>>>>>>>>>>>>>>>>>

| 114 | 3 | $8,000 | $6,500 | $4,500 | |
|---|---|---|---|---|---|
| | | Maximum Position Other Funding | | | Inclusion By |
| Bid | Priority | Senior | Subordinate | Same | Other Funding |
| | | $4,000 | $0 | $4,500 | |
| 101 | 1 | $2,000 | $0 | $0 | 0 |
| 102 | 2 | $1,000 | $0 | $0 | 1 |
| 103 | 1 | $0 | $0 | $0 | 0 |
| 104 | 1 | $0 | $0 | $0 | 0 |
| 105 | 1 | $0 | $0 | $0 | 0 |
| 106 | 1 | $0 | $0 | $0 | 0 |
| 107 | 1 | $0 | $0 | $0 | 0 |
| 108 | 3 | $0 | $0 | $0 | 1 |
| 109 | 1 | $0 | $0 | $0 | 0 |
| 110 | 1 | $0 | $0 | $0 | 0 |
| 111 | 3 | $0 | $0 | $0 | 0 |
| 112 | 2 | $1,000 | $0 | $0 | 1 |
| 113 | 2 | $0 | $0 | $0 | 1 |
| 114 | 3 | $0 | $0 | $0 | 1 |
| 115 | 3 | $0 | $0 | $0 | 0 |
| 116 | 3 | $0 | $0 | $0 | 0 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 0 |
| 122 | 3 | $0 | $0 | $0 | 1 |
| 123 | 2 | $0 | $0 | $0 | 0 |
| 124 | 3 | $0 | $0 | $3,500 | 1 |
| 125 | 3 | $0 | $0 | $0 | 0 |
| 126 | 3 | $0 | $0 | $0 | 0 |
| 127 | 3 | $0 | $0 | $1,000 | 0 |
| 128 | 3 | $0 | $0 | $0 | 0 |
| 129 | 3 | $0 | $0 | $0 | 0 |
| 130 | 3 | $0 | $0 | $0 | 0 |
| A | B | M | N | O | P |

Zazingo BORROWER RESERVE NOT SATISFIED Table 18D
Multi-Directional, Multi-Dimensional
Reverse Matrix Auction

| | | | Borrower | | Lender | | |
|---|---|---|---|---|---|---|---|
| | | | Loan Terms | | Yields On Investment | | |
| 114 | 3 | Selected Bids | | Overall | 1st | 2nd | 3rd |
| | | | Rates >> | 12.42% | 0.00% | 8.50% | 13.84% |
| | | Total | Months >> | 36.0 | 0.0 | 36.0 | 36.0 |
| Bid | Priority | $7,500 | Mo. Pmt >> | $250.71 | $0 | $2,000 | $5,500 |
| 101 | 1 | $0 | | $0.00 | $0 | $0 | $0 |
| 102 | 2 | $1,000 | | $30.99 | $0 | $1,000 | $0 |
| 103 | 1 | $0 | | $0.00 | $0 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $0 | | $0.00 | $0 | $0 | $0 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $1,000 | | $32.15 | $0 | $1,000 | $0 |
| 113 | 2 | $0 | | $0.00 | $0 | $0 | $0 |
| 114 | 3 | $2,000 | | $66.67 | $0 | $0 | $2,000 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $3,500 | | $120.90 | $0 | $0 | $3,500 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 19
Zazingo Table 19A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 115 | 3 | | | 24 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25%, | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 19B
Multi-Directional, Multi-Dimensional
Reverse Matrix Auction

| | | Compatability Factors | | | Qualifying |
|---|---|---|---|---|---|
| | | Continued | | | Bids |
| 115 | 3 | 24 | N/A | 24 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 1 |
| 103 | 1 | N/A | 24 | 30 | 1 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 1 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 1 |
| 113 | 2 | 24 | 24 | 24 | 0 |
| 114 | 3 | 24 | 36 | 36 | 0 |
| 115 | 3 | 24 | N/A | 24 | 1 |
| 116 | 3 | 24 | N/A | 24 | 1 |
| 117 | 3 | 24 | N/A | 24 | 1 |
| 118 | 3 | 24 | N/A | 24 | 1 |
| 119 | 3 | 24 | N/A | 24 | 1 |
| 120 | 3 | 24 | N/A | 24 | 1 |
| 121 | 3 | 24 | N/A | 24 | 1 |
| 122 | 3 | 24 | N/A | 36 | 0 |
| 123 | 2 | 24 | 24 | 24 | 0 |
| 124 | 3 | 24 | N/A | 36 | 0 |
| 125 | 3 | 24 | N/A | 24 | 1 |
| 126 | 3 | 24 | N/A | 24 | 1 |
| 127 | 3 | 24 | N/A | 36 | 0 |
| 128 | 3 | 24 | N/A | 24 | 1 |
| 129 | 3 | 24 | N/A | 36 | 0 |
| 130 | 3 | 24 | N/A | 24 | 1 |
| A | B | I | J | K | L |

Zazingo Table 19C
Multi-Directional, Multi-Dimensional
Reverse Matrix Auction

Qualifying Bids>>>>>>>>>>>>>>>>>>>>>>>>>>

| 115 | 3 | $2,500 | $0 | $2,500 | |
|---|---|---|---|---|---|
| | | Maximum Position Other Funding | | | Inclusion By |
| Bid | Priority | Senior | Subordinate | Same | Other Funding |
| | | $2,500 | $0 | $2,500 | |
| 101 | 1 | $0 | $0 | $0 | 0 |
| 102 | 2 | $1,000 | $0 | $0 | 1 |
| 103 | 1 | $1,500 | $0 | $0 | 1 |
| 104 | 1 | $0 | $0 | $0 | 1 |
| 105 | 1 | $0 | $0 | $0 | 1 |
| 106 | 1 | $0 | $0 | $0 | 0 |
| 107 | 1 | $0 | $0 | $0 | 0 |
| 108 | 3 | $0 | $0 | $2,500 | 1 |
| 109 | 1 | $0 | $0 | $0 | 0 |
| 110 | 1 | $0 | $0 | $0 | 0 |
| 111 | 3 | $0 | $0 | $0 | 0 |
| 112 | 2 | $0 | $0 | $0 | 1 |
| 113 | 2 | $0 | $0 | $0 | 1 |
| 114 | 3 | $0 | $0 | $0 | 0 |
| 115 | 3 | $0 | $0 | $0 | 1 |
| 116 | 3 | $0 | $0 | $0 | 0 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 0 |
| 122 | 3 | $0 | $0 | $0 | 1 |
| 123 | 2 | $0 | $0 | $0 | 0 |
| 124 | 3 | $0 | $0 | $0 | 0 |
| 125 | 3 | $0 | $0 | $0 | 0 |
| 126 | 3 | $0 | $0 | $0 | 0 |
| 127 | 3 | $0 | $0 | $0 | 0 |
| 128 | 3 | $0 | $0 | $0 | 0 |
| 129 | 3 | $0 | $0 | $0 | 0 |
| 130 | 3 | $0 | $0 | $0 | 0 |
| A | B | M | N | O | P |

Zazingo BORROWER RESERVE NOT SATISFIED Table 19D
Multi-Directional, Multi-Dimensional
Reverse Matrix Auction

| | | | Borrower | | Lender | | |
|---|---|---|---|---|---|---|---|
| | | | Loan Terms | | Yields On Investment | | |
| 115 | 3 | Selected Bids | | Overall | 1st | 2nd | 3rd |
| | | | Rates >> | 9.55% | 7.50% | 7.25% | 10.63% |
| | | Total | Months >> | 26.8 | 30.0 | 36.0 | 24.0 |
| Bid | Priority | $7,500 | Mo. Pmt >> | $318.17 | $1,500 | $1,000 | $5,000 |
| 101 | 1 | $0 | | $0.00 | $0 | $0 | $0 |
| 102 | 2 | $1,000 | | $30.99 | $0 | $1,000 | $0 |
| 103 | 1 | $1,500 | | $54.99 | $1,500 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $2,500 | | $113.93 | $0 | $0 | $2,500 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $0 | | $0.00 | $0 | $0 | $0 |
| 113 | 2 | $0 | | $0.00 | $0 | $0 | $0 |
| 114 | 3 | $0 | | $0.00 | $0 | $0 | $0 |
| 115 | 3 | $2,500 | | $118.27 | $0 | $0 | $2,500 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 20
Zazingo Table 20A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 116 | 3 | | | 24 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 20B
Multi-Directional, Multi-Dimensional
Reverse Matrix Auction

| | | Compatability Factors | | | Qualifying |
|---|---|---|---|---|---|
| | | Continued | | | Bids |
| 116 | 3 | 24 | N/A | 24 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 1 |
| 103 | 1 | N/A | 24 | 30 | 1 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 1 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 1 |
| 113 | 2 | 24 | 24 | 24 | 0 |
| 114 | 3 | 24 | 36 | 36 | 0 |
| 115 | 3 | 24 | N/A | 24 | 1 |
| 116 | 3 | 24 | N/A | 24 | 1 |
| 117 | 3 | 24 | N/A | 24 | 1 |
| 118 | 3 | 24 | N/A | 24 | 1 |
| 119 | 3 | 24 | N/A | 24 | 1 |
| 120 | 3 | 24 | N/A | 24 | 1 |
| 121 | 3 | 24 | N/A | 24 | 1 |
| 122 | 3 | 24 | N/A | 36 | 0 |
| 123 | 2 | 24 | 24 | 24 | 0 |
| 124 | 3 | 24 | N/A | 36 | 0 |
| 125 | 3 | 24 | N/A | 24 | 1 |
| 126 | 3 | 24 | N/A | 24 | 1 |
| 127 | 3 | 24 | N/A | 36 | 0 |
| 128 | 3 | 24 | N/A | 24 | 1 |
| 129 | 3 | 24 | N/A | 36 | 0 |
| 130 | 3 | 24 | N/A | 24 | 1 |
| A | B | I | J | K | L |

Zazingo Table 20C
Multi-Directional, Multi-Dimensional
Reverse Matrix Auction

Qualifying Bids>>>>>>>>>>>>>>>>>>>>>>>>>>>

| 116 | 3 | $2,000 | $0 | $3,500 | |
|---|---|---|---|---|---|
| | | Maximum Position Other Funding | | | Inclusion By |
| Bid | Priority | Senior | Subordinate | Same | Other Funding |
| | | $2,000 | $0 | $3,500 | |
| 101 | 1 | $0 | $0 | $0 | 0 |
| 102 | 2 | $1,000 | $0 | $0 | 1 |
| 103 | 1 | $1,000 | $0 | $0 | 0 |
| 104 | 1 | $0 | $0 | $0 | 0 |
| 105 | 1 | $0 | $0 | $0 | 0 |
| 106 | 1 | $0 | $0 | $0 | 0 |
| 107 | 1 | $0 | $0 | $0 | 0 |
| 108 | 3 | $0 | $0 | $3,500 | 1 |
| 109 | 1 | $0 | $0 | $0 | 0 |
| 110 | 1 | $0 | $0 | $0 | 0 |
| 111 | 3 | $0 | $0 | $0 | 0 |
| 112 | 2 | $0 | $0 | $0 | 1 |
| 113 | 2 | $0 | $0 | $0 | 1 |
| 114 | 3 | $0 | $0 | $0 | 0 |
| 115 | 3 | $0 | $0 | $0 | 0 |
| 116 | 3 | $0 | $0 | $0 | 1 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 1 |
| 121 | 3 | $0 | $0 | $0 | 0 |
| 122 | 3 | $0 | $0 | $0 | 0 |
| 123 | 2 | $0 | $0 | $0 | 0 |
| 124 | 3 | $0 | $0 | $0 | 0 |
| 125 | 3 | $0 | $0 | $0 | 0 |
| 126 | 3 | $0 | $0 | $0 | 0 |
| 127 | 3 | $0 | $0 | $0 | 0 |
| 128 | 3 | $0 | $0 | $0 | 0 |
| 129 | 3 | $0 | $0 | $0 | 0 |
| 130 | 3 | $0 | $0 | $0 | 0 |
| A | B | M | N | O | P |

Zazingo BORROWER RESERVE NOT SATISFIED Table 20D
Multi-Directional, Multi-Dimensional
Reverse Matrix Auction

| | | | Borrower | | Lender | | |
|---|---|---|---|---|---|---|---|
| | | | Loan Terms | | Yields On Investment | | |
| 116 | 3 | Selected Bids | | Overall | 1st | 2nd | 3rd |
| | | | Rates >> | 10.15% | 0.00% | 7.25% | 10.60% |
| | | Total | Months >> | 25.6 | 0.0 | 36.0 | 24.0 |
| Bid | Priority | $7,500 | Mo. Pmt >> | $332.76 | $0 | $1,000 | $6,500 |
| 101 | 1 | $0 | | $0.00 | $0 | $0 | $0 |
| 102 | 2 | $1,000 | | $30.99 | $0 | $1,000 | $0 |
| 103 | 1 | $0 | | $0.00 | $0 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $3,500 | | $159.50 | $0 | $0 | $3,500 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $0 | | $0.00 | $0 | $0 | $0 |
| 113 | 2 | $0 | | $0.00 | $0 | $0 | $0 |
| 114 | 3 | $0 | | $0.00 | $0 | $0 | $0 |
| 115 | 3 | $0 | | $0.00 | $0 | $0 | $0 |
| 116 | 3 | $3,000 | | $142.27 | $0 | $0 | $3,000 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 21
Zazingo Table 21A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 117 | 3 | | | 24 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 21B
Multi-Directional, Multi-Dimensional
Reverse Matrix Auction

| | | Compatability Factors | | | Qualifying |
|---|---|---|---|---|---|
| | | Continued | | | Bids |
| 117 | 3 | 24 | N/A | 24 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 1 |
| 103 | 1 | N/A | 24 | 30 | 1 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 1 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 1 |
| 113 | 2 | 24 | 24 | 24 | 0 |
| 114 | 3 | 24 | 36 | 36 | 0 |
| 115 | 3 | 24 | N/A | 24 | 1 |
| 116 | 3 | 24 | N/A | 24 | 1 |
| 117 | 3 | 24 | N/A | 24 | 1 |
| 118 | 3 | 24 | N/A | 24 | 1 |
| 119 | 3 | 24 | N/A | 24 | 1 |
| 120 | 3 | 24 | N/A | 24 | 1 |
| 121 | 3 | 24 | N/A | 24 | 1 |
| 122 | 3 | 24 | N/A | 36 | 0 |
| 123 | 2 | 24 | 24 | 24 | 0 |
| 124 | 3 | 24 | N/A | 36 | 0 |
| 125 | 3 | 24 | N/A | 24 | 1 |
| 126 | 3 | 24 | N/A | 24 | 1 |
| 127 | 3 | 24 | N/A | 36 | 0 |
| 128 | 3 | 24 | N/A | 24 | 1 |
| 129 | 3 | 24 | N/A | 36 | 0 |
| 130 | 3 | 24 | N/A | 24 | 1 |
| A | B | I | J | K | L |

Zazingo Table 21C
Multi-Directional, Multi-Dimensional
Reverse Matrix Auction

Qualifying Bids>>>>>>>>>>>>>>>>>>>>>>>>>>

| 117 | 3 | $1,500 | $0 | $4,500 | |
|---|---|---|---|---|---|
| | | Maximum Position Other Funding | | | Inclusion By |
| Bid | Priority | Senior | Subordinate | Same | Other Funding |
| | | $1,500 | $0 | $4,500 | |
| 101 | 1 | $0 | $0 | $0 | 0 |
| 102 | 2 | $1,000 | $0 | $0 | 1 |
| 103 | 1 | $500 | $0 | $0 | 0 |
| 104 | 1 | $0 | $0 | $0 | 0 |
| 105 | 1 | $0 | $0 | $0 | 0 |
| 106 | 1 | $0 | $0 | $0 | 0 |
| 107 | 1 | $0 | $0 | $0 | 0 |
| 108 | 3 | $0 | $0 | $4,000 | 1 |
| 109 | 1 | $0 | $0 | $0 | 0 |
| 110 | 1 | $0 | $0 | $0 | 0 |
| 111 | 3 | $0 | $0 | $0 | 0 |
| 112 | 2 | $0 | $0 | $0 | 1 |
| 113 | 2 | $0 | $0 | $0 | 0 |
| 114 | 3 | $0 | $0 | $0 | 0 |
| 115 | 3 | $0 | $0 | $500 | 0 |
| 116 | 3 | $0 | $0 | $0 | 0 |
| 117 | 3 | $0 | $0 | $0 | 1 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 0 |
| 122 | 3 | $0 | $0 | $0 | 0 |
| 123 | 2 | $0 | $0 | $0 | 0 |
| 124 | 3 | $0 | $0 | $0 | 0 |
| 125 | 3 | $0 | $0 | $0 | 0 |
| 126 | 3 | $0 | $0 | $0 | 0 |
| 127 | 3 | $0 | $0 | $0 | 0 |
| 128 | 3 | $0 | $0 | $0 | 0 |
| 129 | 3 | $0 | $0 | $0 | 0 |
| 130 | 3 | $0 | $0 | $0 | 0 |
| A | B | M | N | O | P |

Zazingo BORROWER RESERVE NOT SATISFIED Table 21D
Multi-Directional, Multi-Dimensional
Reverse Matrix Auction

| | | | Borrower | | Lender | | |
|---|---|---|---|---|---|---|---|
| | | | Loan Terms | | Yields On Investment | | |
| 117 | 3 | Selected Bids | | Overall | 1st | 2nd | 3rd |
| | | | Rates >> | 10.32% | 0.00% | 7.25% | 10.73% |
| | | Total | Months >> | 25.4 | 0.0 | 36.0 | 24.0 |
| Bid | Priority | $8,500 | Mo. Pmt >> | $379.67 | $0 | $1,000 | $7,500 |
| 101 | 1 | $0 | | $0.00 | $0 | $0 | $0 |
| 102 | 2 | $1,000 | | $30.99 | $0 | $1,000 | $0 |
| 103 | 1 | $0 | | $0.00 | $0 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $4,000 | | $182.28 | $0 | $0 | $4,000 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $0 | | $0.00 | $0 | $0 | $0 |
| 113 | 2 | $0 | | $0.00 | $0 | $0 | $0 |
| 114 | 3 | $0 | | $0.00 | $0 | $0 | $0 |
| 115 | 3 | $0 | | $0.00 | $0 | $0 | $0 |
| 116 | 3 | $0 | | $0.00 | $0 | $0 | $0 |
| 117 | 3 | $3,500 | | $166.40 | $0 | $0 | $3,500 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 22
Zazingo Table 22A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 118 | 3 | | | 24 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 22B
Multi-Directional, Multi-Dimensional
Reverse Matrix Auction

| | | Compatability Factors | | | Qualifying |
|---|---|---|---|---|---|
| | | Continued | | | Bids |
| 118 | 3 | 24 | N/A | 24 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 1 |
| 103 | 1 | N/A | 24 | 30 | 1 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 1 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 1 |
| 113 | 2 | 24 | 24 | 24 | 0 |
| 114 | 3 | 24 | 36 | 36 | 0 |
| 115 | 3 | 24 | N/A | 24 | 1 |
| 116 | 3 | 24 | N/A | 24 | 1 |
| 117 | 3 | 24 | N/A | 24 | 1 |
| 118 | 3 | 24 | N/A | 24 | 1 |
| 119 | 3 | 24 | N/A | 24 | 1 |
| 120 | 3 | 24 | N/A | 24 | 1 |
| 121 | 3 | 24 | N/A | 24 | 1 |
| 122 | 3 | 24 | N/A | 36 | 0 |
| 123 | 2 | 24 | 24 | 24 | 0 |
| 124 | 3 | 24 | N/A | 36 | 0 |
| 125 | 3 | 24 | N/A | 24 | 1 |
| 126 | 3 | 24 | N/A | 24 | 1 |
| 127 | 3 | 24 | N/A | 36 | 0 |
| 128 | 3 | 24 | N/A | 24 | 1 |
| 129 | 3 | 24 | N/A | 36 | 0 |
| 130 | 3 | 24 | N/A | 24 | 1 |
| A | B | I | J | K | L |

Zazingo Table 22C
Multi-Directional, Multi-Dimensional
Reverse Matrix Auction

Qualifying Bids>>>>>>>>>>>>>>>>>>>>>>>>>>

| 118 | 3 | $1,500 | $0 | $5,000 | |
|---|---|---|---|---|---|
| | | Maximum Position Other Funding | | | Inclusion By |
| Bid | Priority | Senior | Subordinate | Same | Other Funding |
| | | $1,500 | $0 | $5,000 | |
| 101 | 1 | $0 | $0 | $0 | 0 |
| 102 | 2 | $1,000 | $0 | $0 | 1 |
| 103 | 1 | $500 | $0 | $0 | 0 |
| 104 | 1 | $0 | $0 | $0 | 0 |
| 105 | 1 | $0 | $0 | $0 | 0 |
| 106 | 1 | $0 | $0 | $0 | 0 |
| 107 | 1 | $0 | $0 | $0 | 0 |
| 108 | 3 | $0 | $0 | $4,000 | 1 |
| 109 | 1 | $0 | $0 | $0 | 0 |
| 110 | 1 | $0 | $0 | $0 | 0 |
| 111 | 3 | $0 | $0 | $0 | 0 |
| 112 | 2 | $0 | $0 | $0 | 0 |
| 113 | 2 | $0 | $0 | $0 | 0 |
| 114 | 3 | $0 | $0 | $0 | 0 |
| 115 | 3 | $0 | $0 | $1,000 | 0 |
| 116 | 3 | $0 | $0 | $0 | 0 |
| 117 | 3 | $0 | $0 | $0 | 0 |
| 118 | 3 | $0 | $0 | $0 | 1 |
| 119 | 3 | $0 | $0 | $0 | 0 |
| 120 | 3 | $0 | $0 | $0 | 0 |
| 121 | 3 | $0 | $0 | $0 | 0 |
| 122 | 3 | $0 | $0 | $0 | 0 |
| 123 | 2 | $0 | $0 | $0 | 0 |
| 124 | 3 | $0 | $0 | $0 | 0 |
| 125 | 3 | $0 | $0 | $0 | 0 |
| 126 | 3 | $0 | $0 | $0 | 0 |
| 127 | 3 | $0 | $0 | $0 | 0 |
| 128 | 3 | $0 | $0 | $0 | 0 |
| 129 | 3 | $0 | $0 | $0 | 0 |
| 130 | 3 | $0 | $0 | $0 | 0 |
| A | B | M | N | O | P |

Zazingo Table 22D
Multi-Directional, Multi-Dimensional
Reverse Matrix Auction

| | | | Borrower | | Lender | | |
|---|---|---|---|---|---|---|---|
| | | | Loan Terms | | Yields On Investment | | |
| 118 | 3 | Selected Bids | | Overall | 1st | 2nd | 3rd |
| | | | Rates >> | 10.85% | 0.00% | 7.25% | 11.25% |
| | | Total | Months >> | 25.2 | 0.0 | 36.0 | 24.0 |
| Bid | Priority | $10,000 | Mo. Pmt >> | $451.57 | $0 | $1,000 | $9,000 |
| 101 | 1 | $0 | | $0.00 | $0 | $0 | $0 |
| 102 | 2 | $1,000 | | $30.99 | $0 | $1,000 | $0 |
| 103 | 1 | $0 | | $0.00 | $0 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $4,000 | | $182.28 | $0 | $0 | $4,000 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $0 | | $0.00 | $0 | $0 | $0 |
| 113 | 2 | $0 | | $0.00 | $0 | $0 | $0 |
| 114 | 3 | $0 | | $0.00 | $0 | $0 | $0 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $5,000 | | $238.30 | $0 | $0 | $5,000 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 23
Zazingo Table 23A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 119 | 3 | | | 24 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 23B
Multi-Directional, Multi-Dimensional
Reverse Matrix Auction

| | | Compatability Factors | | | Qualifying |
|---|---|---|---|---|---|
| | | Continued | | | Bids |
| 119 | 3 | 24 | N/A | 24 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 1 |
| 103 | 1 | N/A | 24 | 30 | 1 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 1 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 1 |
| 113 | 2 | 24 | 24 | 24 | 0 |
| 114 | 3 | 24 | 36 | 36 | 0 |
| 115 | 3 | 24 | N/A | 24 | 1 |
| 116 | 3 | 24 | N/A | 24 | 1 |
| 117 | 3 | 24 | N/A | 24 | 1 |
| 118 | 3 | 24 | N/A | 24 | 1 |
| 119 | 3 | 24 | N/A | 24 | 1 |
| 120 | 3 | 24 | N/A | 24 | 1 |
| 121 | 3 | 24 | N/A | 24 | 1 |
| 122 | 3 | 24 | N/A | 36 | 0 |
| 123 | 2 | 24 | 24 | 24 | 0 |
| 124 | 3 | 24 | N/A | 36 | 0 |
| 125 | 3 | 24 | N/A | 24 | 1 |
| 126 | 3 | 24 | N/A | 24 | 1 |
| 127 | 3 | 24 | N/A | 36 | 0 |
| 128 | 3 | 24 | N/A | 24 | 1 |
| 129 | 3 | 24 | N/A | 36 | 0 |
| 130 | 3 | 24 | N/A | 24 | 1 |
| A | B | I | J | K | L |

Zazingo Table 23C
Multi-Directional, Multi-Dimensional
Reverse Matrix Auction

Qualifying Bids>>>>>>>>>>>>>>>>>>>>>>>>>>

| 119 | 3 | $1,000 | $0 | $6,000 | |
|---|---|---|---|---|---|
| | | Maximum Position Other Funding | | | Inclusion By |
| Bid | Priority | Senior | Subordinate | Same | Other Funding |
| | | $1,000 | $0 | $6,000 | |
| 101 | 1 | $0 | $0 | $0 | 0 |
| 102 | 2 | $1,000 | $0 | $0 | 1 |
| 103 | 1 | $0 | $0 | $0 | 0 |
| 104 | 1 | $0 | $0 | $0 | 0 |
| 105 | 1 | $0 | $0 | $0 | 0 |
| 106 | 1 | $0 | $0 | $0 | 0 |
| 107 | 1 | $0 | $0 | $0 | 0 |
| 108 | 3 | $0 | $0 | $4,000 | 1 |
| 109 | 1 | $0 | $0 | $0 | 0 |
| 110 | 1 | $0 | $0 | $0 | 0 |
| 111 | 3 | $0 | $0 | $0 | 0 |
| 112 | 2 | $0 | $0 | $0 | 0 |
| 113 | 2 | $0 | $0 | $0 | 0 |
| 114 | 3 | $0 | $0 | $0 | 0 |
| 115 | 3 | $0 | $0 | $2,000 | 0 |
| 116 | 3 | $0 | $0 | $0 | 0 |
| 117 | 3 | $0 | $0 | $0 | 0 |
| 118 | 3 | $0 | $0 | $0 | 0 |
| 119 | 3 | $0 | $0 | $0 | 1 |
| 120 | 3 | $0 | $0 | $0 | 0 |
| 121 | 3 | $0 | $0 | $0 | 0 |
| 122 | 3 | $0 | $0 | $0 | 0 |
| 123 | 2 | $0 | $0 | $0 | 0 |
| 124 | 3 | $0 | $0 | $0 | 0 |
| 125 | 3 | $0 | $0 | $0 | 0 |
| 126 | 3 | $0 | $0 | $0 | 0 |
| 127 | 3 | $0 | $0 | $0 | 0 |
| 128 | 3 | $0 | $0 | $0 | 0 |
| 129 | 3 | $0 | $0 | $0 | 0 |
| 130 | 3 | $0 | $0 | $0 | 0 |
| A | B | M | N | O | P |

Zazingo BORROWER RESERVE NOT SATISFIED Table 23D
Multi-Directional, Multi-Dimensional
Reverse Matrix Auction

| | | | Borrower | | Lender | | |
|---|---|---|---|---|---|---|---|
| | | | Loan Terms | | Yields On Investment | | |
| 119 | 3 | Selected Bids | | Overall | 1st | 2nd | 3rd |
| | | | Rates >> | 10.84% | 0.00% | 7.25% | 11.26% |
| | | Total | Months >> | 25.3 | 0.0 | 36.0 | 24.0 |
| Bid | Priority | $9,500 | Mo. Pmt >> | $428.27 | $0 | $1,000 | $8,500 |
| 101 | 1 | $0 | | $0.00 | $0 | $0 | $0 |
| 102 | 2 | $1,000 | | $30.99 | $0 | $1,000 | $0 |
| 103 | 1 | $0 | | $0.00 | $0 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $4,000 | | $182.28 | $0 | $0 | $4,000 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $0 | | $0.00 | $0 | $0 | $0 |
| 113 | 2 | $0 | | $0.00 | $0 | $0 | $0 |
| 114 | 3 | $0 | | $0.00 | $0 | $0 | $0 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $4,500 | | $215.00 | $0 | $0 | $4,500 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 24
Zazingo Table 24A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 120 | 3 | | | 24 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 24B
Multi-Directional, Multi-Dimensional
Reverse Matrix Auction

| | | Compatability Factors | | | Qualifying |
|---|---|---|---|---|---|
| | | Continued | | | Bids |
| 120 | 3 | 24 | N/A | 24 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 1 |
| 103 | 1 | N/A | 24 | 30 | 1 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 1 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 1 |
| 113 | 2 | 24 | 24 | 24 | 0 |
| 114 | 3 | 24 | 36 | 36 | 0 |
| 115 | 3 | 24 | N/A | 24 | 1 |
| 116 | 3 | 24 | N/A | 24 | 1 |
| 117 | 3 | 24 | N/A | 24 | 1 |
| 118 | 3 | 24 | N/A | 24 | 1 |
| 119 | 3 | 24 | N/A | 24 | 1 |
| 120 | 3 | 24 | N/A | 24 | 1 |
| 121 | 3 | 24 | N/A | 24 | 1 |
| 122 | 3 | 24 | N/A | 36 | 0 |
| 123 | 2 | 24 | 24 | 24 | 0 |
| 124 | 3 | 24 | N/A | 36 | 0 |
| 125 | 3 | 24 | N/A | 24 | 1 |
| 126 | 3 | 24 | N/A | 24 | 1 |
| 127 | 3 | 24 | N/A | 36 | 0 |
| 128 | 3 | 24 | N/A | 24 | 1 |
| 129 | 3 | 24 | N/A | 36 | 0 |
| 130 | 3 | 24 | N/A | 24 | 1 |
| A | B | I | J | K | L |

Zazingo Table 24C
Multi-Directional, Multi-Dimensional
Reverse Matrix Auction

Qualifying Bids>>>>>>>>>>>>>>>>>>>>>>>>>>

| 120 | 3 | $1,000 | $0 | $6,500 | |
|---|---|---|---|---|---|
| | | Maximum Position Other Funding | | | Inclusion By |
| Bid | Priority | Senior | Subordinate | Same | Other Funding |
| | | $1,000 | $0 | $6,500 | |
| 101 | 1 | $0 | $0 | $0 | 0 |
| 102 | 2 | $1,000 | $0 | $0 | 1 |
| 103 | 1 | $0 | $0 | $0 | 0 |
| 104 | 1 | $0 | $0 | $0 | 0 |
| 105 | 1 | $0 | $0 | $0 | 0 |
| 106 | 1 | $0 | $0 | $0 | 0 |
| 107 | 1 | $0 | $0 | $0 | 0 |
| 108 | 3 | $0 | $0 | $4,000 | 1 |
| 109 | 1 | $0 | $0 | $0 | 0 |
| 110 | 1 | $0 | $0 | $0 | 0 |
| 111 | 3 | $0 | $0 | $0 | 0 |
| 112 | 2 | $0 | $0 | $0 | 0 |
| 113 | 2 | $0 | $0 | $0 | 0 |
| 114 | 3 | $0 | $0 | $0 | 0 |
| 115 | 3 | $0 | $0 | $2,500 | 0 |
| 116 | 3 | $0 | $0 | $0 | 0 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 1 |
| 121 | 3 | $0 | $0 | $0 | 0 |
| 122 | 3 | $0 | $0 | $0 | 0 |
| 123 | 2 | $0 | $0 | $0 | 0 |
| 124 | 3 | $0 | $0 | $0 | 0 |
| 125 | 3 | $0 | $0 | $0 | 0 |
| 126 | 3 | $0 | $0 | $0 | 0 |
| 127 | 3 | $0 | $0 | $0 | 0 |
| 128 | 3 | $0 | $0 | $0 | 0 |
| 129 | 3 | $0 | $0 | $0 | 0 |
| 130 | 3 | $0 | $0 | $0 | 0 |
| A | B | M | N | O | P |

Zazingo Table 24D
Multi-Directional, Multi-Dimensional
Reverse Matrix Auction

| | | | Borrower | | Lender | | |
|---|---|---|---|---|---|---|---|
| | | | Loan Terms | | Yields On Investment | | |
| 120 | 3 | Selected Bids | | Overall | 1st | 2nd | 3rd |
| | | | Rates >> | 11.10% | 0.00% | 7.25% | 11.53% |
| | | Total | Months >> | 25.2 | 0.0 | 36.0 | 24.0 |
| Bid | Priority | $10,000 | Mo. Pmt >> | $452.75 | $0 | $1,000 | $9,000 |
| 101 | 1 | $0 | | $0.00 | $0 | $0 | $0 |
| 102 | 2 | $1,000 | | $30.99 | $0 | $1,000 | $0 |
| 103 | 1 | $0 | | $0.00 | $0 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $4,000 | | $182.28 | $0 | $0 | $4,000 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $0 | | $0.00 | $0 | $0 | $0 |
| 113 | 2 | $0 | | $0.00 | $0 | $0 | $0 |
| 114 | 3 | $0 | | $0.00 | $0 | $0 | $0 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $5,000 | | $239.47 | $0 | $0 | $5,000 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 25
Zazingo Table 25A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 121 | 3 | | | 24 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 25B
Multi-Directional, Multi-Dimensional
Reverse Matrix Auction

| | | Compatability Factors | | | Qualifying |
|---|---|---|---|---|---|
| | | Continued | | | Bids |
| 121 | 3 | 24 | N/A | 24 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 1 |
| 103 | 1 | N/A | 24 | 30 | 1 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 1 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 1 |
| 113 | 2 | 24 | 24 | 24 | 0 |
| 114 | 3 | 24 | 36 | 36 | 0 |
| 115 | 3 | 24 | N/A | 24 | 1 |
| 116 | 3 | 24 | N/A | 24 | 1 |
| 117 | 3 | 24 | N/A | 24 | 1 |
| 118 | 3 | 24 | N/A | 24 | 1 |
| 119 | 3 | 24 | N/A | 24 | 1 |
| 120 | 3 | 24 | N/A | 24 | 1 |
| 121 | 3 | 24 | N/A | 24 | 1 |
| 122 | 3 | 24 | N/A | 36 | 0 |
| 123 | 2 | 24 | 24 | 24 | 0 |
| 124 | 3 | 24 | N/A | 36 | 0 |
| 125 | 3 | 24 | N/A | 24 | 1 |
| 126 | 3 | 24 | N/A | 24 | 1 |
| 127 | 3 | 24 | N/A | 36 | 0 |
| 128 | 3 | 24 | N/A | 24 | 1 |
| 129 | 3 | 24 | N/A | 36 | 0 |
| 130 | 3 | 24 | N/A | 24 | 1 |
| A | B | I | J | K | L |

Zazingo Table 25C
Multi-Directional, Multi-Dimensional
Reverse Matrix Auction

Qualifying Bids>>>>>>>>>>>>>>>>>>>>>>>>>>

| 121 | 3 | $5,000 | $0 | $2,000 | |
|---|---|---|---|---|---|
| | | Maximum Position Other Funding | | | Inclusion By |
| | | Senior | Subordinate | Same | Other Funding |
| Bid | Priority | $3,500 | $0 | $2,000 | |
| 101 | 1 | $0 | $0 | $0 | 1 |
| 102 | 2 | $1,000 | $0 | $0 | 1 |
| 103 | 1 | $1,500 | $0 | $0 | 1 |
| 104 | 1 | $0 | $0 | $0 | 1 |
| 105 | 1 | $0 | $0 | $0 | 1 |
| 106 | 1 | $0 | $0 | $0 | 1 |
| 107 | 1 | $0 | $0 | $0 | 1 |
| 108 | 3 | $0 | $0 | $2,000 | 1 |
| 109 | 1 | $0 | $0 | $0 | 0 |
| 110 | 1 | $0 | $0 | $0 | 0 |
| 111 | 3 | $0 | $0 | $0 | 1 |
| 112 | 2 | $1,000 | $0 | $0 | 1 |
| 113 | 2 | $0 | $0 | $0 | 1 |
| 114 | 3 | $0 | $0 | $0 | 1 |
| 115 | 3 | $0 | $0 | $0 | 0 |
| 116 | 3 | $0 | $0 | $0 | 0 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 1 |
| 122 | 3 | $0 | $0 | $0 | 1 |
| 123 | 2 | $0 | $0 | $0 | 1 |
| 124 | 3 | $0 | $0 | $0 | 0 |
| 125 | 3 | $0 | $0 | $0 | 1 |
| 126 | 3 | $0 | $0 | $0 | 1 |
| 127 | 3 | $0 | $0 | $0 | 1 |
| 128 | 3 | $0 | $0 | $0 | 0 |
| 129 | 3 | $0 | $0 | $0 | 0 |
| 130 | 3 | $0 | $0 | $0 | 0 |
| A | B | M | N | O | P |

Zazingo BORROWER RESERVE NOT SATISFIED Table 25D
Multi-Directional, Multi-Dimensional
Reverse Matrix Auction

| | | | Borrower | | Lender | | |
|---|---|---|---|---|---|---|---|
| | | | Loan Terms | | Yields On Investment | | |
| 121 | 3 | Selected Bids | | Overall | 1st | 2nd | 3rd |
| | | | Rates >> | 9.19% | 7.50% | 8.50% | 10.50% |
| Bid | Priority | Total | Months >> | 29.1 | 30.0 | 36.0 | 24.0 |
| | | $6,500 | Mo. Pmt >> | $257.28 | $1,500 | $2,000 | $3,000 |
| 101 | 1 | $0 | | $0.00 | $0 | $0 | $0 |
| 102 | 2 | $1,000 | | $30.99 | $0 | $1,000 | $0 |
| 103 | 1 | $1,500 | | $54.99 | $1,500 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $2,000 | | $91.14 | $0 | $0 | $2,000 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $1,000 | | $32.15 | $0 | $1,000 | $0 |
| 113 | 2 | $0 | | $0.00 | $0 | $0 | $0 |
| 114 | 3 | $0 | | $0.00 | $0 | $0 | $0 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $1,000 | | $48.01 | $0 | $0 | $1,000 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 26
Zazingo Table 26A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 122 | 3 | | | 12 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 26B
Multi-Directional, Multi-Dimensional
Reverse Matrix Auction

| | | Compatability Factors | | | Qualifying |
|---|---|---|---|---|---|
| | | Continued | | | Bids |
| 122 | 3 | 24 | N/A | 36 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 0 |
| 103 | 1 | N/A | 24 | 30 | 0 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 0 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 0 |
| 113 | 2 | 24 | 24 | 24 | 0 |
| 114 | 3 | 24 | 36 | 36 | 0 |
| 115 | 3 | 24 | N/A | 24 | 0 |
| 116 | 3 | 24 | N/A | 24 | 0 |
| 117 | 3 | 24 | N/A | 24 | 0 |
| 118 | 3 | 24 | N/A | 24 | 0 |
| 119 | 3 | 24 | N/A | 24 | 0 |
| 120 | 3 | 24 | N/A | 24 | 0 |
| 121 | 3 | 24 | N/A | 24 | 0 |
| 122 | 3 | 24 | N/A | 36 | 1 |
| 123 | 2 | 24 | 24 | 24 | 0 |
| 124 | 3 | 24 | N/A | 36 | 0 |
| 125 | 3 | 24 | N/A | 24 | 0 |
| 126 | 3 | 24 | N/A | 24 | 0 |
| 127 | 3 | 24 | N/A | 36 | 0 |
| 128 | 3 | 24 | N/A | 24 | 0 |
| 129 | 3 | 24 | N/A | 36 | 0 |
| 130 | 3 | 24 | N/A | 24 | 0 |
| A | B | I | J | K | L |

Zazingo Table 26C
Multi-Directional, Multi-Dimensional
Reverse Matrix Auction

Qualifying Bids>>>>>>>>>>>>>>>>>>>>>>>>>>

| 122 | 3 | $5,500 | $0 | $5,500 | |
|---|---|---|---|---|---|
| | | Maximum Position Other Funding | | | Inclusion By |
| Bid | Priority | Senior | Subordinate | Same | Other Funding |
| | | $0 | $0 | $0 | |
| 101 | 1 | $0 | $0 | $0 | 1 |
| 102 | 2 | $0 | $0 | $0 | 1 |
| 103 | 1 | $0 | $0 | $0 | 1 |
| 104 | 1 | $0 | $0 | $0 | 1 |
| 105 | 1 | $0 | $0 | $0 | 1 |
| 106 | 1 | $0 | $0 | $0 | 1 |
| 107 | 1 | $0 | $0 | $0 | 1 |
| 108 | 3 | $0 | $0 | $0 | 1 |
| 109 | 1 | $0 | $0 | $0 | 1 |
| 110 | 1 | $0 | $0 | $0 | 1 |
| 111 | 3 | $0 | $0 | $0 | 1 |
| 112 | 2 | $0 | $0 | $0 | 1 |
| 113 | 2 | $0 | $0 | $0 | 1 |
| 114 | 3 | $0 | $0 | $0 | 1 |
| 115 | 3 | $0 | $0 | $0 | 1 |
| 116 | 3 | $0 | $0 | $0 | 1 |
| 117 | 3 | $0 | $0 | $0 | 1 |
| 118 | 3 | $0 | $0 | $0 | 1 |
| 119 | 3 | $0 | $0 | $0 | 1 |
| 120 | 3 | $0 | $0 | $0 | 1 |
| 121 | 3 | $0 | $0 | $0 | 1 |
| 122 | 3 | $0 | $0 | $0 | 1 |
| 123 | 2 | $0 | $0 | $0 | 1 |
| 124 | 3 | $0 | $0 | $0 | 1 |
| 125 | 3 | $0 | $0 | $0 | 1 |
| 126 | 3 | $0 | $0 | $0 | 1 |
| 127 | 3 | $0 | $0 | $0 | 1 |
| 128 | 3 | $0 | $0 | $0 | 1 |
| 129 | 3 | $0 | $0 | $0 | 1 |
| 130 | 3 | $0 | $0 | $0 | 0 |
| A | B | M | N | O | P |

Zazingo BORROWER RESERVE NOT SATISFIED Table 26D
Multi-Directional, Multi-Dimensional
Reverse Matrix Auction

| | | | Borrower | | Lender | | |
|---|---|---|---|---|---|---|---|
| | | | Loan Terms | | Yields On Investment | | |
| 122 | 3 | Selected Bids | | Overall | 1st | 2nd | 3rd |
| | | | Rates >> | 14.25% | 0.00% | 0.00% | 14.25% |
| | | Total | Months >> | 12.0 | 0.0 | 0.0 | 12.0 |
| Bid | Priority | $1,500 | Mo. Pmt >> | $134.86 | $0 | $0 | $1,500 |
| 101 | 1 | $0 | | $0.00 | $0 | $0 | $0 |
| 102 | 2 | $0 | | $0.00 | $0 | $0 | $0 |
| 103 | 1 | $0 | | $0.00 | $0 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $0 | | $0.00 | $0 | $0 | $0 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $0 | | $0.00 | $0 | $0 | $0 |
| 113 | 2 | $0 | | $0.00 | $0 | $0 | $0 |
| 114 | 3 | $0 | | $0.00 | $0 | $0 | $0 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $1,500 | | $134.86 | $0 | $0 | $1,500 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 27
Zazingo Table 27A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 123 | 2 | | | 24 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 27B
Multi-Directional, Multi-Dimensional
Reverse Matrix Auction

| | | Compatability Factors | | | Qualifying |
|---|---|---|---|---|---|
| | | Continued | | | Bids |
| 123 | 2 | 24 | 24 | 24 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 1 |
| 103 | 1 | N/A | 24 | 30 | 1 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 1 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 0 |
| 113 | 2 | 24 | 24 | 24 | 1 |
| 114 | 3 | 24 | 36 | 36 | 0 |
| 115 | 3 | 24 | N/A | 24 | 1 |
| 116 | 3 | 24 | N/A | 24 | 1 |
| 117 | 3 | 24 | N/A | 24 | 1 |
| 118 | 3 | 24 | N/A | 24 | 1 |
| 119 | 3 | 24 | N/A | 24 | 1 |
| 120 | 3 | 24 | N/A | 24 | 1 |
| 121 | 3 | 24 | N/A | 24 | 1 |
| 122 | 3 | 24 | N/A | 36 | 0 |
| 123 | 2 | 24 | 24 | 24 | 1 |
| 124 | 3 | 24 | N/A | 36 | 0 |
| 125 | 3 | 24 | N/A | 24 | 1 |
| 126 | 3 | 24 | N/A | 24 | 1 |
| 127 | 3 | 24 | N/A | 36 | 0 |
| 128 | 3 | 24 | N/A | 24 | 1 |
| 129 | 3 | 24 | N/A | 36 | 0 |
| 130 | 3 | 24 | N/A | 24 | 1 |
| A | B | I | J | K | L |

Zazingo Table 27C
Multi-Directional, Multi-Dimensional
Reverse Matrix Auction

Qualifying Bids>>>>>>>>>>>>>>>>>>>>>>>>>>

| 123 | 2 | $6,000 | $3,000 | $2,000 | |
|---|---|---|---|---|---|
| | | Maximum Position Other Funding | | | Inclusion By |
| Bid | Priority | Senior | Subordinate | Same | Other Funding |
| | | $1,500 | $3,000 | $2,000 | |
| 101 | 1 | $0 | $0 | $0 | 1 |
| 102 | 2 | $0 | $0 | $1,000 | 1 |
| 103 | 1 | $1,500 | $0 | $0 | 1 |
| 104 | 1 | $0 | $0 | $0 | 1 |
| 105 | 1 | $0 | $0 | $0 | 1 |
| 106 | 1 | $0 | $0 | $0 | 1 |
| 107 | 1 | $0 | $0 | $0 | 1 |
| 108 | 3 | $0 | $3,000 | $0 | 0 |
| 109 | 1 | $0 | $0 | $0 | 0 |
| 110 | 1 | $0 | $0 | $0 | 0 |
| 111 | 3 | $0 | $0 | $0 | 1 |
| 112 | 2 | $0 | $0 | $0 | 0 |
| 113 | 2 | $0 | $0 | $1,000 | 1 |
| 114 | 3 | $0 | $0 | $0 | 1 |
| 115 | 3 | $0 | $0 | $0 | 0 |
| 116 | 3 | $0 | $0 | $0 | 0 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 0 |
| 122 | 3 | $0 | $0 | $0 | 0 |
| 123 | 2 | $0 | $0 | $0 | 1 |
| 124 | 3 | $0 | $0 | $0 | 1 |
| 125 | 3 | $0 | $0 | $0 | 1 |
| 126 | 3 | $0 | $0 | $0 | 1 |
| 127 | 3 | $0 | $0 | $0 | 1 |
| 128 | 3 | $0 | $0 | $0 | 1 |
| 129 | 3 | $0 | $0 | $0 | 1 |
| 130 | 3 | $0 | $0 | $0 | 1 |
| A | B | M | N | O | P |

Zazingo BORROWER RESERVE NOT SATISFIED Table 27D
Multi-Directional, Multi-Dimensional
Reverse Matrix Auction

| | | | Borrower | | Lender | | |
|---|---|---|---|---|---|---|---|
| | | | Loan Terms | | Yields On Investment | | |
| 123 | 2 | Selected Bids | | Overall | 1st | 2nd | 3rd |
| | | | Rates >> | 10.79% | 7.50% | 11.89% | 0.00% |
| | | Total | Months >> | 27.8 | 30.0 | 27.0 | 0.0 |
| Bid | Priority | $6,000 | Mo. Pmt >> | $252.75 | $1,500 | $4,500 | $0 |
| 101 | 1 | $0 | | $0.00 | $0 | $0 | $0 |
| 102 | 2 | $1,000 | | $30.99 | $0 | $1,000 | $0 |
| 103 | 1 | $1,500 | | $54.99 | $1,500 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $0 | | $0.00 | $0 | $0 | $0 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $0 | | $0.00 | $0 | $0 | $0 |
| 113 | 2 | $1,000 | | $46.14 | $0 | $1,000 | $0 |
| 114 | 3 | $0 | | $0.00 | $0 | $0 | $0 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $2,500 | | $120.62 | $0 | $2.500 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 28
Zazingo Table 28A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 124 | 3 | | | 36 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 28B
Multi-Directional, Multi-Dimensional
Reverse Matrix Auction

| | | Compatability Factors | | | Qualifying |
|---|---|---|---|---|---|
| | | Continued | | | Bids |
| 124 | 3 | 24 | N/A | 36 | |
| | | Minimum Term By Position | | | Inclusion |
| Bid | Priority | Senior | Subordinate | Same | By Term |
| 101 | 1 | N/A | 36 | 36 | 1 |
| 102 | 2 | 24 | 18 | 18 | 1 |
| 103 | 1 | N/A | 24 | 30 | 0 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 0 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 1 |
| 113 | 2 | 24 | 24 | 24 | 0 |
| 114 | 3 | 24 | 36 | 36 | 1 |
| 115 | 3 | 24 | N/A | 24 | 0 |
| 116 | 3 | 24 | N/A | 24 | 0 |
| 117 | 3 | 24 | N/A | 24 | 0 |
| 118 | 3 | 24 | N/A | 24 | 0 |
| 119 | 3 | 24 | N/A | 24 | 0 |
| 120 | 3 | 24 | N/A | 24 | 0 |
| 121 | 3 | 24 | N/A | 24 | 0 |
| 122 | 3 | 24 | N/A | 36 | 0 |
| 123 | 2 | 24 | 24 | 24 | 0 |
| 124 | 3 | 24 | N/A | 36 | 1 |
| 125 | 3 | 24 | N/A | 24 | 0 |
| 126 | 3 | 24 | N/A | 24 | 0 |
| 127 | 3 | 24 | N/A | 36 | 1 |
| 128 | 3 | 24 | N/A | 24 | 0 |
| 129 | 3 | 24 | N/A | 36 | 1 |
| 130 | 3 | 24 | N/A | 24 | 0 |
| A | B | I | J | K | L |

Zazingo Table 28C
Multi-Directional, Multi-Dimensional
Reverse Matrix Auction

Qualifying Bids>>>>>>>>>>>>>>>>>>>>>>>>>>

| 124 | 3 | $9,000 | $0 | $2,000 | |
|---|---|---|---|---|---|
| | | Maximum Position Other Funding | | | Inclusion By |
| Bid | Priority | Senior | Subordinate | Same | Other Funding |
| | | $4,000 | $0 | $2,000 | |
| 101 | 1 | $2,000 | $0 | $0 | 0 |
| 102 | 2 | $1,000 | $0 | $0 | 1 |
| 103 | 1 | $0 | $0 | $0 | 0 |
| 104 | 1 | $0 | $0 | $0 | 0 |
| 105 | 1 | $0 | $0 | $0 | 0 |
| 106 | 1 | $0 | $0 | $0 | 0 |
| 107 | 1 | $0 | $0 | $0 | 0 |
| 108 | 3 | $0 | $0 | $0 | 1 |
| 109 | 1 | $0 | $0 | $0 | 0 |
| 110 | 1 | $0 | $0 | $0 | 0 |
| 111 | 3 | $0 | $0 | $0 | 0 |
| 112 | 2 | $1,000 | $0 | $0 | 1 |
| 113 | 2 | $0 | $0 | $0 | 1 |
| 114 | 3 | $0 | $0 | $2,000 | 1 |
| 115 | 3 | $0 | $0 | $0 | 0 |
| 116 | 3 | $0 | $0 | $0 | 0 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 0 |
| 122 | 3 | $0 | $0 | $0 | 1 |
| 123 | 2 | $0 | $0 | $0 | 0 |
| 124 | 3 | $0 | $0 | $0 | 1 |
| 125 | 3 | $0 | $0 | $0 | 0 |
| 126 | 3 | $0 | $0 | $0 | 0 |
| 127 | 3 | $0 | $0 | $0 | 0 |
| 128 | 3 | $0 | $0 | $0 | 0 |
| 129 | 3 | $0 | $0 | $0 | 0 |
| 130 | 3 | $0 | $0 | $0 | 0 |
| A | B | M | N | O | P |

Zazingo BORROWER RESERVE NOT SATISFIED Table 28D
Multi-Directional, Multi-Dimensional
Reverse Matrix Auction

| | | | Borrower | | Lender | | |
|---|---|---|---|---|---|---|---|
| | | | Loan Terms | | Yields On Investment | | |
| 124 | 3 | Selected Bids | | Overall | 1st | 2nd | 3rd |
| | | | Rates >> | 12.42% | 0.00% | 8.50% | 13.84% |
| | | Total | Months >> | 36.0 | 0.0 | 36.0 | 36.0 |
| Bid | Priority | $7,500 | Mo. Pmt >> | $250.71 | $0 | $2,000 | $5,500 |
| 101 | 1 | $0 | | $0.00 | $0 | $0 | $0 |
| 102 | 2 | $1,000 | | $30.99 | $0 | $1,000 | $0 |
| 103 | 1 | $0 | | $0.00 | $0 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $0 | | $0.00 | $0 | $0 | $0 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $1,000 | | $32.15 | $0 | $1,000 | $0 |
| 113 | 2 | $0 | | $0.00 | $0 | $0 | $0 |
| 114 | 3 | $2,000 | | $66.67 | $0 | $0 | $2,000 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $3,500 | | $120.90 | $0 | $0 | $3,500 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 29
Zazingo Table 29A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 125 | 3 | | | 24 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 29B
Multi-Directional, Multi-Dimensional
Reverse Matrix Auction

| | | Compatability Factors | | | Qualifying |
|---|---|---|---|---|---|
| | | Continued | | | Bids |
| 125 | 3 | 24 | 0 | 24 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 1 |
| 103 | 1 | N/A | 24 | 30 | 1 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 1 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 1 |
| 113 | 2 | 24 | 24 | 24 | 0 |
| 114 | 3 | 24 | 36 | 36 | 0 |
| 115 | 3 | 24 | N/A | 24 | 1 |
| 116 | 3 | 24 | N/A | 24 | 1 |
| 117 | 3 | 24 | N/A | 24 | 1 |
| 118 | 3 | 24 | N/A | 24 | 1 |
| 119 | 3 | 24 | N/A | 24 | 1 |
| 120 | 3 | 24 | N/A | 24 | 1 |
| 121 | 3 | 24 | N/A | 24 | 1 |
| 122 | 3 | 24 | N/A | 36 | 0 |
| 123 | 2 | 24 | 24 | 24 | 0 |
| 124 | 3 | 24 | N/A | 36 | 0 |
| 125 | 3 | 24 | N/A | 24 | 1 |
| 126 | 3 | 24 | N/A | 24 | 1 |
| 127 | 3 | 24 | N/A | 36 | 0 |
| 128 | 3 | 24 | N/A | 24 | 1 |
| 129 | 3 | 24 | N/A | 36 | 0 |
| 130 | 3 | 24 | N/A | 24 | 1 |
| A | B | I | J | K | L |

Zazingo Table 29C
Multi-Directional, Multi-Dimensional
Reverse Matrix Auction

Qualifying Bids>>>>>>>>>>>>>>>>>>>>>>>>>>

| 125 | 3 | $7,000 | $0 | $4,000 | |
|---|---|---|---|---|---|
| | | Maximum Position Other Funding | | | Inclusion By |
| Bid | Priority | Senior | Subordinate | Same | Other Funding |
| | | $3,500 | $0 | $4,000 | |
| 101 | 1 | $0 | $0 | $0 | 0 |
| 102 | 2 | $1,000 | $0 | $0 | 1 |
| 103 | 1 | $1,500 | $0 | $0 | 0 |
| 104 | 1 | $0 | $0 | $0 | 0 |
| 105 | 1 | $0 | $0 | $0 | 0 |
| 106 | 1 | $0 | $0 | $0 | 0 |
| 107 | 1 | $0 | $0 | $0 | 0 |
| 108 | 3 | $0 | $0 | $4,000 | 1 |
| 109 | 1 | $0 | $0 | $0 | 0 |
| 110 | 1 | $0 | $0 | $0 | 0 |
| 111 | 3 | $0 | $0 | $0 | 0 |
| 112 | 2 | $1,000 | $0 | $0 | 0 |
| 113 | 2 | $0 | $0 | $0 | 0 |
| 114 | 3 | $0 | $0 | $0 | 0 |
| 115 | 3 | $0 | $0 | $0 | 0 |
| 116 | 3 | $0 | $0 | $0 | 0 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 0 |
| 122 | 3 | $0 | $0 | $0 | 0 |
| 123 | 2 | $0 | $0 | $0 | 0 |
| 124 | 3 | $0 | $0 | $0 | 0 |
| 125 | 3 | $0 | $0 | $0 | 1 |
| 126 | 3 | $0 | $0 | $0 | 0 |
| 127 | 3 | $0 | $0 | $0 | 0 |
| 128 | 3 | $0 | $0 | $0 | 0 |
| 129 | 3 | $0 | $0 | $0 | 0 |
| 130 | 3 | $0 | $0 | $0 | 0 |
| A | B | M | N | O | P |

Zazingo BORROWER RESERVE NOT SATISFIED Table 29D
Multi-Directional, Multi-Dimensional
Reverse Matrix Auction

| | | | Borrower | | Lender | | |
|---|---|---|---|---|---|---|---|
| | | | Loan Terms | | Yields On Investment | | |
| 125 | 3 | Selected Bids | | Overall | 1st | 2nd | 3rd |
| | | | Rates >> | 11.36% | 0.00% | 7.25% | 11.88% |
| | | Total | Months >> | 25.3 | 0.0 | 36.0 | 24.0 |
| Bid | Priority | $9,000 | Mo. Pmt >> | $407.22 | $0 | $1,000 | $8,000 |
| 101 | 1 | $0 | | $0.00 | $0 | $0 | $0 |
| 102 | 2 | $1,000 | | $30.99 | $0 | $1,000 | $0 |
| 103 | 1 | $0 | | $0.00 | $0 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $4,000 | | $182.28 | $0 | $0 | $4,000 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $0 | | $0.00 | $0 | $0 | $0 |
| 113 | 2 | $0 | | $0.00 | $0 | $0 | $0 |
| 114 | 3 | $0 | | $0.00 | $0 | $0 | $0 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $4,000 | | $193.95 | $0 | $0 | $4,000 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 30
Zazingo Table 30A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 126 | 3 | | | 24 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 30B
Multi-Directional, Multi-Dimensional
Reverse Matrix Auction

| | | Compatability Factors | | | Qualifying |
|---|---|---|---|---|---|
| | | Continued | | | Bids |
| 126 | 3 | 24 | 0 | 24 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 1 |
| 103 | 1 | N/A | 24 | 30 | 1 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 1 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 1 |
| 113 | 2 | 24 | 24 | 24 | 0 |
| 114 | 3 | 24 | 36 | 36 | 0 |
| 115 | 3 | 24 | N/A | 24 | 1 |
| 116 | 3 | 24 | N/A | 24 | 1 |
| 117 | 3 | 24 | N/A | 24 | 1 |
| 118 | 3 | 24 | N/A | 24 | 1 |
| 119 | 3 | 24 | N/A | 24 | 1 |
| 120 | 3 | 24 | N/A | 24 | 1 |
| 121 | 3 | 24 | N/A | 24 | 1 |
| 122 | 3 | 24 | N/A | 36 | 0 |
| 123 | 2 | 24 | 24 | 24 | 0 |
| 124 | 3 | 24 | N/A | 36 | 0 |
| 125 | 3 | 24 | N/A | 24 | 1 |
| 126 | 3 | 24 | N/A | 24 | 1 |
| 127 | 3 | 24 | N/A | 36 | 0 |
| 128 | 3 | 24 | N/A | 24 | 1 |
| 129 | 3 | 24 | N/A | 36 | 0 |
| 130 | 3 | 24 | N/A | 24 | 1 |
| A | B | I | J | K | L |

Zazingo Table 30C
Multi-Directional, Multi-Dimensional
Reverse Matrix Auction

Qualifying Bids>>>>>>>>>>>>>>>>>>>>>>>>>>

| 126 | 3 | $7,500 | $0 | $3,500 | |
|---|---|---|---|---|---|
| | | Maximum Position Other Funding | | | Inclusion By |
| Bid | Priority | Senior | Subordinate | Same | Other Funding |
| | | $3,500 | $0 | $3,500 | |
| 101 | 1 | $0 | $0 | $0 | 0 |
| 102 | 2 | $1,000 | $0 | $0 | 1 |
| 103 | 1 | $1,500 | $0 | $0 | 0 |
| 104 | 1 | $0 | $0 | $0 | 0 |
| 105 | 1 | $0 | $0 | $0 | 0 |
| 106 | 1 | $0 | $0 | $0 | 0 |
| 107 | 1 | $0 | $0 | $0 | 0 |
| 108 | 3 | $0 | $0 | $3,500 | 1 |
| 109 | 1 | $0 | $0 | $0 | 0 |
| 110 | 1 | $0 | $0 | $0 | 0 |
| 111 | 3 | $0 | $0 | $0 | 0 |
| 112 | 2 | $1,000 | $0 | $0 | 1 |
| 113 | 2 | $0 | $0 | $0 | 1 |
| 114 | 3 | $0 | $0 | $0 | 0 |
| 115 | 3 | $0 | $0 | $0 | 0 |
| 116 | 3 | $0 | $0 | $0 | 0 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 0 |
| 122 | 3 | $0 | $0 | $0 | 0 |
| 123 | 2 | $0 | $0 | $0 | 0 |
| 124 | 3 | $0 | $0 | $0 | 0 |
| 125 | 3 | $0 | $0 | $0 | 0 |
| 126 | 3 | $0 | $0 | $0 | 1 |
| 127 | 3 | $0 | $0 | $0 | 0 |
| 128 | 3 | $0 | $0 | $0 | 0 |
| 129 | 3 | $0 | $0 | $0 | 0 |
| 130 | 3 | $0 | $0 | $0 | 0 |
| A | B | M | N | O | P |

Zazingo BORROWER RESERVE NOT SATISFIED Table 30D
Multi-Directional, Multi-Dimensional
Reverse Matrix Auction

| | | | Borrower | | Lender | | |
|---|---|---|---|---|---|---|---|
| | | | Loan Terms | | Yields On Investment | | |
| 126 | 3 | Selected Bids | | Overall | 1st | 2nd | 3rd |
| | | | Rates >> | 10.72% | 0.00% | 8.50% | 11.46% |
| | | Total | Months >> | 27.0 | 0.0 | 36.0 | 24.0 |
| Bid | Priority | $8,000 | Mo. Pmt >> | $344.15 | $0 | $2,000 | $6,000 |
| 101 | 1 | $0 | | $0.00 | $0 | $0 | $0 |
| 102 | 2 | $1,000 | | $30.99 | $0 | $1,000 | $0 |
| 103 | 1 | $0 | | $0.00 | $0 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $3,500 | | $159.50 | $0 | $0 | $3,500 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $1,000 | | $32.15 | $0 | $1,000 | $0 |
| 113 | 2 | $0 | | $0.00 | $0 | $0 | $0 |
| 114 | 3 | $0 | | $0.00 | $0 | $0 | $0 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $2,500 | | $121.51 | $0 | $0 | $2,500 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 31
Zazingo Table 31A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 127 | 3 | | | 36 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 31B
Multi-Directional, Multi-Dimensional
Reverse Matrix Auction

| | | Compatability Factors | | | Qualifying |
|---|---|---|---|---|---|
| | | Continued | | | Bids |
| 127 | 3 | 24 | 0 | 36 | |
| | | Minimum Term By Position | | | Inclusion |
| Bid | Priority | Senior | Subordinate | Same | By Term |
| 101 | 1 | N/A | 36 | 36 | 1 |
| 102 | 2 | 24 | 18 | 18 | 1 |
| 103 | 1 | N/A | 24 | 30 | 0 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 0 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 1 |
| 113 | 2 | 24 | 24 | 24 | 0 |
| 114 | 3 | 24 | 36 | 36 | 1 |
| 115 | 3 | 24 | N/A | 24 | 0 |
| 116 | 3 | 24 | N/A | 24 | 0 |
| 117 | 3 | 24 | N/A | 24 | 0 |
| 118 | 3 | 24 | N/A | 24 | 0 |
| 119 | 3 | 24 | N/A | 24 | 0 |
| 120 | 3 | 24 | N/A | 24 | 0 |
| 121 | 3 | 24 | N/A | 24 | 0 |
| 122 | 3 | 24 | N/A | 36 | 0 |
| 123 | 2 | 24 | 24 | 24 | 0 |
| 124 | 3 | 24 | N/A | 36 | 1 |
| 125 | 3 | 24 | N/A | 24 | 0 |
| 126 | 3 | 24 | N/A | 24 | 0 |
| 127 | 3 | 24 | N/A | 36 | 1 |
| 128 | 3 | 24 | N/A | 24 | 0 |
| 129 | 3 | 24 | N/A | 36 | 1 |
| 130 | 3 | 24 | N/A | 24 | 0 |
| A | B | I | J | K | L |

Zazingo Table 31C
Multi-Directional, Multi-Dimensional
Reverse Matrix Auction

Qualifying Bids>>>>>>>>>>>>>>>>>>>>>>>>>>

| 127 | 3 | $8,000 | $0 | $3,000 | |
|---|---|---|---|---|---|
| | | Maximum Position Other Funding | | | Inclusion By |
| Bid | Priority | Senior | Subordinate | Same | Other Funding |
| | | $4,000 | $0 | $3,000 | |
| 101 | 1 | $2,000 | $0 | $0 | 0 |
| 102 | 2 | $1,000 | $0 | $0 | 1 |
| 103 | 1 | $0 | $0 | $0 | 1 |
| 104 | 1 | $0 | $0 | $0 | 0 |
| 105 | 1 | $0 | $0 | $0 | 0 |
| 106 | 1 | $0 | $0 | $0 | 0 |
| 107 | 1 | $0 | $0 | $0 | 0 |
| 108 | 3 | $0 | $0 | $0 | 1 |
| 109 | 1 | $0 | $0 | $0 | 0 |
| 110 | 1 | $0 | $0 | $0 | 0 |
| 111 | 3 | $0 | $0 | $0 | 0 |
| 112 | 2 | $1,000 | $0 | $0 | 1 |
| 113 | 2 | $0 | $0 | $0 | 1 |
| 114 | 3 | $0 | $0 | $2,000 | 1 |
| 115 | 3 | $0 | $0 | $0 | 0 |
| 116 | 3 | $0 | $0 | $0 | 0 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 0 |
| 122 | 3 | $0 | $0 | $0 | 1 |
| 123 | 2 | $0 | $0 | $0 | 0 |
| 124 | 3 | $0 | $0 | $1,000 | 0 |
| 125 | 3 | $0 | $0 | $0 | 0 |
| 126 | 3 | $0 | $0 | $0 | 0 |
| 127 | 3 | $0 | $0 | $0 | 1 |
| 128 | 3 | $0 | $0 | $0 | 0 |
| 129 | 3 | $0 | $0 | $0 | 0 |
| 130 | 3 | $0 | $0 | $0 | 0 |
| A | B | M | N | O | P |

Zazingo BORROWER RESERVE NOT SATISFIED Table 31D
Multi-Directional, Multi-Dimensional
Reverse Matrix Auction

| | | | Borrower | | Lender | | |
|---|---|---|---|---|---|---|---|
| | | | Loan Terms | | Yields On Investment | | |
| 127 | 3 | Selected Bids | | Overall | 1st | 2nd | 3rd |
| | | | Rates >> | 12.57% | 0.00% | 8.50% | 14.20% |
| | | Total | Months >> | 36.0 | 0.0 | 36.0 | 36.0 |
| Bid | Priority | $7,000 | Mo. Pmt >> | $234.54 | $0 | $2,000 | $5,000 |
| 101 | 1 | $0 | | $0.00 | $0 | $0 | $0 |
| 102 | 2 | $1,000 | | $30.99 | $0 | $1.000 | $0 |
| 103 | 1 | $0 | | $0.00 | $0 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $0 | | $0.00 | $0 | $0 | $0 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $1,000 | | $32.15 | $0 | $1,000 | $0 |
| 113 | 2 | $0 | | $0.00 | $0 | $0 | $0 |
| 114 | 3 | $2,000 | | $66.67 | $0 | $0 | $2,000 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $3,000 | | $104.73 | $0 | $0 | $3,000 |
| 128 | 3 | $0 | | $0.00 | $0 | $0 | $0 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 32
Zazingo Table 32A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 128 | 3 | | | 24 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 32B
Multi-Directional, Multi-Dimensional
Reverse Matrix Auction

| | | Compatability Factors | | | Qualifying |
|---|---|---|---|---|---|
| | | Continued | | | Bids |
| 128 | 3 | 24 | 0 | 24 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 1 |
| 103 | 1 | N/A | 24 | 30 | 1 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 1 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 1 |
| 113 | 2 | 24 | 24 | 24 | 0 |
| 114 | 3 | 24 | 36 | 36 | 0 |
| 115 | 3 | 24 | N/A | 24 | 1 |
| 116 | 3 | 24 | N/A | 24 | 1 |
| 117 | 3 | 24 | N/A | 24 | 1 |
| 118 | 3 | 24 | N/A | 24 | 1 |
| 119 | 3 | 24 | N/A | 24 | 1 |
| 120 | 3 | 24 | N/A | 24 | 1 |
| 121 | 3 | 24 | N/A | 24 | 1 |
| 122 | 3 | 24 | N/A | 36 | 0 |
| 123 | 2 | 24 | 24 | 24 | 0 |
| 124 | 3 | 24 | N/A | 36 | 0 |
| 125 | 3 | 24 | N/A | 24 | 1 |
| 126 | 3 | 24 | N/A | 24 | 1 |
| 127 | 3 | 24 | N/A | 36 | 0 |
| 128 | 3 | 24 | N/A | 24 | 1 |
| 129 | 3 | 24 | N/A | 36 | 0 |
| 130 | 3 | 24 | N/A | 24 | 1 |
| A | B | I | J | K | L |

Zazingo Table 32C
Multi-Directional, Multi-Dimensional
Reverse Matrix Auction

Qualifying Bids>>>>>>>>>>>>>>>>>>>>>>>>>>

| 128 | 3 | $8,500 | $0 | $2,500 | |
|---|---|---|---|---|---|
| | | Maximum Position Other Funding | | | Inclusion By |
| Bid | Priority | Senior | Subordinate | Same | Other Funding |
| | | $3,500 | $0 | $2,500 | |
| 101 | 1 | $0 | $0 | $0 | 0 |
| 102 | 2 | $1,000 | $0 | $0 | 1 |
| 103 | 1 | $1,500 | $0 | $0 | 1 |
| 104 | 1 | $0 | $0 | $0 | 1 |
| 105 | 1 | $0 | $0 | $0 | 1 |
| 106 | 1 | $0 | $0 | $0 | 0 |
| 107 | 1 | $0 | $0 | $0 | 0 |
| 108 | 3 | $0 | $0 | $2,500 | 1 |
| 109 | 1 | $0 | $0 | $0 | 0 |
| 110 | 1 | $0 | $0 | $0 | 0 |
| 111 | 3 | $0 | $0 | $0 | 0 |
| 112 | 2 | $1,000 | $0 | $0 | 1 |
| 113 | 2 | $0 | $0 | $0 | 1 |
| 114 | 3 | $0 | $0 | $0 | 1 |
| 115 | 3 | $0 | $0 | $0 | 0 |
| 116 | 3 | $0 | $0 | $0 | 0 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 0 |
| 122 | 3 | $0 | $0 | $0 | 1 |
| 123 | 2 | $0 | $0 | $0 | 0 |
| 124 | 3 | $0 | $0 | $0 | 0 |
| 125 | 3 | $0 | $0 | $0 | 1 |
| 126 | 3 | $0 | $0 | $0 | 0 |
| 127 | 3 | $0 | $0 | $0 | 0 |
| 128 | 3 | $0 | $0 | $0 | 1 |
| 129 | 3 | $0 | $0 | $0 | 0 |
| 130 | 3 | $0 | $0 | $0 | 0 |
| A | B | M | N | O | P |

Zazingo BORROWER RESERVE NOT SATISFIED Table 32D
Multi-Directional, Multi-Dimensional
Reverse Matrix Auction

| | | | Borrower | | Lender | | |
|---|---|---|---|---|---|---|---|
| | | | Loan Terms | | Yields On Investment | | |
| 128 | 3 | Selected Bids | | Overall | 1st | 2nd | 3rd |
| | | | Rates >> | 9.83% | 7.50% | 8.50% | 11.38% |
| | | Total | Months >> | 28.4 | 30.0 | 36.0 | 24.0 |
| Bid | Priority | $7,500 | Mo. Pmt >> | $305.32 | $1,500 | $2,000 | $4,000 |
| 101 | 1 | $0 | | $0.00 | $0 | $0 | $0 |
| 102 | 2 | $1,000 | | $30.99 | $0 | $1,000 | $0 |
| 103 | 1 | $1,500 | | $54.99 | $1,500 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $2,500 | | $113.93 | $0 | $0 | $2,500 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $1,000 | | $32.15 | $0 | $1,000 | $0 |
| 113 | 2 | $0 | | $0.00 | $0 | $0 | $0 |
| 114 | 3 | $0 | | $0.00 | $0 | $0 | $0 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $1,500 | | $73.27 | $0 | $0 | $1,500 |
| 129 | 3 | $0 | | $0.00 | $0 | $0 | $0 |
| 130 | 3 | $0 | | $0.00 | $0 | $0 | $0 |
| A | B | Q | | R | S | T | U |

TABLE 33
Zazingo Table 33A
Multi-Directional, Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 129 | 3 | | | 36 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 33B
Multi-Directional, Multi-Dimensional
Reverse Matrix Auction

| | | Compatability Factors | | | Qualifying |
|---|---|---|---|---|---|
| | | Continued | | | Bids |
| 129 | 3 | 24 | 0 | 36 | |
| | | Minimum Term By Position | | | Inclusion |
| Bid | Priority | Senior | Subordinate | Same | By Term |
| 101 | 1 | N/A | 36 | 36 | 1 |
| 102 | 2 | 24 | 18 | 18 | 1 |
| 103 | 1 | N/A | 24 | 30 | 0 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 0 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 1 |
| 113 | 2 | 24 | 24 | 24 | 0 |
| 114 | 3 | 24 | 36 | 36 | 1 |
| 115 | 3 | 24 | N/A | 24 | 0 |
| 116 | 3 | 24 | N/A | 24 | 0 |
| 117 | 3 | 24 | N/A | 24 | 0 |
| 118 | 3 | 24 | N/A | 24 | 0 |
| 119 | 3 | 24 | N/A | 24 | 0 |
| 120 | 3 | 24 | N/A | 24 | 0 |
| 121 | 3 | 24 | N/A | 24 | 0 |
| 122 | 3 | 24 | N/A | 36 | 0 |
| 123 | 2 | 24 | 24 | 24 | 0 |
| 124 | 3 | 24 | N/A | 36 | 1 |
| 125 | 3 | 24 | N/A | 24 | 0 |
| 126 | 3 | 24 | N/A | 24 | 0 |
| 127 | 3 | 24 | N/A | 36 | 1 |
| 128 | 3 | 24 | N/A | 24 | 0 |
| 129 | 3 | 24 | N/A | 36 | 1 |
| 130 | 3 | 24 | N/A | 24 | 0 |
| A | B | I | J | K | L |

Zazingo Table 33C
Multi-Directional, Multi-Dimensional
Reverse Matrix Auction

Qualifying Bids>>>>>>>>>>>>>>>>>>>>>>>>>>

| 129 | 3 | $9,000 | $0 | $2,000 | |
|---|---|---|---|---|---|
| | | Maximum Position Other Funding | | | Inclusion By |
| Bid | Priority | Senior | Subordinate | Same | Other Funding |
| | | $4,000 | $0 | $2,000 | |
| 101 | 1 | $2,000 | $0 | $0 | 1 |
| 102 | 2 | $1,000 | $0 | $0 | 1 |
| 103 | 1 | $0 | $0 | $0 | 1 |
| 104 | 1 | $0 | $0 | $0 | 1 |
| 105 | 1 | $0 | $0 | $0 | 1 |
| 106 | 1 | $0 | $0 | $0 | 1 |
| 107 | 1 | $0 | $0 | $0 | 1 |
| 108 | 3 | $0 | $0 | $0 | 1 |
| 109 | 1 | $0 | $0 | $0 | 0 |
| 110 | 1 | $0 | $0 | $0 | 0 |
| 111 | 3 | $0 | $0 | $0 | 1 |
| 112 | 2 | $1,000 | $0 | $0 | 1 |
| 113 | 2 | $0 | $0 | $0 | 1 |
| 114 | 3 | $0 | $0 | $2,000 | 1 |
| 115 | 3 | $0 | $0 | $0 | 0 |
| 116 | 3 | $0 | $0 | $0 | 0 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 0 |
| 122 | 3 | $0 | $0 | $0 | 1 |
| 123 | 2 | $0 | $0 | $0 | 1 |
| 124 | 3 | $0 | $0 | $0 | 0 |
| 125 | 3 | $0 | $0 | $0 | 1 |
| 126 | 3 | $0 | $0 | $0 | 1 |
| 127 | 3 | $0 | $0 | $0 | 1 |
| 128 | 3 | $0 | $0 | $0 | 0 |
| 129 | 3 | $0 | $0 | $0 | 1 |
| 130 | 3 | $0 | $0 | $0 | 0 |
| A | B | M | N | O | P |

Zazingo BORROWER RESERVE NOT SATISFIED Table 33D
Multi-Directional, Multi-Dimensional
Reverse Matrix Auction

| | | | Borrower | | Lender | | |
|---|---|---|---|---|---|---|---|
| | | | Loan Terms | | Yields On Investment | | |
| 129 | 3 | Selected Bids | | Overall | 1st | 2nd | 3rd |
| | | | Rates >> | 10.21% | 7.00% | 8.50% | 13.50% |
| | | Total | Months >> | 36.0 | 36.0 | 36.0 | 36.0 |
| Bid | Priority | $7,000 | Mo. Pmt >> | $226.72 | $2,000 | $2,000 | $3,000 |
| 101 | 1 | $2,000 | | $61.75 | $2,000 | $0 | $0 |
| 102 | 2 | $1,000 | | $30.99 | $0 | $1,000 | $0 |
| 103 | 1 | $0 | | $0.00 | $0 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $0 | | $0.00 | $0 | $0 | $0 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $1,000 | | $32.15 | $0 | $1,000 | $0 |
| 113 | 2 | $0 | | $0.00 | $0 | $0 | $0 |
| 114 | 3 | $2,000 | | $66.67 | $0 | $0 | $2,000 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $1,000 | | $35.16 | $0 | $0 | $1,000 |
| 130 | 3 | $0 | | $0.00 | $0 | $0 | $0 |
| A | B | Q | | R | S | T | U |

TABLE 34
Zazingo Table 34A
Multi-Directional Multi-Dimensional Reverse Matrix Auction

| Lenders' Terms | | | | | Compatability Factors | | |
|---|---|---|---|---|---|---|---|
| | Bidding Amounts & Terms >>>>>>>>>>>>>>>>>>>>>>>>>>> | | | | | | |
| 130 | 3 | | | 24 | Maximum Position | | |
| | | | | | Other Funding | | |
| Bid | Priority | Amount | Rate | Term | Senior | Subordinate | Same |
| 101 | 1 | $2,000 | 7.00% | 36 | 0% | 55% | 35% |
| 102 | 2 | $1,000 | 7.25% | 36 | 90% | 90% | 35% |
| 103 | 1 | $1,500 | 7.50% | 30 | 0% | 70% | 20% |
| 104 | 1 | $2,000 | 7.75% | 30 | 0% | 65% | 45% |
| 105 | 1 | $2,500 | 8.00% | 24 | 0% | 60% | 20% |
| 106 | 1 | $3,000 | 8.25% | 24 | 0% | 55% | 55% |
| 107 | 1 | $4,000 | 8.50% | 30 | 0% | 50% | 40% |
| 108 | 3 | $4,000 | 8.75% | 24 | 50% | 45% | 65% |
| 109 | 1 | $4,500 | 9.00% | 18 | 0% | 40% | 70% |
| 110 | 1 | $5,000 | 9.25% | 24 | 0% | 35% | 75% |
| 111 | 3 | $500 | 9.50% | 12 | 99% | 0% | 30% |
| 112 | 2 | $1,000 | 9.75% | 36 | 90% | 75% | 35% |
| 113 | 2 | $1,500 | 10.00% | 24 | 90% | 70% | 40% |
| 114 | 3 | $2,000 | 12.25% | 36 | 80% | 65% | 45% |
| 115 | 3 | $2,500 | 12.50% | 24 | 25% | 0% | 25% |
| 116 | 3 | $3,000 | 12.75% | 24 | 20% | 0% | 35% |
| 117 | 3 | $3,500 | 13.00% | 24 | 15% | 0% | 45% |
| 118 | 3 | $5,000 | 13.25% | 24 | 15% | 0% | 50% |
| 119 | 3 | $4,500 | 13.50% | 24 | 10% | 0% | 60% |
| 120 | 3 | $5,000 | 13.75% | 24 | 10% | 0% | 65% |
| 121 | 3 | $1,000 | 14.00% | 24 | 50% | 0% | 20% |
| 122 | 3 | $1,500 | 14.25% | 12 | 55% | 0% | 55% |
| 123 | 2 | $2,500 | 14.50% | 24 | 60% | 30% | 20% |
| 124 | 3 | $3,500 | 14.75% | 36 | 90% | 0% | 20% |
| 125 | 3 | $4,000 | 15.00% | 24 | 70% | 0% | 40% |
| 126 | 3 | $2,500 | 15.25% | 24 | 75% | 0% | 35% |
| 127 | 3 | $3,000 | 15.50% | 36 | 80% | 0% | 30% |
| 128 | 3 | $1,500 | 15.75% | 24 | 85% | 0% | 25% |
| 129 | 3 | $1,000 | 16.00% | 36 | 90% | 0% | 20% |
| 130 | 3 | $500 | 16.25% | 24 | 95% | 0% | 15% |
| A | B | C | D | E | F | G | H |

Zazingo Table 34B
Multi-Directional, Multi-Dimensional
Reverse Matrix Auction

| | | Compatability Factors | | | Qualifying |
|---|---|---|---|---|---|
| | | Continued | | | Bids |
| 130 | 3 | 24 | 0 | 24 | |
| | | Minimum Term By Position | | | Inclusion |
| Bid | Priority | Senior | Subordinate | Same | By Term |
| 101 | 1 | N/A | 36 | 36 | 0 |
| 102 | 2 | 24 | 18 | 18 | 1 |
| 103 | 1 | N/A | 24 | 30 | 1 |
| 104 | 1 | N/A | 36 | 30 | 0 |
| 105 | 1 | N/A | 42 | 24 | 0 |
| 106 | 1 | N/A | 48 | 24 | 0 |
| 107 | 1 | N/A | 36 | 30 | 0 |
| 108 | 3 | 24 | 60 | 24 | 1 |
| 109 | 1 | N/A | 66 | 24 | 0 |
| 110 | 1 | N/A | 72 | 24 | 0 |
| 111 | 3 | 24 | 12 | 12 | 0 |
| 112 | 2 | 24 | 18 | 36 | 1 |
| 113 | 2 | 24 | 24 | 24 | 0 |
| 114 | 3 | 24 | 36 | 36 | 0 |
| 115 | 3 | 24 | N/A | 24 | 1 |
| 116 | 3 | 24 | N/A | 24 | 1 |
| 117 | 3 | 24 | N/A | 24 | 1 |
| 118 | 3 | 24 | N/A | 24 | 1 |
| 119 | 3 | 24 | N/A | 24 | 1 |
| 120 | 3 | 24 | N/A | 24 | 1 |
| 121 | 3 | 24 | N/A | 24 | 1 |
| 122 | 3 | 24 | N/A | 36 | 0 |
| 123 | 2 | 24 | 24 | 24 | 0 |
| 124 | 3 | 24 | N/A | 36 | 0 |
| 125 | 3 | 24 | N/A | 24 | 1 |
| 126 | 3 | 24 | N/A | 24 | 1 |
| 127 | 3 | 24 | N/A | 36 | 0 |
| 128 | 3 | 24 | N/A | 24 | 1 |
| 129 | 3 | 24 | N/A | 36 | 0 |
| 130 | 3 | 24 | N/A | 24 | 1 |
| A | B | I | J | K | L |

Zazingo Table 34C
Multi-Directional, Multi-Dimensional
Reverse Matrix Auction

Qualifying Bids>>>>>>>>>>>>>>>>>>>>>>>>>>

| 130 | 3 | $9,500 | $0 | $1,500 | |
|---|---|---|---|---|---|
| | | Maximum Position Other Funding | | | Inclusion By |
| Bid | Priority | Senior | Subordinate | Same | Other Funding |
| | | $3,500 | $0 | $1,500 | |
| 101 | 1 | $0 | $0 | $0 | 1 |
| 102 | 2 | $1,000 | $0 | $0 | 1 |
| 103 | 1 | $1,500 | $0 | $0 | 1 |
| 104 | 1 | $0 | $0 | $0 | 1 |
| 105 | 1 | $0 | $0 | $0 | 1 |
| 106 | 1 | $0 | $0 | $0 | 1 |
| 107 | 1 | $0 | $0 | $0 | 1 |
| 108 | 3 | $0 | $0 | $1,500 | 1 |
| 109 | 1 | $0 | $0 | $0 | 1 |
| 110 | 1 | $0 | $0 | $0 | 0 |
| 111 | 3 | $0 | $0 | $0 | 1 |
| 112 | 2 | $1,000 | $0 | $0 | 1 |
| 113 | 2 | $0 | $0 | $0 | 1 |
| 114 | 3 | $0 | $0 | $0 | 1 |
| 115 | 3 | $0 | $0 | $0 | 0 |
| 116 | 3 | $0 | $0 | $0 | 0 |
| 117 | 3 | $0 | $0 | $0 | 0 |
| 118 | 3 | $0 | $0 | $0 | 0 |
| 119 | 3 | $0 | $0 | $0 | 0 |
| 120 | 3 | $0 | $0 | $0 | 0 |
| 121 | 3 | $0 | $0 | $0 | 1 |
| 122 | 3 | $0 | $0 | $0 | 1 |
| 123 | 2 | $0 | $0 | $0 | 1 |
| 124 | 3 | $0 | $0 | $0 | 1 |
| 125 | 3 | $0 | $0 | $0 | 1 |
| 126 | 3 | $0 | $0 | $0 | 1 |
| 127 | 3 | $0 | $0 | $0 | 1 |
| 128 | 3 | $0 | $0 | $0 | 1 |
| 129 | 3 | $0 | $0 | $0 | 1 |
| 130 | 3 | $0 | $0 | $0 | 1 |
| A | B | M | N | O | P |

Zazingo BORROWER RESERVE NOT SATISFIED Table 34D
Multi-Directional, Multi-Dimensional
Reverse Matrix Auction

| | | | Borrower | | Lender | | |
|---|---|---|---|---|---|---|---|
| | | | Loan Terms | | Yields On Investment | | |
| 130 | 3 | Selected Bids | | Overall | 1st | 2nd | 3rd |
| | | | Rates >> | 9.00% | 7.50% | 8.50% | 10.63% |
| | | Total | Months >> | 30.0 | 30.0 | 36.0 | 24.0 |
| Bid | Priority | $5,500 | Mo. Pmt >> | $211.03 | $1,500 | $2,000 | $2,000 |
| 101 | 1 | $0 | | $0.00 | $0 | $0 | $0 |
| 102 | 2 | $1,000 | | $30.99 | $0 | $1,000 | $0 |
| 103 | 1 | $1,500 | | $54.99 | $1,500 | $0 | $0 |
| 104 | 1 | $0 | | $0.00 | $0 | $0 | $0 |
| 105 | 1 | $0 | | $0.00 | $0 | $0 | $0 |
| 106 | 1 | $0 | | $0.00 | $0 | $0 | $0 |
| 107 | 1 | $0 | | $0.00 | $0 | $0 | $0 |
| 108 | 3 | $1,500 | | $68.36 | $0 | $0 | $1,500 |
| 109 | 1 | $0 | | $0.00 | $0 | $0 | $0 |
| 110 | 1 | $0 | | $0.00 | $0 | $0 | $0 |
| 111 | 3 | $0 | | $0.00 | $0 | $0 | $0 |
| 112 | 2 | $1,000 | | $32.15 | $0 | $1,000 | $0 |
| 113 | 2 | $0 | | $0.00 | $0 | $0 | $0 |
| 114 | 3 | $0 | | $0.00 | $0 | $0 | $0 |
| 115 | 3 | $0 | | $0.00 | $0 | $0 | $0 |
| 116 | 3 | $0 | | $0.00 | $0 | $0 | $0 |
| 117 | 3 | $0 | | $0.00 | $0 | $0 | $0 |
| 118 | 3 | $0 | | $0.00 | $0 | $0 | $0 |
| 119 | 3 | $0 | | $0.00 | $0 | $0 | $0 |
| 120 | 3 | $0 | | $0.00 | $0 | $0 | $0 |
| 121 | 3 | $0 | | $0.00 | $0 | $0 | $0 |
| 122 | 3 | $0 | | $0.00 | $0 | $0 | $0 |
| 123 | 2 | $0 | | $0.00 | $0 | $0 | $0 |
| 124 | 3 | $0 | | $0.00 | $0 | $0 | $0 |
| 125 | 3 | $0 | | $0.00 | $0 | $0 | $0 |
| 126 | 3 | $0 | | $0.00 | $0 | $0 | $0 |
| 127 | 3 | $0 | | $0.00 | $0 | $0 | $0 |
| 128 | 3 | $0 | | $0.00 | $0 | $0 | $0 |
| 129 | 3 | $0 | | $0.00 | $0 | $0 | $0 |
| 130 | 3 | $500 | | $24.54 | $0 | $0 | $500 |
| A | B | Q | | R | S | T | U |

### EXAMPLE III

A second exemplary description of the reverse auction matrix system is described, again using Tables 4-34, to further clarify the method and apparatus. In this example, multiple lenders bidding using multivariate terms and defining loan position for a potential loan is described. In Table 4, a borrower 105 submits a loan request over a network 113 to a loan coordinator 101. In this case, the borrower specifies specific loan reserve terms to: a loan amount of ten thousand dollars, a maximum payment of four hundred seventy-one dollars, a minimum term of twenty-four months, and a maximum interest rate of twelve percent. In all cases the loan terms are set by the buyer as the borrower's reserve criteria.

The borrower's loan terms are presented in the reverse matrix auction 100 to potential lenders 107 via the network 113. A multitude of lender bids are returned to the loan coordinator. Tables 5 to 34 represent thirty of the returned bids; bids could number in the tens, hundreds, or thousands. Table 4, columns B through L represents the lender bid terms and priority of the thirty lenders, which data are representable in a sub-matrix. The sub-matrix is itself a portion of a larger set of lender submitted data, which are also representable in matrix form. Table 5 through 34 include vectors of lender identifications. For each lender identification, a number of associated loan terms and positions are represented in corresponding vectors of the matrix. For example, lender number 101 submitted a bid of first priority position and terms of a bid amount of two thousand dollars at seven percent interest for thirty-six months. Each lender submits their own priority and terms as shown by example in Table 4. A single bidder may bid more than once.

Using the borrower's loan requirements represented in Table 4, column A and the lender's loan terms and position requirements of Table 4, columns B through L, a reconciliation algorithm 111 of a term and position coordinator 103, as displayed in Table 11, determines that the terms and position of bids 102, 104, 112, and 114 are compatible in a composite loan with bid 107 as the subject-bid, and are likewise compatible among themselves. Their combined fractionalized loan amounts of $1,000, $2,000, $1,000, $2,000, and $4,000 total $10,000, satisfying the borrower's reserve criterion of a $10,000 loan amount. The reconciliation algorithm further determines that the composite loan of bids 102, 104, 107, 112, and 114 has a total monthly payment of $351.83, a weighted average amortization term of 32.4 months, and weighted average interest rate of 9.10% that fulfill and actually better the borrower's reserve criteria even though bid 114 has an individual rate term of 12.25% exceeding that of the borrower's reserve criteria for maximum rate term of 12.0%. Still further, the composite loan coordinator 112 determines that composite loan composed of bids 102, 104, 107, 112, and 114 is the winning bid combination because its weighted average interest rate is lower than all other qualifying composite loan combinations as displayed in Table 4, columns M through P. Optionally, the reconciliation program and composite loan coordinator use still further lender requirements in selecting a winning combination of lenders.

All or portions of the elements of Tables 4 through 34 and additional bid elements are combinable into a larger matrix. Typically, in practice the reconciliation algorithm considers all terms represented in the sub-matrices of Tables 4 through 34 in finding the optimal terms for the borrower. More or less information may be provided in Tables 4 through 34 and all or parts of tables 4 through 34 are optionally combined. The combined results are also representable in matrix format.

### Auction Termination

Auction participants are obligated to perform for a minimum term, an extended term, or for a reduced term. A minimum term is an auction lasting a set period of time, such as n days, where n is a positive integer of greater than or equal to one. A default auction period of about ten days is preferred. If the auction does not produce a qualifying bid within the minimum term, an extended term is available. The borrower may extend the auction for a number of days. Preferably, the extension period for the extended term is equal to the minimum term period. Additional extensions of time for the auction are available for a maximum of x extensions, where x is one, two, three, four, or five extensions. A reduced term is available at the discretion of the borrower when:
there is at least one qualifying bid adequate to fully fund the loan request; and
the borrower gives notice of intent to close the auction at the end of a notice period, such as about twenty-four hours.

If during the notice period a bid that had been a winning bid at the commencement of the notice period is replaced by a new bid to fund the loan request, then the reduced term is extended for an additional notice period, such as about twenty-four hours, to permit additional bidding until no bid in the new round is replacing a bid from an earlier round.

### Loan Servicing

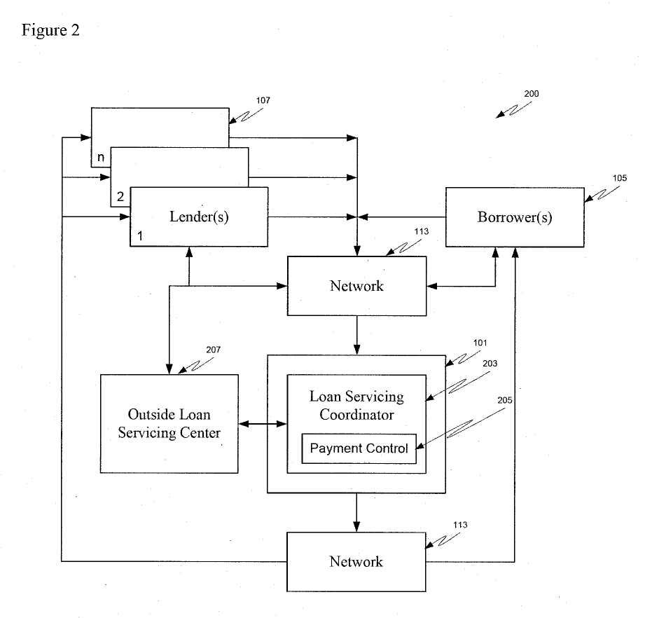

Referring now to FIG. 2, a loan management system 200 is illustrated. Subsequent to loan origination, a loan servicing coordinator 203 of the loan coordinator 101 coordinates payments through a payment control module 205. The payment control module coordinates payments and receipts between the above described lender(s) 107 and the above described borrower 105 over a network 113, such as described supra.

Payments and receipts between the borrowers and lenders are (1) routed through the loan servicing coordinator 203 or (2) are outsourced to an outside loan servicing center 207 designated by the loan servicing coordinator.

The loan coordinator, loan term and position coordinator, and/or loan servicing coordinator preferably provide fees for service to any or all of the lenders, borrowers, and outside loan servicing center. Fees include one or more of: a fixed amount, a function of loan amount, a function of fractionalized loan amount for a total loan to a borrower, a function of total loans from a given lender, are amortized with each loan payment, are up-front fees, and/or are based upon a membership of the lender or borrower with the loan coordinator.

The loan coordinator 101, the loan term and position coordinator 103, and/or loan servicing coordinator 203 coordinate with the borrower 105 and lender 107 through a user interface and display module showing loan requests, bids, winning bid combinations, and/or contact information.

### Loan Terms and Priority

Loan terms and priority are further described herein. Loan terms optionally include, but are not limited to: price, quantity, payment per time period, and/or term. Price is the interest rate charged. Quantity refers to the amount loaned. Term is the time period of the loan. Payment is cost per period, such as dollar amount per month. Priority includes any of, but is not limited to: position and ratio. The priority position is also described as 1^{st}, 2^{nd}, and 3^{rd} position with a total of n positions where n is a positive integer. For example, four, five, six, or more loan positions are available. Ratio of priority positions refers to the percentage loan funding, other than the subject fractionalized loan interest, bears to the total loan, in senior, subordinate, and equivalent positions compared to the position of the subject fractionalized loan interest.

### Reverse Auction Benefits

Reverse matrix auctions have a number of benefits including:
providing to borrowers as much financing as practical to meet their objective, while paying the lowest possible cost as measured by annual interest rate charged or lowest payment for a given time period;
providers are able to lend a maximal amount of capital while earning a highest rate of return both while selecting a degree of risk in-line with the provider's risk allocation requirements or investment strategy;
the borrower's rate diminishes as access to a larger number of potential lenders increases, which is the result of the reverse matrix auction enabling lending customized to the lenders risk-return requirements;
system flexibility in loan terms and position reduces perceived provider risk thereby enhancing capital outflow to borrower's otherwise overlooked; and
the system efficiently breaks capital down from older less efficient industries or investments and reallocates the capital from willing providers to borrowers with new, modern, and until now capital starved ideas.

The system allows relatively risk averse lenders to accept lesser rates of return in exchange for greater perceived security. The lender alters their risk level by any one or combination of:
lending in a superior position with subordinate capital insulating the investor from first dollar loss, such as loaning in 1^{st} or 2^{nd} position with a 2^{nd} or 3^{rd} position, respectively, acting as the insulator; and
lending funds over a shorter term amortization schedule than subordinate, or even superior or equivalent position, capital.

Similarly, a relatively less risk-averse lender or relatively risk tolerant lender can achieve one or more of:
demanding greater rates of return in exchange for greater perceived risk;
providing capital in a junior position and/or on a longer amortization schedule and demanding a higher rate of return, compared to that returned to the senior capital, in return for the increased risk; and
participating in loans exceeding a specific lender's available capital at a given risk tolerance as the fractionalized loan terms between lenders of varying risk tolerance allows the junior lender to participate in loans requiring more capital than the junior lender can provide, thereby achieving higher rates for the junior lender on loans otherwise unobtainable, in terms of available loan capital, to the junior lender.

The reverse matrix auction system has still additional benefits and features, as described herein. First, the system allows the above described relatively risk averse lenders and relatively risk tolerant lenders to both loan funds to a single borrower. Hence, in one embodiment, a single loan to a provider is derived from funds from a range of investors each having varying degrees of tolerance or adversity to risk, where tolerance and adversity are measured as a function of loan terms and position. Second, a single lender can provide funds in multiple positions with multiple terms for a single loan. Third, the reverse matrix auction system provides lenders with an opportunity to take a partial position with provider refined loan terms and position matching their investment objectives and risk tolerance.

Hence, the ability to tailor loan terms and position attracts lenders resulting in:
a lower blended cost of funds to a borrower;
a material higher yield to lenders in subordinate position; and
a materially greater security to lenders having a senior position.

Combined, a borrower can afford to pay a higher rate of return to subordinate lenders for subordinate capital while enjoying a lower rate from senior lenders thereby achieving a blended interest rate or payment for a given period, such as a monthly payment, that is in-line with the borrower's needs and/or expectations.

### Reverse Auction Types

There are several types of reverse auctions that vary according to whether the buyer is seeking a single item or multiple items and according to which price a successful bidder pays or selects to pay. Each has supporting legal basis. Reverse auction types include, but are not limited to: English, Vickery, Dutch, and Yankee, each of which are further described, infra.

### Reverse English Auctions

In a reverse English auction, sellers bid for the lowest price that they are willing to sell an item for and bidding activity stops when the auction duration is complete. If the reserve is met, the item is subsequently purchased from the lowest bidder at the seller's bid price.

### Reverse Vickery Auctions

A reverse Vickery auction is like a reverse English auction except that the lowest bidding seller sells at a price of the next highest bid price, which is the price bid by the second lowest seller. Using another loan example, the seller identifies terms and priority for at least a portion of the buyer's requested loan amount and uses a loan term, such as an interest rate, of the next lowest seller.

### Reverse Dutch Auctions

In a reverse Dutch auction, a buyer seeks multiple quantities of an identical item. The buyer specifies the maximum price that the buyer is willing to pay. Sellers bid at below that price for the maximum number of items that they are willing to sell. At the end of the auction, the sellers with the lowest bids, in a reverse bid order, receive the right to sell their items at the price offered by the lowest bidder until the buyer has purchased the desired quantity of items. Using still another loan example, the item could be number of dollars desired to borrow and the maximum price may be defined by one or more loan terms.

### Reverse Yankee Auctions

A reverse Yankee auction is like a reverse Dutch auction except that bidder, in a reverse bid order, sells at the price that they actually bid and not at the price bid by the lowest qualified bidder. Using yet another loan example, the bid price may be defined in loan terms and priority.

It should be appreciated, that items, asking prices, and bid prices for any auction type can be defined in terms of loan terms and priority for partial or total requested loan amounts from the buyer. It should still further be appreciated that all combinations and permutation of examples provided herein are considered as if fully individually presented in separate examples and that examples a given auction type have corresponding elements in other auction types that are equally applicable to a multi-dimensional and/or multi-directional reverse auction as described herein.

In another embodiment, tools are provided to the borrower and/or lender to aid in loan request or offer terms. The tools include both straight formula calculation tools, such as payment calculations given loan terms and what/if tools, which use data from the real-time online auction in progress. In one case, what/if software enables a borrower to determine for a requested loan amount or requested payment if existing bids would result in a bid fulfilling the borrower's needs if the borrower relaxes the borrower's reserve terms, such as interest rate or amortization period. In a second case, what/if software helps a lender to determine if relaxed bid parameters, as described supra, would combine with other bids to meet the borrower's reserve criteria. An advantage of the what/if software is that online reverse matrix auction scenarios are learned and optimized in a non-public fashion, such as without disclosing loan intentions.

Those skilled in the art will recognize that the present invention may be manifested in a variety of forms other than the specific embodiments described and contemplated herein. Departures in form and detail may be made without departing from the spirit and scope of the present invention. Accordingly, the invention should only be limited by the Claims included below.

1. A computer implemented reverse auction method, comprising the steps of:
providing a term and position coordinator module of a loan coordinator, that is accessible via a network;
a bidder requesting a loan by interacting with said term and position coordinator module via said network, said loan comprising a loan amount;
a plurality of sellers bidding for said loan by interacting with said term and position coordinator module via said network′, said bidding representable in a matrix comprising a vector of said sellers and for each seller element of said vector a set of corresponding fractional bid elements comprising: terms, position, and a fractional loan amount;
a loan coordinator using said term and position coordinator module to interact over said network through a display module with said bidder and said plurality of sellers;
said loan coordinator executing computer implemented a reconciliation algorithm combining two or more elements of said fractional loan amounts totaling to said loan amount,
wherein terms and position elements corresponding to said two or more elements yield a minimum cost of said loan to the bidder.

2. The reverse auction method of claim 1, further comprising a step of requiring said minimum cost of said loan to comprise a minimum weighted composite interest rate for said loan amount to said bidder, wherein reserve requirements of payment, weighted average interest rate, weighted average amortization period, total monthly payment, and total loan amount of said bidder are met.

3. The reverse auction method of claim 1, further comprising a step of requiring said minimum cost of said loan to comprise a minimum weighted composite interest rate.

4. The reverse auction method of claim 2, further comprising a step of a loan coordinator charging a fee for service to any or all of said borrower, at least one of said plurality of lenders, and an outside loan servicing center, wherein an algorithm computes said fee at least partially based upon a function of loan terms.

5. The reverse auction of claim 1, wherein said terms comprise all of an interest rate, a loan amount, an amortization period, and a priority position.

6. The reverse auction of claim 1, wherein said terms comprise all of a monthly payment, a loan amount, and a ratio of priority position relating at least two of any of a senior, a subordinate, and an equivalent position.

7. A reverse auction apparatus, comprising:
a term and position coordinator module of a loan coordinator interacting via a network with a bidder and a plurality of sellers,
wherein a bidder requests a loan, said loan comprising a loan amount,
means for a plurality of sellers to bid for said loan, said bid representable in a matrix comprising a vector of said sellers and for each element of said vector a set of corresponding fractional bid elements comprising: terms, position, and a fractional loan amount,
a plurality of display elements driven by said loan coordinator;
wherein said fractional bid elements of said plurality of sellers are multi-directionally viewable between said plurality of sellers display elements driven by said software of said loan coordinator.
a reconciliation algorithm operating on said loan coordinator for combining at least three elements of said fractional loan amounts totaling to said loan amount,
wherein terms and position elements corresponding to said at least three elements yield a minimum term and cover each of a first position, a second position, and a third position.

8. The apparatus of claim 7, further comprising said reconciliation algorithm yielding a current winning bid combination viewable on said display elements.

9. The apparatus of claim 8, wherein a winning bid derived by said reconciliation program includes, as a result of blended rates between winning bidders, an interest rate bid element of less than or equal to an amount specified by the borrower as a maximum blended rate willing to be paid by the borrower.

10. The apparatus of claim 7, wherein a winning bid derived by said reconciliation program comprises a senior position having a shorter term than a term of a junior position.

11. The apparatus of claim 7, wherein a winning bid derived by said reconciliation program comprises a senior position having a longer to or equal term than a term of a junior position.

12. A computer implemented reverse auction method, comprising the steps of:
providing a term and position coordinator module of a loan coordinator that is accessible via a network;
a borrower requesting a loan by interacting with said term and position coordinator via said network, said borrower designating a loan amount and at least one additional borrower loan term;
multiple bidders submitting bids in a reverse matrix auction format for fractionalized positions on said loan, wherein each of said multiple bidders separately designates:
a set of bidder loan term requirements;
a bidder position requirement; and
a set of bidder compatibility requirements;
said coordinator a loan coordinator receiving over said network and reconciling all of said loan amount, said at least one additional borrower loan term, said set of bidder loan term requirements, said bidder position requirement, and said set of bidder compatibility requirements to determine a subset combination of said bids yielding a winning set of lowest combined loan terms for said loan of said borrower.

13. The method of claim 12, wherein said at least one additional borrower loan term further comprises: a maximum payment, a minimum term, and a maximum rate.

14. The method of claim 12, further comprising a software module facilitating what/if scenarios to the borrower and/or the bidders.

15. The method of claim 12, further comprising means for the borrower to adjust reserve requirements during a real-time auction.

16. The method of claim 12, further comprising means for the lender to adjust reserve requirements during a real-time auction.

17. A computer implemented reverse auction method, comprising the steps of:
providing a term and position coordinator module of a loan coordinator that is accessible via a network;
a borrower requesting a loan amount with reserve requirements;
multiple bidders submitting bids in a reverse matrix auction format for fractionalized positions on said loan amount by interacting with said term and position coordinator module via said network, wherein each of said bids separately designates:
a set of bidder loan term requirements;
a bidder position requirement; and
a set of bidder compatibility requirements,
said a loan coordinator receiving over said network and reconciling all of said loan amount, said reserve requirements, and said bids to determine a subset combination of said bids yielding a winning set of lowest combined loan terms for said loan of said borrower.

18. The reverse auction method of claim 16, wherein said reverse auction comprises both multi-direction and multidimensional bids.

19. A reverse auction apparatus, comprising:
a term and position coordinator module of a loan coordinator interacting via a network with a bidder and a plurality of sellers,
wherein the bidder updates a multi-directional bid yielding an updated bid,
wherein the plurality of sellers submit multi-dimensional bids; and
a reconciliation algorithm operating on said loan coordinator for combining a subset of said multi-dimensional bids to fulfill requirements of said updated bid.
